(19) United States
(12) Patent Application Publication
(10) Pub. No.: US 2026/0222624 A1
(43) Pub. Date: Jul. 30, 2026

(54) ENCODING METHOD, DECODING METHOD, AND STORAGE MEDIUM

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 19/576,869

(22) Filed: Mar. 24, 2026

Related U.S. Application Data
(63) Continuation of application No. PCT/CN2023/122969, filed on Sep. 28, 2023.

(51) Int. Cl. H04N 19/61; H04N 19/122; H04N 19/159; H04N 19/196; H04N 19/70

(52) U.S. Cl. CPC H04N 19/61; H04N 19/122; H04N 19/159; H04N 19/196; H04N 19/70

(57) ABSTRACT

Disclosed in the present application are an encoding method, a decoding method, a bit stream, an encoder, a decoder, and a storage medium. The method includes: determining a texture feature index of a current block; determining a transformation kernel group of the current block on the basis of the texture feature index; determining a transformation kernel of the current block on the basis of the transformation kernel group; and determining a transformation coefficient of the current block, performing inverse transformation on the transformation coefficient of the current block on the basis of the transformation kernel, and determining a residual block of the current block.

### CROSS-REFERENCE TO RELATED APPLICATION

The present application is a continuation of International Application No. PCT/CN2023/122969 filed on Sep. 28, 2023, the disclosure of which is hereby incorporated by reference in its entirety.

### BACKGROUND

With the people's increasing requirements for video display quality, high-resolution videos such as High Definition (HD) videos and Ultra-HD videos have emerged. However, high-resolution videos typically contain more information, thereby requiring greater bandwidth. To reduce bandwidth requirements, video coding standards involving video compression have been introduced.

Intra prediction and inter prediction are included in video coding standards. Because intra prediction can't perfectly predict complex textures in many cases, an intra-coded block usually has more residual. In inter prediction, for an inter-coded block, a better prediction block may usually be found from a reference picture, resulting in less residual. However, the transform process in the inter prediction is not comprehensive enough, making it less effective in handling texture features with various directions, which ultimately results in lower compression efficiency.

### SUMMARY

Embodiments of the present application relate to the technical field of video encoding and decoding, and particularly provide an encoding method, a decoding method, and a storage medium.

The technical solution of the embodiment of the present application can be realized as follows:

According to a first aspect, an embodiment of the present application provides a decoding method applied to a decoder, the method includes the following operations:
an index of a texture feature of the current block is determined;
a transform kernel set for the current block is determined according to the index of the texture feature;
a transform kernel for the current block is determined according to the transform kernel set;
a transform coefficient of the current block is determined; and
an inverse transform is performed on the transform coefficient of the current block according to the transform kernel to determine a residual block of the current block.

In a second aspect, an embodiment of the present application provides an encoding method, which is applied to an encoder, and the method includes the following operations:
an index of a texture feature of a current block is determined;
a transform kernel set for the current block is determined according to the index of the texture feature;
a transform kernel for the current block is determined according to the transform kernel set;
the residual block of the current block is determined; and the residual block of the current block is transformed according to the transform kernel to determine a transform coefficient of the current block;
the transform coefficient of the current block is encoded, and the obtained encoded bits are written into the bitstream.

According to a third aspect, an embodiment of the present application provides a computer-readable storage medium having a computer program and a bitstream stored thereon, the computer program, when executed by at least one processor, implements the method according to according to the second aspect to generate the bitstream.

### BRIEF DESCRIPTION OF THE DRAWINGS

FIG. 1 is a schematic flowchart of a hybrid coding framework.

FIG. 2 is a schematic structural diagram of Group Of Pictures (GOP).

FIG. 3 is a schematic diagram of a block partitioning structure.

FIG. 4 is a schematic diagram of a block position relationship in the spatial domain/temporal domain of a current block.

FIG. 5 is a schematic diagram of motion information of a current block and a collocated block.

FIG. 6 is a schematic diagram of a motion displacement using a collocated reference picture.

FIG. 7 is a schematic diagram of a distribution using MVD characteristics.

FIG. 8 is a schematic diagram of affine motions using two or three control points.

FIG. 9 is a schematic diagram of affine motions deriving motion vectors based on sub-blocks.

FIG. 10 is a schematic diagram of multiple mode weights in a Geometric Partitioning Mode (GPM) mode.

FIG. 11 is a schematic diagram of motion information for a bilateral matching.

FIG. 12 is a schematic diagram of template matching for a current block.

FIG. 13 is a schematic diagram of a reference sample of a current block.

FIG. 14 is a schematic diagram of multiple reference rows of a current block.

FIG. 15 is a first schematic diagram of a plurality of prediction modes corresponding to an intra prediction.

FIG. 16 is a second schematic diagram of a plurality of prediction modes corresponding to an intra prediction.

FIG. 17 is a third schematic diagram of a plurality of prediction modes corresponding to an intra prediction.

FIG. 18 is a fourth schematic diagram of a plurality of prediction modes corresponding to an intra prediction.

FIG. 19 is a schematic diagram of encoding a screen content.

FIG. 20 is a schematic bar diagram of gradients versus intra prediction modes.

FIG. 21 is a schematic diagram of a weighted merge for three intra prediction modes.

FIG. 22 is a schematic diagram of reference samples of a chroma component and a luma component.

FIG. 23 is a schematic diagram of groupings of a multi-model Cross-Component Linear Model (CCLM).

FIG. 24 is a schematic diagram of a prediction for a multi-model CCLM.

FIG. 25 is a schematic diagram of a reference region for an intra CCCM.

FIG. 26 is a schematic diagram illustrating a luma gradient calculation for a Gradient Linear Model (GLM).

FIG. 27 is a schematic diagram of a prediction for an inter CCCM.

FIG. 28 is a schematic diagram of a Discrete Cosine Transform (DCT).

FIG. 29 is a schematic diagram of a base picture for a DCT.

FIG. 30 is a schematic flow without a Low Frequency Non-Separable Transform (LFNST).

FIG. 31 is a schematic flow with an LFNST.

FIG. 32 is a detailed flowchart with an LFNST.

FIG. 33 is a schematic diagram of base pictures for a plurality of transform kernel sets.

FIG. 34 is a schematic diagram of a base picture for an NSPT.

FIG. 35 is schematic structure diagrams in which luma and chroma are separately divided.

FIG. 36 is a schematic diagram of a network architecture of a video encoding/decoding according to an embodiment of the present application.

FIG. 37 is a schematic block diagram of a system configuration of an encoder according to an embodiment of the present application.

FIG. 38 is a schematic block diagram of a system configuration of a decoder according to an embodiment of the present application.

FIG. 39 is a first schematic flowchart of a decoding method according to an embodiment of the present application.

FIG. 40 is a schematic diagram of a partitioning line in a GPM mode.

FIG. 41 is a second schematic flowchart of a decoding method according to an embodiment of the present application.

FIG. 42 is a third schematic flowchart of a decoding method according to an embodiment of the present application.

FIG. 43 is a first schematic flowchart of an encoding method according to an embodiment of the present application.

FIG. 44 is a second schematic flowchart of an encoding method according to an embodiment of the present application.

FIG. 45 is a schematic structural diagram of a configuration of an encoder according to an embodiment of the present application.

FIG. 46 is a schematic diagram of a hardware structure of an encoder according to an embodiment of the present application.

FIG. 47 is a schematic structural diagram of a configuration of a decoder according to an embodiment of the present application.

FIG. 48 is a schematic diagram of a hardware structure of a decoder according to an embodiment of the present application.

FIG. 49 is a schematic structural diagram of a configuration of a coding system according to an embodiment of the present application.

### DETAILED DESCRIPTION

In order to provide a more detailed understanding of the features and technical contents of embodiments of the present application, the implementation of the embodiments of the present application will be described in detail below with reference to the accompanying drawings, which are for reference and illustration only, and are not intended to limit the embodiments of the present application.

Unless otherwise defined, all technical and scientific terms used herein have the same meaning as commonly understood by a skilled person belonging to the technical field of the present application. The terms used herein is for the purpose of describing the embodiments of the present application only and is not intended to limit the present application.

In the following description, reference is made to “some embodiments”, which describes a subset of all possible embodiments, but it should be understood that “some embodiments” may be the same subset or different subsets of all possible embodiments, and may be combined with each other without conflict.

It should also be pointed out that the terms “first\second\third” involved in the embodiments of the present application are only used to distinguish similar objects, and do not represent a specific ordering for the objects. It should be understood that “first\second\third” can be interchanged with a specific order or a priority order where allowed, so that the embodiments of the present application described herein can be implemented in an order other than that illustrated or described herein.

In video pictures, a first color component, a second color component, and a third color component are generally used to represent a Coding Block (CB). The three color components are one luma component, one blue chroma component, and one red chroma component, respectively. Specifically, the luma component is usually represented by the symbol Y, the blue chroma component is usually represented by the symbol Cb or U, and the red chroma component is usually represented by the symbol Cr or V. In this way, the video picture may be represented in the YCbCr format or in the YUV format.

Before further describing the embodiments of the present application in detail, the phrases and terms related to the embodiments of the present application will be described first, and the phrases and terms related to the embodiments of the present application are applicable to the following explanations:
H.265/High Efficiency Video Coding (HEVC);
H.266/Versatile Video Coding (VVC);
VVC Test Model (VTM);
A platform for improving compression performance after VVC (Enhanced Compression Model (ECM));
Joint Video Experts Team (JVET);
Coding Unit (CU);
Coding Tree Unit (CTU)
Largest Coding Unit (LCU);
Motion Vector (MV);
Prediction Unit (PU);
Transform Unit (TU);
Merge;
Skip;
Quantization Parameter (QP);
Merge with Motion Vector Difference (MMVD);
Motion Vector Prediction (MVP);
Temporal Motion Vector Prediction (TMVP);
Subblock-based Temporal Motion Vector Prediction, (SbTMVP);
Discrete Cosine Transform (DCT);
Discrete Sine Transform (DST);
Multiple Transform Selection (MTS);
Low Frequency Non-Separable Transform (LFNST);
Non-Separable Primary Transform (NSPT);
Context-based Adaptive Binary Arithmetic Coding, (CABAC).

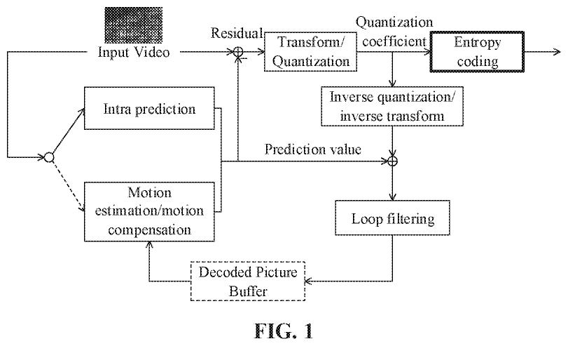

At present, all common video coding and decoding standards adopt block-based hybrid coding framework. Each picture or sub-picture or frame in the video is partitioned into largest coding units or coding tree units in square shape with a same size (such as 256×256, 128×128, 64×64, etc.). Each largest coding unit or coding tree unit may be partitioned into rectangular coding units according to a rule. A coding unit may also be divided into a prediction unit, a transform unit, and the like. Specifically, as shown in FIG. 1, the hybrid coding framework includes a prediction module, a transform/quantization module, an entropy coding module, an inverse quantization/inverse transform module, and an in loop filter, etc. The prediction module may include an intra prediction module and an inter prediction module, and the inter prediction module may include a motion estimation and motion compensation module. Because there is a strong correlation between neighboring samples in one picture of a video, intra prediction is used in video coding technology to eliminate spatial redundancy between neighboring samples. In addition, because there is a strong similarity between neighboring pictures in a video, inter-picture prediction method is used in video coding technology to eliminate the temporal redundancy between neighboring pictures, thus improving the coding efficiency.

The basic flow of the video coding is as follows: at an encoding side, a picture is partitioned into blocks, intra prediction or inter prediction is used for a current block to generate a prediction block of the current block, the prediction block is subtracted from an original block of the current block to obtain a residual block, the residual block is transformed and quantized to obtain a quantization coefficient matrix, and the quantization coefficient matrix is entropy encoded and output to a bitstream. At a decoding side, intra prediction or inter prediction is used for a current block to generate a prediction block of the current block, on the other hand, the bitstream is parsed to obtain a quantization coefficient matrix, the quantization coefficient matrix is inversely quantized and inversely transformed to obtain a residual block, and the prediction block and the residual block are added to obtain a reconstructed block. Reconstructed blocks form a reconstructed picture, and the reconstructed picture is loop filtered based on the picture or block to obtain a decoded picture. The encoding side also needs similar operations as the decoding side to obtain the decoded picture. The decoded picture may be used as a reference picture for inter prediction for a subsequent picture. Block partition information, mode information or parameter information such as prediction, transform, quantization, entropy coding, loop filtering, etc. determined at the encoding side need to be output to the bitstream if necessary. The decoding side determines the same block partition information, mode information or parameter information such as prediction, transform, quantization, entropy coding, loop filtering, etc. as the encoding side by parsing the bitstream and analyzing according to the existing information, so as to ensure that a decoded picture obtained at the encoding side is the same as a decoded picture obtained at the encoding side. The decoded picture obtained at the encoding side is usually also called a reconstructed picture. At the time of prediction, the current block may be partitioned into prediction units, at the time of transform, the current block may be divided into transform units, and the partitions of the prediction units and the transform units may be different. The above is the basic flow of the video coding under the block-based hybrid coding framework. With the development of technology, some modules or steps of the framework or flow may be optimized. Embodiments of the present application are applicable to the basic flow of the video encoder and decoder under the block-based hybrid coding framework, but are not limited to the framework and flow.

In addition, in the embodiment of the present application, a Current Block (CB) may be a current coding unit, a current prediction unit, a current transform unit, or the like. Because of the need of parallel processing, pictures can be partitioned into slices, etc. The slices in a same picture can be processed in parallel, that is to say, there is no data dependence between the slices. “Frame” is a commonly used term, which can generally be understood as that one frame is a picture. The frame described in the embodiments of the present application may also be replaced with a picture, a slice, or the like.

It can be understood that, in prediction techniques, the following describes in detail intra prediction and inter prediction, respectively.

### (1) Inter Prediction.

Inter prediction uses temporal correlation to eliminate redundancy. In order to make the stuttering invisible to the human eye, the frame rate of a general video will be 30 frames per second, 50 frames per second, 60 frames per second, or even 120 frames per second. In such a video, the correlation between adjacent frames in the same scene is high, and the inter prediction technology uses this correlation to predict the content to be encoded currently with reference to the content of the already encoded frame. Inter prediction can greatly improve encoding performance.

The primary inter prediction method is translational prediction. In the translational prediction, it is assumed that the content to be predicted is translational between the current picture and the reference picture. For example, if the content of the current block (a coding unit or a prediction unit) is translational between the current picture and the reference picture, then this content can be found from the reference picture through a motion vector and used as the prediction block of the current block. Translation motion accounts for a large proportion in videos, and the stationary background, the overall translated objects and the translation of the lens can all be processed by translational prediction.

Some contents in a natural video are not simple translation. For example, there are some subtle changes in the process of translation, including changes in shape, color, etc. In the Bidirectional prediction, two reference blocks are found from the reference pictures and a weighted average of the two reference blocks is calculated to obtain a prediction block as similar as possible to the current block. For example, for some scenes, a reference block is found from each of a front picture and back picture of the current picture for weighted averaging, which may obtain a block more like the current block than a single reference block. Based on this bidirectional prediction, the compression performance is improved on the basis of unidirectional prediction.

The Picture Order Count (POC) can be used as an identifier of the picture. In a video sequence, each picture has a unique POC. In the embodiments of the present application, it is considered that the order of the POC and the playback order are the same. A P picture (P Frame) is a picture that can only be predicted using a reference picture of which the POC precedes the current picture. The current reference picture has only one Reference Picture List (RPL), denoted as RPL0. The reference picture list RPL0 includes only reference pictures of which the POC precedes the current picture. A B picture (B Frame) in a previous time is a picture that can be predicted using a reference picture of which the POC precedes the current picture and a reference picture of which the POC is after the current picture. The B picture has two reference picture lists, denoted RPL0 and RPL1. In one configuration method, RPL0 includes only reference pictures of which the POC precedes the current picture, and RPL1 includes only reference pictures of which the POC is after the current picture. For a current block, only a reference block of a certain picture in RPL0 can be referred to, which is also called forward prediction, or only a reference block of a certain picture in RPL1 can be referred to, which is also called backward prediction, or both a reference block of a certain picture in RPL0 and a reference block of a certain picture in RPL1 may also be referred to, which is also called bi-prediction. A simple method of referencing both two reference blocks is to average the samples at the positions corresponding to each of the two reference blocks to obtain the prediction block of the current block. Later, for the B picture, it no longer limits that RPL0 includes only the reference picture of which the POC precedes the current picture and RPL1 includes only the reference picture of which the POC is after the current picture. Therefore, RPL0 may also include a reference picture of which the POC is after the current picture, and RPL1 may also include a reference picture of which the POC precedes the current picture. The current block may also simultaneously refer to a reference picture of which the POC precedes the current picture or simultaneously refer to a reference picture of which the POC is after the current picture. This kind of B picture is also called generalized B picture.

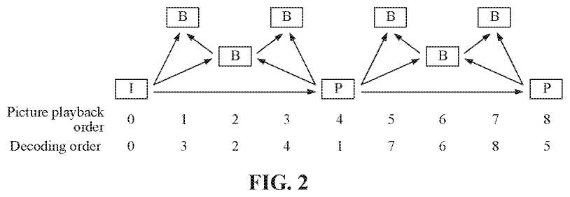

Because the encoding and decoding order of Random Access (RA) configuration is different from the POC order, the B picture can refer to the information before the current picture and the information after the current picture, thereby obviously improving the encoding performance. Exemplarily, a structure of a classical Group Of Pictures (GOP) of RA is shown in FIG. 2. In FIG. 2, an arrow indicates a reference relationship. Since an I picture does not need a reference picture, a P picture having a POC of 4 will be decoded after an I picture having a POC of 0 is decoded. An I picture having a POC of 0 may be referred to when decoding a P-picture having a POC of 4. After the P picture having a POC of 4 is decoded, then the B picture having a POC of 2 is decoded. The I picture having a POC of 0 and the P picture having a POC of 4 may be referred to when decoding the B picture having a POC of 2, and so on. In this way, according to FIG. 2, when the POC order is {0 1 2 3 4 5 6 7 8}, the corresponding decoding order is {0 3 2 4 1 7 6 8 5}.

The encoding and decoding order of the Low Delay (LD) configuration is the same as the POC order, so a current picture can only refer to the information before the current picture. The Low Delay configuration is divided into Low Delay P and Low Delay B. Low Delay P is the traditional Low Delay configuration, of which the typical structure is IPPP. That is, an I picture is coded or decoded first, and the subsequent pictures are all P pictures. The typical structure of Low Delay B is IBBB . . . , which is different from Low Delay P in that each inter picture is a B picture. That is, two reference picture lists are used, the current block can refer to both a reference block of a certain picture in RPL0 and a reference block of a certain picture in RPL1.

Generally, the compression efficiency of the RA configuration is higher than that of the LD configuration, and the compression efficiency of the LDB configuration is higher than that of the LDP configuration. On the one hand, it is because bi-directional prediction can refer to subsequent information, and on the other hand, it is because bi-directional prediction can reduce prediction errors through some techniques, such as weighted average.

A reference picture list for the current picture may have at most several reference pictures, such as 2, 3, or 4, etc. When a certain current picture is encoded, which reference pictures in each of RPL0 and RPL1 are determined by a certain configuration or algorithm, which is not the focus of discussion in the embodiments of the present application. But a same reference picture may appear in RPL0 and RPL1 at the same time. That is, the encoder/decoder allows the current block to simultaneously refer to two reference blocks of a same reference picture. The encoder/decoder usually uses an index value (index, idx) in the reference picture list to correspond to a reference picture. If a reference picture list is 4 in length, index has four values: 0, 1, 2, 3. Exemplarily, if RPL0 of a current picture has 4 reference pictures with POC of 5, 4, 3, 0. Then, index 0 of RPL0 is the reference picture with POC of 5, index 1 of RPL0 is the reference picture with POC of 4, index 2 of RPL0 is the reference picture with POC of 3, and index 3 of RPL0 is the reference picture with POC of 0.

It is also understood that inter prediction uses motion information to represent “motion”. The basic motion information includes information of a reference picture (reference picture) and information of a motion vector (MV). In order for a block to be able to use bi-prediction, it naturally needs to be able to find two reference blocks, so it needs two sets of reference picture information and motion vector information. Each set of reference picture information and motion vector information can be understood as a unidirectional motion information, and these two sets are combined together to form a bidirectional motion information. In specific implementation, the unidirectional motion information and the bidirectional motion information can use a same data structure, except that the two sets of the reference picture information and the motion vector information for the bidirectional motion information are valid, while one of two sets of reference frame information and the of motion vector information for the unidirectional motion information are invalid. The valid can also be referred to as “use”, and the invalid can also be referred to as “not use”.

VVC supports two reference picture lists, denoted as RPL0 and RPL1. For the above-described bidirectional motion information, the VVC uses the reference picture index refIdxL0 corresponding to RPL0, the motion vector mvL0 corresponding to RPL0, the reference picture index refIdxL1 corresponding to RPL1, and the motion vector mvL1 corresponding to RPL1. Here, the reference picture index corresponding to RPL0 and the reference picture index corresponding to RPL1 can be understood as the above-described reference picture information. The VVC uses two pieces of identifier information to respectively indicate whether or not the motion information corresponding to RPL0 is used and whether or not the motion information corresponding to RPL1 is used, which are denoted as predFlagL0 and predFlagL1, respectively. It can also be understood that predFlagL0 and predFlagL1 indicate whether or not the above-mentioned unidirectional motion information is valid. Therefore, although the data structure of motion information is not explicitly mentioned in the VVC, it represents the motion information with the reference picture index corresponding to each reference picture list, the motion vector and the flag bit of “valid or not” together. A motion vector used instead of motion information appears in the standard text of the VVC, and it may be considered that the reference picture index and the flag of whether or not the corresponding motion information is used are attachments of the motion vector. “Motion information” is still used herein for convenience of description, but it should be understood that “motion vector” may also be used for description. The “motion information” may also be referred to as a “motion parameter”.

For a two-dimensional picture, the motion vector can be represented by (x, y), that is, a horizontal component and a vertical component. Since videos are represented in samples, and there is a distance between samples, the movement of an object may not always correspond to the integer sample distance between adjacent pictures. For example, in a long-distance video, the distance between 2 pixels is 1 meter on the long-distance object, and the distance moved by this object in the time between 2 frames is 0.5 meters. This kind of scene can't be well represented by the motion vector of integer pixels. Therefore, motion vectors can be at fraction pixel levels, such as ½ pixel accuracy, ¼ pixel accuracy, ⅛ pixel accuracy, and 1/16 pixel accuracy, to represent motion more finely. The pixel values at the fractional pixel positions in the reference picture are obtained by interpolation.

Both unidirectional prediction and bidirectional prediction in the translation prediction described above are block-based, such as coding unit or prediction unit. That is, a pixel matrix is used as a unit for prediction. The most basic blocks are rectangular blocks, such as squares and rectangles. Video coding and decoding standards such as HEVC and VVC allow encoders to determine the size and partition mode of coding units and prediction units according to the content of the video. Regions with simple textures or motions tend to use larger blocks and regions with complex textures or motions tend to use smaller blocks. The deeper the level of block partitioning, the more complex blocks that are closer to the actual texture or motion can be partitioned, but the overhead of representing these partitions is correspondingly greater. The motion information may also need to be transmitted in the bitstream. Moreover, in general, the finer the block division, the greater the overhead of motion information.

The most primitive method of expressing motion information is to signal complete motion information directly. Later, experts found that motion vector prediction (MVP) plus motion vector difference (MVD) can be used to represent motion vectors, that is, MV=MVP+MVD. Herein, the more accurate the MVP is, the smaller the MVD is, which takes up less overhead in the bitstream.

It will also be understood that for the merge mode, a piece of motion information is required for each inter-coded block. In order to simplify the problem, it is assumed that the partition of CU is equal to the partition of PU is equal to the partition of TU, that is, a coding unit has a prediction unit of the same size and at a same position, and a transform unit of the same size at a same position. In fact, as CU partition becomes more flexible, VVC tends to weaken PU and TU compared to HEVC. Differences in any of prediction, transform, quantization and entropy coding may lead to different CU partitions. For example, if the motion information of two regions is different, the encoder may partition the two regions into different CUs. For example, if the motion information of two regions is the same or similar, but the residual characteristics are very different, then the encoder may also partition the two regions into different CUs. How to partition it is determined according to the overall compression efficiency, and does not entirely depend on a certain factor. Therefore, it may occur that same objects or regions with a same or similar motion are partitioned into different CUs.

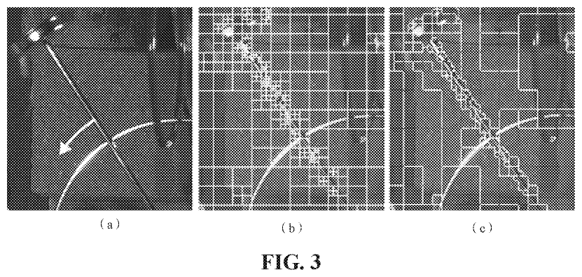

FIG. 3 is a schematic block partitioning structure for HEVC. As shown in FIG. 3, (a) is an original picture, in (a) there is an iron rod moving in the direction indicated by the arrow, and the background region moves less. (b) is a block partition case for HEVC, and in (c), boundaries of blocks with a same motion information in (b) are removed. It can be seen that many adjacent blocks use the same motion information. In this case, if the motion information is separately encoded for each block, there will be obvious waste. The complete motion information mentioned above for VVC includes the reference picture index of RPL0, a MV and a flag of whether or not the MV is used, and the reference picture index of RPL1, a MV, and a flag of whether or not the MV is used. The basic principle of merge mode is that the current block can inherit the motion information of adjacent blocks, including the information of reference pictures and information of motion vectors.

In the merge mode, a merge candidate list can be built. If the current block uses the merge mode, an index can be used to indicate which motion information the current block merges, thus eliminating the need to encode the complete motion information. When the merge candidate list is constructed, motion information of a spatial neighboring block, temporal motion information, motion information of a spatial non-neighboring block, motion information of a temporal non-neighboring block, history-based movement information, synthesized motion information, etc. of the current block can be added.

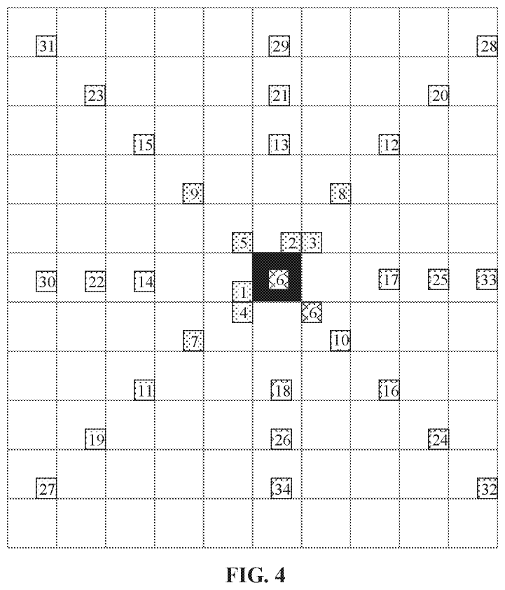

The spatial neighboring block refers to a block neighboring to the current block in a same picture, and the spatial non-neighboring block refers to a block not neighboring to the current block in the same picture. The temporal motion information and the motion information of the temporal non-neighboring block refer to motion information at a specified position on a collocated reference picture. Exemplarily, as shown in FIG. 4, the black fill block is the current block, where the positions 1, 2, 3, 4, and 5 are positions of spatial neighboring blocks used for merge, and positions corresponding to other point fill blocks are positions of spatial non-neighboring blocks used for merge. The position 6 is a position used for temporal motion information, and if the position corresponding to the below right corner of the current block is not available, the position corresponding to the center of the current block is used. The positions corresponding to the other grid filling blocks are positions used for motion information of temporal non-neighboring blocks. The temporal motion information is derived according to the motion information at the corresponding position of the collocated reference picture, and the specific derivation method is described below. It should be noted that the background grid in FIG. 4 is only a schematic diagram of sample coordinates, and is not a specific block partition.

The history-based movement information is unrelated to the location, the encoder or decoder will maintain a first-in, first-out motion information list. Every time a block is encoded and decoded, the encoder or decoder will update the list with the motion information of the block. When updating the list, it is ensured that it does not duplicate the existing motion information in the list. The history-based movement information is obtained from this list.

It is also understood that, for the derivation of the temporal motion information (vector), the temporal motion information prediction is used as a supplement to the spatial domain motion information prediction. Generally speaking, the correlation between neighboring regions on the same picture is stronger than that on different pictures. But there are also some cases where temporal motion information is better used. To give a simple example, for example, the current block and the neighboring blocks in the current picture belong to different objects, and they have completely different motions. However, the motion of a block belonging to the same object as the current block on a certain reference picture can provide better motion information prediction for the current block.

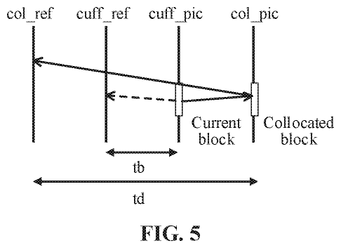

The motion vector of a collocated block on the collocated reference picture (here, the block used for acquiring the temporal motion information is called a collocated block) is a vector from the collocated reference picture col_pic to the reference picture col_ref of the collocated block. Specifically, as shown in FIG. 5, for the current block, the required motion vector is a vector from the current picture current_pic to the reference picture current_ref of the current block. Let the POC distance between col_pic and col_ref be td, and the POC distance between current_pic and current_ref be tb. Assuming that the motion on the collocated block is the same as the motion on the current block, a scale can be determined according to td, tb. If the motion vector of the collocated block is (col_mv_x, col_mv_y), the temporal motion vector prediction (tmvp_x, tmvp_y) can be derived as follows: tmvp_x=col_mv_x*tb/td, tmvp_y=col_mv_y*tb/td.

In VVC, the minimum unit on the collocated reference picture for which motion information is stored is 4×4. That is, a set of motion information is stored for each 4×4 sub-block. It can be understood that if the cost of hardware implementation is not considered, a set of motion information can also be stored for each pixel in the collocated reference picture.

It can also be understood that sub-block-based temporal motion vector prediction, that is, SbTMVP, is introduced in VVC. Generally, MVP and TMVP are for the whole block, that is, the whole block shares the same MVP. SbTMVP is based on sub-blocks, so that SbTMVP can obtain an MVP for each sub-block. This is also the essential difference between SbTMVP and TMVP.

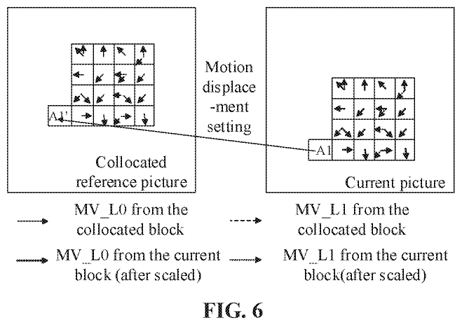

On the other hand, in TMVP, the position of the below right corner of the current block or the position of the center of the current block is used to locate the collocated block, while in SbTMVP, a motion offset is found according to the motions of the surrounding blocks to determine the position. In VVC, if the block at the position A1 refers to the collocated reference picture, the motion displacement is set to be that A1 uses the motion vector of the collocated reference picture. Otherwise, the motion displacement is set to (0, 0). As shown in FIG. 6, the position is found according to the motion displacement, and then the MV corresponding to the position of each sub-block in the “collocated block” is scaled to obtain the MVP of each sub-block.

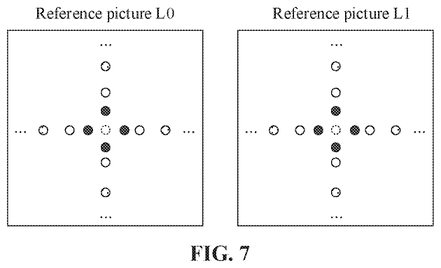

It is also understood that for merge with motion vector difference, that is, MMVD, the motion information in the merge candidate list directly selected in the merge mode is used as the motion information of the current block. In the actual video, there may be some differences between the actual motion vector of the current block and the selected motion vector in the merge candidate list. MMVD is a special merge mode in VVC, which encodes the MVD in this case with an efficient method. Common merge doesn't need to encode/decode MVD. In common inter mode, direct encoding and decoding of MVD is not required. MMVD takes advantage of the characteristic that MVD is more distributed in a single horizontal direction or a single vertical direction, with more MVD with smaller values and less MVD with larger values, as shown in FIG. 7. In FIG. 7, circles of different shapes may represent MVD with different values.

MMVD can only represent MVDs with specific values in some specific directions, but it cannot represent any MVD. It uses mmvd_direction_idx to represent the direction of the MVD, or, it can also be understood as whether x and y of the MVD are non-zero and whether the sign of which is positive or negative. mmvd_distance_idx is used to represent the absolute value MmvdDistance of one of x and y of the MVD which is non-zero.

Here, Table 1 shows a schematic relationship between mmvd_distance_idx [x0] [y0] and MmvdDistance [x0] [y0].

TABLE 1

| | MmvdDistance[x0][y0] | |
|---|---|---|
| mmvd_distance_idx[x0][y0] | ph_mmvd_fullpel_only_flag == 0 | ph_mmvd_fullpel_only_flag == 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

Here, ph_mmvd_fullpel_only_flag is one picture header flag, and two different combinations of MMVDs can be set.

Here, Table 2 shows a schematic relationship with mmvd_direction_idx [x0] [y0] and MmvdSign [x0] [y0].

TABLE 2

| mmvd_direction_idx[x0][y0] | MmvdSign[x0][y0][0] | MmvdSign[x0][y0][1] |
|---|---|---|
| 0 | +1 | 0 |
| 1 | −1 | 0 |
| 2 | 0 | +1 |
| 3 | 0 | −1 |

Wherein the MVD of the MMVD is obtained as follows:

$$MmvdOffset [ x 0 ] [ y 0 ] = ( MmvdDistance [ x 0 ] [ y 0 ] << 2 ) * MmvdSign [ x 0 ] [ y 0 ] [ 0 ] ; \\ MmvdOffset [ x 0 ] [ y 0 ] = ( MmvdDistance [ x 0 ] [ y 0 ] << 2 ) * MmvdSign [ x 0 ] [ y 0 ] [ 1 ] .$$

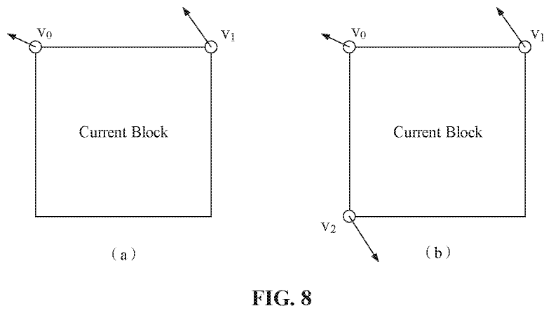

It can also be understood that for Affine, the simplest and commonly used translational motion was introduced above. In the real world, motion is not only translation, but also many forms such as zooming out, zooming in, rotating, and moving perspective (perspective: an object close to the lens appears large, an object far away from the lens appears small), and there are many irregular forms of motion. Affine can be used to represent more complex motions than translation. As shown in FIG. 8, Affine uses a linear model to calculate the motion vector of each sub-block or each pixel in the current block based on the motion vectors of two control points (four parameters, one motion vector includes two parameters x and y) or three control points (six parameters). In FIG. 6, (a) provides the case of two control points, such as v₀, v₁; (b) provides the case of three control points, such as v₀, v₁, v₂.

For the 4-parameter affine model, the motion vector of the position (x, y) within the current block is derived according to the following formula:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 1 )$$

For the 6-parameter affine model, the motion vector of the position (x, y) within the current block is derived as follows according to the following formula:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 )$$

Here, (mv₀ₓ, mv_{0y}) is a motion vector of a control point at the top left corner of the current block, (mv₁ₓ, mv_{1y}) is a motion vector of a control point at the top right corner of the current block, and (mv₂ₓ, mv_{2y}) is a motion vector of a control point at the below left corner of the current block.

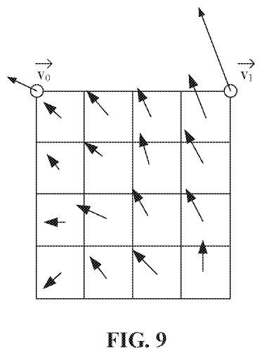

In order to simplify the complexity of hardware implementation, Affine used in VVC partitions the current block into 4×4 sub-blocks, calculates an MV for each sub-block and performs motion compensation. FIG. 9 is a schematic diagram of deriving motion vectors based on sub-blocks in Affine. It may be understood that, with the enhancement of hardware processing capabilities, Affine can also achieve sample-based processing. That is, a motion vector is derived for each sample, and motion compensation is performed on the sample according to the motion vector. Here, Affine only needs a few control points to derive its own motion vector for each sub-block or each sample. Compared with motion compensation based on the whole block, it can achieve finer prediction. Compared with smaller CUs, the overhead of Affine is much smaller.

It can also be understood that for the Geometric Partitioning Mode (GPM), HEVC supports a CTU up to 64×64, and quadtree partitioning can be performed recursively. VVC supports a set of more flexible block partitioning methods than HEVC, supporting a CTU up to 128×128, including quadtree partitioning, tritree partitioning and binary tree partitioning. For these partitioning methods, although block partitioning is becoming more and more flexible, whether it is CU, PU or TU, it can only be partitioned into rectangular blocks. It should be noted that VVC has weakened the partitioning of PU and TU. The boundaries of textures or motions in natural videos are various. For example, when an oblique object boundary is encountered, if it simply use rectangular blocks to approximate the boundary, many small blocks will be partitioned, which will obviously increase the overhead. The GPM can better handle textures and boundaries in natural videos.

In the GPM, two prediction blocks with the same size as the current block are used. In the prediction block of the GPM, some sample positions use 100% of the sample values at the corresponding positions of the first prediction block, and some sample positions use 100% of the sample values at the corresponding positions of the second prediction block. In the boundary region or transition region, the sample values at the corresponding positions of the two prediction blocks are used with a certain ratio. The weights for the boundary region are also gradually transitioned. Or, the transition region may not be used for scenarios such as screen content encoding. How these weights are allocated is determined based on the “partition” mode in GPM. The weight at each sample position is determined according to the “partition” mode in the GPM. Or, in some cases, such as when the block size is very small, it may not ensure that there are some sample positions at which 100% of the sample value at the corresponding position of the first prediction block is used, and there are some sample positions at which 100% of the sample value at the corresponding position of the second prediction block is used in some GPM modes. It can also be considered that GPM uses two prediction blocks with different sizes from the current block, that is, the required part is acquired from each block and the part with a weight of 0 is eliminated.

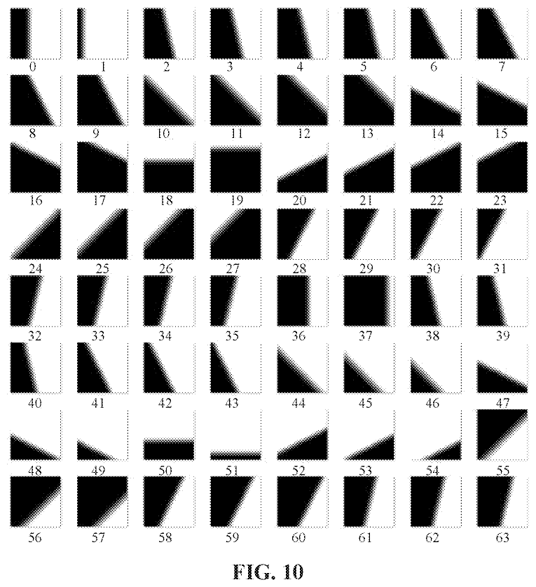

FIG. 10 is a schematic diagram of the weights of 64 modes on a square block for the GPM mode in VVC. As shown in FIG. 10, black indicates that the weight value for the corresponding position of the first prediction block is 0%, white indicates that the weight value for the corresponding position of the first prediction block is 100%, and gray indicates according to different color depths that the weight value for the corresponding position of the first prediction block is a certain weight value greater than 0% and less than 100%. The weight value for the corresponding position of the second reference block is 100% minus the weight value for the corresponding position of the first reference block.

It can be said that the GPM is a prediction mode or prediction method because it ultimately produces a prediction block. It can also be said that the GPM is a “partitioning” mode, it partitions the prediction block virtually, which is similar to implementing PU partitioning, but without substantial partitioning. The first prediction block and the second prediction block used in the GPM may be a prediction block generated through intra prediction, a prediction block generated through inter unidirectional prediction, or a prediction block generated through inter bidirectional prediction.

It will also be understood that the bitrate of consumer-grade video is generally limited, so video compression usually seeks a compromise between bitstream overhead and distortion. Taking block partition as an example, for the same content, within a certain range, the finer the partition, the greater the overhead and the less the distortion; The coarser the partition, the less overhead and the greater the distortion. Taking the encoding of motion information as an example, for the same content, within a certain range, the more accurate the motion information, the greater the overhead and the smaller the distortion, the coarser the motion information, the smaller the overhead and the greater the distortion. Some methods at the decoding side use the information at the decoding side for processing and calculation without occupying overhead, so as to improve the motion information, improve the prediction effect and reduce the distortion. No overhead being occupied means that when there is instruction given by the encoder based on the original picture, it may automatically perform a process according to available information. Two typical decoding methods in VVC are Decoder side Motion Vector Refinement (DMVR) and Bi-Directional Optical Flow (BDOF), which will be introduced in detail below.

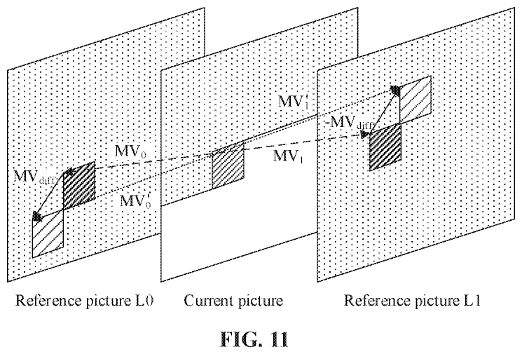

In one possible implementation, for the DMVR, a start condition for the DMVR in VVC is that the two reference pictures of the current block are respectively from a picture preceding the current picture and a picture after the current picture, and the distances between the two reference pictures and the current picture are equal. Another start condition is that a whole block merge mode (including skip) is used for the current CU. The whole block merge mode does not include a sub-block-based merge such as SbTMVP and affine merge, because the motion vector in the merge mode may be not accuracy enough. There are some other conditions that will not be repeated here. For the DMVR in VVC, bilateral matching (BM) is used, that is, the matching costs for the bilateral reference blocks, such as the sum of absolute differences (SAD), are calculated. In the DMVR, the matching costs of the MVs around the original MV are searched, the MVs of the two reference pictures are moved in a manner of mirror images when moving. That is, one side moves by MV_{diff} and the other side moves by −MV_{diff} on the basis of the respective original MVs, as shown in FIG. 11. In FIG. 11, the two reference pictures include a reference picture L0 (refPic in ListL0) and a reference picture L1 (refPic in ListL1). Fractional sample search is also supported during search, so a MV with higher accuracy than the original MV may be found through the DMVR. Searching is performed according to a certain rule, generally, the integer sample MVs within a certain range are searched first, to find an integer sample MV with the lowest matching cost, and then the fractional sample MVs are searched on the basis of the integer sample MV. If an MV with a smaller matching cost than the original MV is found, the MV with the smaller matching cost is used for motion compensation prediction. The MV improved through the DMVR can theoretically be used for the storing of MV and surrounding blocks. For example, when a merge candidate list is constructed for the current block, if the MV of the surrounding block is improved through the DMVR, the improved MV is used to construct the merge candidate list, which may achieve better compression effect. However, due to the consideration of hardware implementation, VVC does not do this.

The DMVR can perform the processing based on sub-blocks. In fact, in VVC, if there are more than 16 samples in the horizontal or vertical direction of the block, the sub-block may be partitioned by a size of 16 samples. On the one hand, this is based on the consideration of hardware implementation complexity, because DMVR needs to search at the decoding side, limiting the size of the sub-block can reduce the cost of caching. On the other hand, the processing is performed after it is partitioned into sub-blocks, which provides better flexibility. Each sub-block can independently improve the MV, which achieves the effect of improving the partitioning accuracy to a certain extent, and also improves the compression efficiency.

In another possible implementation, for the BDOF, the BDOF is also a typical decoder-side method. As its name, the BDOF improves MV and prediction based on the principle of optical flow. Optical flow is the instantaneous velocity of pixel motion of a spatially moving object on the observed imaging plane. There are some basic assumptions for optical flow. For example, the luma is constant. That is, when the same object moves between different pictures, its luma does not change. As another example, the time is continuous or the motion is small motion. That is, the change in time does not cause a drastic change in the target position.

One start condition for BDOF in VVC is that the two reference pictures of the current block are respectively from a picture preceding the current picture and a picture after the current picture, and the distances between the two reference pictures and the current picture are equal. In VVC, for each 4×4 sub-block, BDOF derives a motion vector deviation (vₓ, v_{y}) calculated by minimizing the difference between prediction values in two directions. This motion vector deviation is also used to adjust the prediction value in the corresponding sub-block. The derivation process is as follows:

First, the horizontal and vertical gradients of the two prediction blocks are calculated, that is,

$$\frac{\partial {I}^{( k )}}{\partial x} ( i , j ) and \frac{\partial {I}^{( k )}}{\partial y} ( i , j ) ,$$

k=0,1. The details are as follows:

$$\frac{\partial {I}^{( k )}}{\partial x} ( i , j ) = ( ( {I}^{( k )} ( i + 1 , j ) >> shift1 ) - ( {I}^{( k )} ( i - 1 , j ) >> shift1 ) ) \qquad ( 3 )$$

$$\frac{\partial {I}^{( k )}}{\partial y} ( i , j ) = ( ( {I}^{( k )} ( i , j + 1 ) >> shift1 ) - ( {I}^{( k )} ( i , j - 1 ) >> shift1 ) ) \qquad ( 4 )$$

Where I^{(k)} (i, j) is the prediction value of the coordinates (i, j) of the reference picture list k, k=0,1, shift1 is calculated from the bit depth bitDepth of the luma, shift1=max(6, bitDepth−6).

Secondly, S₁, S₂, S₃, S₅, and S₆ are computed as follows:

$${S}_{1} = {\sum }_{( i , j ) ∈ Ω} Abs ( {ψ}_{x} ( i , j ) ) \qquad ( 5 )$$

$${S}_{2} = {\sum }_{( i , j ) ∈ Ω} {ψ}_{x} ( i , j ) \cdot Sign ( {ψ}_{y} ( i , j ) ) \qquad ( 6 )$$

$${S}_{3} = {\sum }_{( i , j ) ∈ Ω} θ ( i , j ) \cdot Sign ( {ψ}_{x} ( i , j ) ) \qquad ( 7 )$$

$${S}_{5} = {\sum }_{( i , j ) ∈ Ω} Abs ( {ψ}_{y} ( i , j ) ) \qquad ( 8 )$$

$${S}_{6} = {\sum }_{( i , j ) ∈ Ω} θ ( i , j ) \cdot Sign ( {ψ}_{y} ( i , j ) ) \qquad ( 9 )$$

Wherein,

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad ( 1 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a} \qquad ( 2 )$$

$$θ ( i , j ) = ( {I}^{( 1 )} ( i , j ) >> {n}_{b} ) - ( {I}^{( 0 )} ( i , j ) >> {n}_{b} ) \qquad ( 3 )$$

Where Ω is a 6×6 window around a current 4×4 sub-block, nₐ is min (1, bitDepth−11), and n_{b} is min (4, bitDepth−8).

Again, the motion vector deviation (vₓ, v_{y}) is calculated as follows:

$${v}_{x} = {S}_{1} > 0 ? clip 3 ( - t {h}_{BIO}^{′} , t {h}_{BIO}^{′} , - ( ( {S}_{3} \cdot {2}^{{n}_{b} - {n}_{a}} ) >> ⌊ {log}_{2} {S}_{1} ⌋ ) ) : 0 \qquad ( 13 )$$

$${v}_{y} = {S}_{5} > 0 ? clip 3 ( - t {h}_{BIO}^{′} , t {h}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) ) : 0 \qquad ( 14 )$$

Where

$${S}_{2 , m} = {S}_{2} >> {n}_{{S}_{2}} , {S}_{2 , s} = {S}_{2} \& ( {2}^{{n}_{{S}_{2}}} - 1 ) , t {h}_{BIO}^{′} = {2}^{max ( 5 , B D - 7 )} ,$$

└⋅┘ is rounded down, n_{S}_{₂}=12, and BD is bitDepth.

Again, according to the motion vector deviation and gradient, each prediction value within the 4×4 sub-block is adjusted as follows:

$$( 15 )$$

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + \text{} {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the prediction value of the BDOF is calculated as follows:

$${pred}_{BDOF} ( x , y ) = ( {I}^{( 0 )} ( x , y ) + {I}^{( 1 )} ( x , y ) + b ( x , y ) + {o}_{offset} ) >> shift \qquad ( 16 )$$

Where o_{offset} and shift are calculated from the bit depth of the luma. nₐ, n_{b} and shift are all processes done to reduce the bit width during the calculation process.

In this way, the motion vector deviation of BDOF can achieve high accuracy, thus making the prediction more accurate, and the sub-block-based processing also improves the flexibility. These two aspects are similar to DMVR.

It is also understood that both DMVR and BDOF have the effect of improving motion vectors. DMVR is based on block matching, and BDOF is based on optical flow principle. They can be used in combination. Exemplarily, it may be referred to as Multi-pass Decoder-side Motion Vector Refinement (MDMVR).

The first operation is motion vector refinement based on bidirectional matching of a whole block. The second operation is motion vector improvement based on bidirectional matching of a sub-block. The block size in this operation may be 16×16. The third operation is motion vector refinement based on bidirectional optical flow of a sub-block. The sub-block size in this operation may be 8×8. At present, on this basis, further operations can be added, such as a fourth operation, which is motion vector refinement based on bidirectional optical flow of a 4×4 sub-block. Or motion vector refinement based on bidirectional optical flow of a point, etc. may be further added.

It can also be understood that the method of Template Matching (TM) was first used in inter prediction. In the method of MT, based on the correlation between neighboring samples, some regions around the current block are used as templates. When the current block is encoded/decoded, the left and top sides of the current block have been encoded/decoded according to the coding order. Of course, when it is implemented by the existing hardware decoder, it may not be ensured that when decoding of the current block starts, the left and top sides of the current block have been decoded. Of course, here is for an inter block. For example, in HEVC, the inter-coded block does not require the surrounding reconstructed samples when a prediction block is generated, so the prediction process of the inter-coded block can be performed in parallel. However, an intra-coded block must require the reconstructed samples on the left and top sides as reference samples. Theoretically, samples on the left and top sides are available, that is to say, it can be achieved by correspondingly adjusting the hardware design. In contrast, samples on the right and below sides are not available under the encoding order of current standards such as VVC.

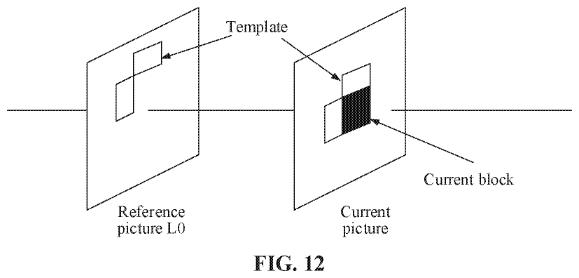

As shown in FIG. 12, the rectangular regions on the left side and the top side of the current block are set as templates, and the height of the portion of the templates on the left side is generally the same as the height of the current block, and the width of the portion of the templates on the top side is generally the same as the width of the current block. Or, the height of the portion of the templates on the left side may not the same as the height of the current block, and the width of the portion of the templates on the top side may not the same as the width of the current block. A best matching position of the template is searched for in the reference picture L0 to determine the motion information or motion vector of the current block. This process can be generally described as starting from a starting position in a certain reference picture and searching within a certain range around it. A search rule may be set in advance, such as a search scope, a search step size, etc. Every time it is moved to a position, the matching degree between the template corresponding to the position and the template around the current block is calculated. The so-called matching degree can be measured by some distortion costs, such as Sum of Absolute Difference (SAD), Sum of Absolute Transformed Difference (SATD), Mean-Square Error (MSE). Generally, the transform used for SATD is Hadamard transform. The smaller the values of SAD, SATD, MSE, etc., the higher the matching degree. The cost is calculated by using the prediction block of the template corresponding to the position and the reconstructed block of the template around the current block. In addition to the search for the integer sample position, the search for the fractional sample position may be performed, and the motion information of the current block may be determined according to the searched position with the highest matching degree. With the correlation between neighboring samples, the motion information appropriate for the template may also be the motion information appropriate for the current block. Of course, the template matching method may not be applicable to all blocks, so some methods can be used to determine whether the above template matching method may be used for the current block. For example, a control switch for indicating whether the template matching method is used for the current block. One name for this template matching method is Decoder side Motion Vector Derivation (DMVD). Both the encoder and the decoder can perform searching using the template, to derive motion information or find better motion information on the basis of the original motion information. Specific motion vectors or motion vector differences do not need to be transmitted, but both the encoder and the decoder performs searching according to the same rule to ensure the consistency between encoding and decoding. The template matching method can improve the compression performance, but it needs to “search” on the decoding side, which brings a certain degree of complexity on the decoding side.

### (2) Intra Prediction.

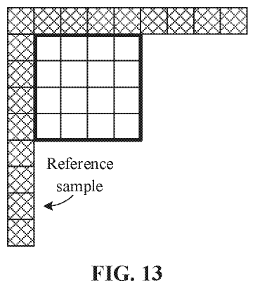

There is a strong spatial correlation between adjacent parts or neighboring samples in the picture. Intra prediction is a prediction method that uses the spatial correlation between the encoded samples around the current block and the samples inside the current block. Exemplarily, as shown in FIG. 13, 4×4 white padding samples are the current block, and grid padding samples on the left column and the top row of the current block are reference samples of the current block, and intra prediction uses these reference samples to predict the current block. These reference samples may already be all available, i.e. all have been coded and decoded. Some of these reference samples may be not available. For example, if the current block is the leftmost side of the entire picture, then the reference sample on the left side of the current block is not available. Or when the current block is encoded/decoded, the below left of the current block has not been encoded/decoded, so the reference samples at the below left are not available. In the case where the reference sample is not available, the reference samples that are available or certain values or certain methods may be used for padding, or no padding may be performed.

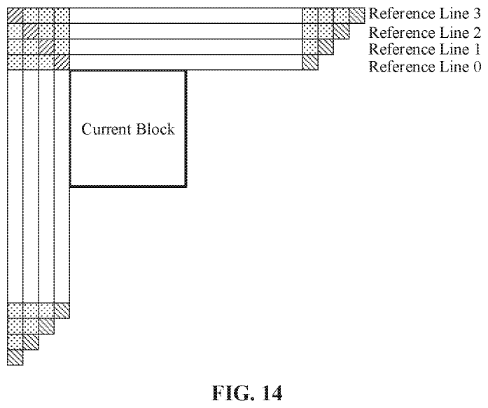

It should also be noted that the Multiple Reference Line (MRL) intra prediction method can use more reference samples to improve coding efficiency. As shown in FIG. 14, it is a schematic diagram using four reference rows/columns.

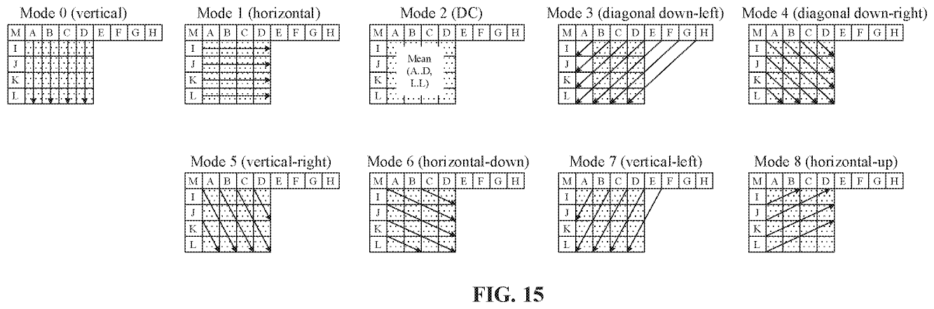

There are a plurality of prediction modes for intra prediction, as shown in FIG. 15. Here, there are nine modes for intra prediction of 4×4 blocks in H.264. Mode 0 (vertical mode) is to copy the samples above the current block to the current block in the vertical direction as the prediction value. Mode 1 (horizontal mode) is to copy the left reference sample to the current block in the horizontal direction as the prediction value. Mode 2 (DC mode) is to copy the average value of eight points A to D and I to L as the prediction value of all points. Modes 3 to 8 are to copy the reference sample to the corresponding position of the current block according to a certain angle respectively. Because some positions in the current block may not exactly correspond to a reference sample, a weighted average value of reference samples or a fractional sample obtained by interpolating the reference samples may be used.

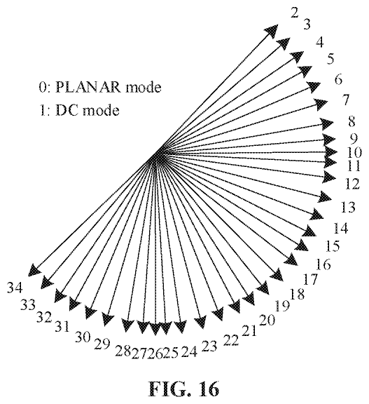

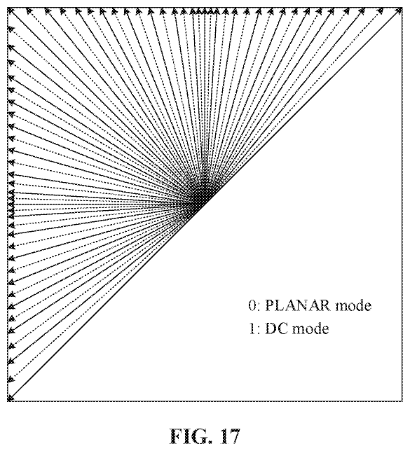

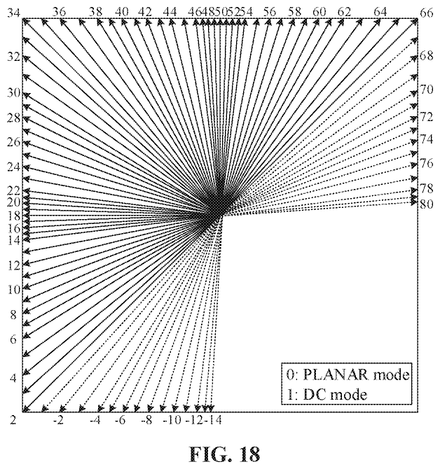

In addition, there is PLANE, PLANAR and other modes. With the development of technology and the expansion of blocks, there are more and more angle prediction modes. For example, the intra prediction modes used by HEVC include PLANAR, DC and 33 angle modes, a total of 35 prediction modes, as shown in FIG. 16 for details. The intra modes used by VVC include PLANAR, DC and 65 angle modes, a total of 67 prediction modes, as shown in FIG. 17 for details. Or, in addition to the above 67 modes, VVC also provides wide-angle modes for some rectangular blocks with large differences between the length and the width, such as, the modes indicated by the dotted lines in the figure, that is, two ranges −14~−1 and 67~80. They will replace some conventional modes, as shown in FIG. 18 for details.

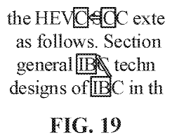

It is also understood that, for Intra Block Copy (IBC), IBC can significantly improve the compression efficiency of Screen Content Coding (SCC), and thus IBC is used for Screen Content Coding from HEVC to VVC. Screen content is different from camera captured content. The screen content is generated by a computer. The screen content has no noise, contains text, computer graphics, etc., and has clear boundaries. There is a lot of repetitive content in the screen content, as shown in FIG. 19.

In the embodiments of the present application, it can be considered that IBC uses an inter prediction method to intra prediction. Herein, the inter prediction uses a reference block on a reference picture to generate a prediction block of the current block, the reference picture is not the current picture. In IBC, a reference block is searched for in the encoded/decoded part or reconstructed part of the current picture, to generate the prediction block of the current block. IBC may also be referred to as intra picture block compensation or Current Picture Referencing (CPR).

The IBC can use a block vector (BV) to represent the position difference between the current block and the reference block, which is similar to the inter-predicted MV. The encoder determines a best matching block of the current block through the block matching method within the search range, and encodes the BV. There are many methods for encoding the BV, for example, the merge mode can be used, which is similar to inter prediction, and will not be repeated here.

IBC can be regarded as an intra prediction method, or it can be regarded as another kind of prediction method independent of intra prediction and inter prediction. IBC has high efficiency in encoding screen content, and can also improve compression efficiency in natural sequences collected by cameras.

Intra Template Matching Prediction (IntraTMP) in ECM 10 can be regarded as a special IBC. In the IntraTMP, a reference block is also searched for in the encoded part of the current picture, to generate a prediction block of the current block. In the IntraTMP, the reconstructed samples within a certain range on the left side and top side of the current block are taken as templates of the current block. When a BV is searched, the reconstructed samples within certain ranges on the left side and top side of the reference block having the same size as the current block and corresponding to the BV are the templates of the reference block, a matching cost between the template of the current block and the template of the reference block is calculated, and the reference block is determined according to the matching cost, to generate the prediction block.

It is also understood that for Decoder-side Intra Mode Derivation (DIMD), the in the DIMD, a prediction mode is derived using the reconstructed samples on the left and top sides of the current block, but instead of predicting on the template, the gradient of the reconstructed samples is analyzed.

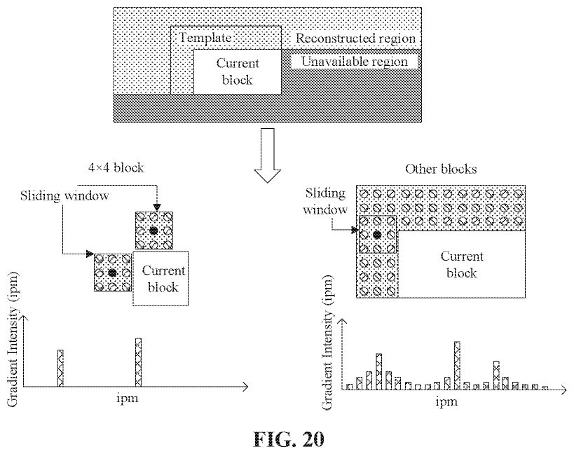

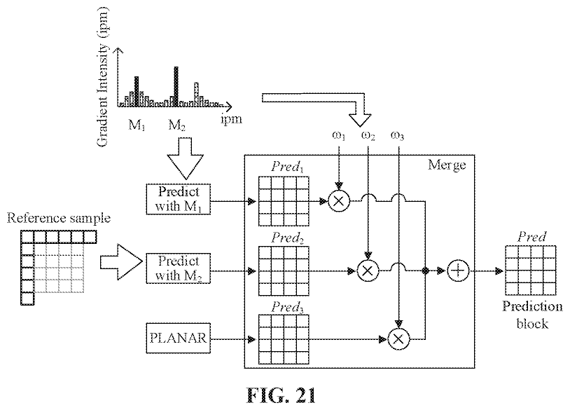

As shown in FIG. 20, through the DIMD, the gradients of black points are analyzed, such as horizontal gradients and vertical gradients, an intra prediction mode adopted according to its gradients, and all the points to be checked are analyzed to obtain a result similar to the following histogram, that is, the statistics of the number of points matched with each intra prediction mode. Of course, the so-called histogram is only used to help understand, and the specific implementation can be in many simple forms. The current DIMD selects the two highest intra prediction modes in the histogram, plus the PLANAR mode. The prediction values in the three intra prediction modes are weighted, and the weights are related to the analysis results. Exemplarily, as illustrated in FIG. 21, the three intra prediction modes include a mode M₁, a mode M₂, and a PLANAR mode. The prediction values obtained in the three intra prediction modes are set to Pred₁, Pred₂, Pred₃, respectively, and the weight values for the three intra prediction modes are set to w₁, w₂, w₃, respectively, and the specific calculation formulas are as follows:

$${w}_{1} = \frac{43}{64} \times \frac{ampl ( {M}_{1} )}{ampl ( {M}_{1} ) + ampl ( {M}_{2} )} \qquad ( 17 )$$

$${w}_{2} = \frac{43}{64} \times \frac{ampl ( {M}_{2} )}{ampl ( {M}_{1} ) + ampl ( {M}_{2} )} \qquad ( 18 )$$

$${w}_{3} = \frac{21}{64} \qquad ( 19 )$$

The final prediction block may be as follows:

$$Pred = {\sum }_{i = 1}^{3} {w}_{i} \times {Pred}_{i} \qquad ( 20 )$$

To sum up, DIMD uses gradient analysis for reconstructed samples to screen intra prediction modes, and two intra prediction modes plus planar can be weighted according to the analysis results. The advantage of DIMD is that if the DIMD mode is selected for the current block, it does not need to indicate which intra prediction mode is used, the intra prediction mode is derived by the decoder itself through the above process, which reduces overhead to a certain extent.

It can also be understood that for Cross-Component Prediction (CCP), since there is a strong correlation between different components in the same space, video coding techniques can utilize this correlation to improve compression efficiency. In some cases, a first component of a same space will be encoded/decoded first, and then a second component and a third component will be encoded/decoded, so that some information of the first component may be used for the second component and the third component. For example, in the YUV format, samples of U and V can be predicted with the reconstructed samples of Y at the corresponding position. If it is in the YUV4:2:0 format, the sample positions of U and V do not correspond to the position of Y one-to-one, and the reconstructed sample of corresponding Y can be found by downsampling or other methods and used for prediction.

A typical example of the CCP in VVC is the Cross-Component Linear Model (CCLM). Other cross-component prediction technologies in ECM include Multi-Model CCLM (MM-CCLM), Convolutional Cross-Component Model (CCCM), Multi-Model CCCM (MM-CCCM), Gradient Linear Model (GLM), inter-CCCM, etc. Other derivative technologies will not be listed one by one. They are all technologies in which the second/third color components use some information of the first color component, such as reconstructed values, to predict. Cross-component prediction techniques may be used for intra-coded blocks as well as inter-coded blocks. For example, the inter-CCCM is used for the inter coded blocks.

### (1) Cross-Component Linear Model (CCLM).

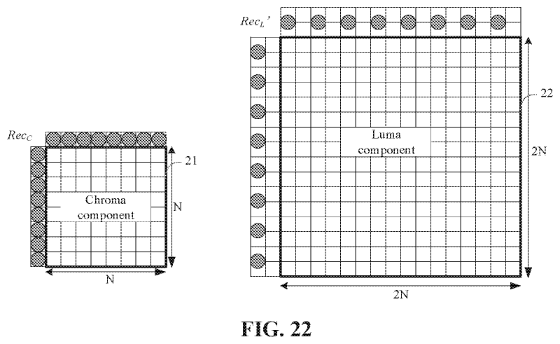

CCLM, as its name implies, is a technique in which a prediction is performed using a linear model for a first color component and a second/third color component. Specifically, as follows:

$${pred}_{C} ( i , 1 ) = α \cdot {rec}_{L}^{′} ( i , j ) + β \qquad ( 21 )$$

Where pred_{C}(i, j) represents a prediction value of a chroma sample at the position (i, j) and rec_{L}′ represents the reconstructed value of the down-sampled luma sample at the position (i, j). The model parameters (α and β) of the CCLM are derived from the neighboring down-sampled luma samples and chroma samples of the current block. As an example, as shown in FIG. 22, a schematic diagram of sampling of adjacent reference values of a luma component of a current block and sampling of adjacent reference values of a chroma component of the current block are shown here. In (a), a bold larger box is used to highlight a chroma block 21, while gray solid circles are used to indicate adjacent reference values of the chroma block 21. In (b), the bold larger box is used to highlight a luma block 22, while grey solid circles are used to indicate adjacent reference values of the luma block 22. The chroma block 21 has a size of N×N, and the luma block 22 has a size of 2N×2N. Here, both the adjacent reference values of the chroma block 21 and the adjacent reference values of the luma block 22 are used to derive the model parameters α and β.

The basic principle is to derive a linear model by using the adjacent luma and chroma samples of the current block, and then apply this linear model to the current block, and determine the prediction value of chroma according to the reconstructed value of luma and this linear model.

### (2) Multi-Model CCLM.

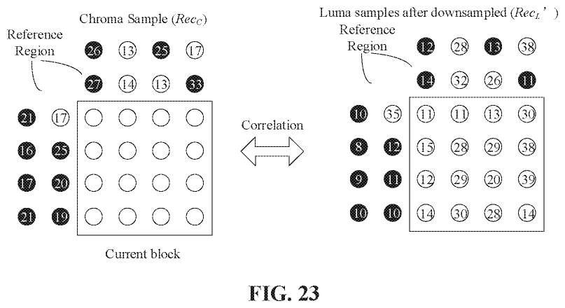

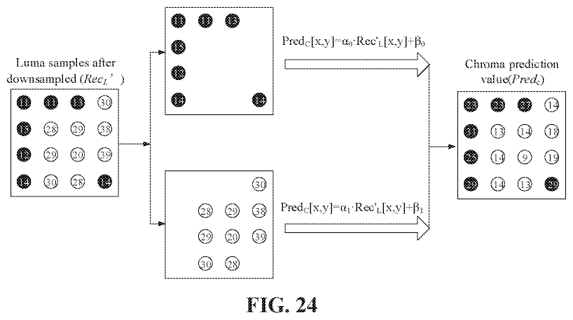

MM-CCLM is an extension of the CCLM, which uses only one linear model in the current block. However, as the name implies, the MM-CCLM uses multiple linear models. Specifically 2 linear models are used in ECM-10. In order to derive 2 linear models, the neighboring luma samples on the left and top side of the current block used to derive the linear model are divided into 2 groups, and a threshold for grouping is the median value of these luma sample values. When the current block is predicted, the luma samples of the current block are also divided into two groups by using the threshold, and respective models are used for prediction. FIG. 23 is a schematic diagram of groups for the MM-CCLM, and FIG. 24 is a schematic diagram of a prediction for the MM-CCLM.

### (3) Convolutional Cross-Component Model (CCCM).

Similar to the CCLM, in the CCCM, a cross-component model is also derived based on the reconstructed parts on the left and top sides of the current block, but a larger reconstructed region is used for the CCCM, and it can derive a nonlinear model. Another difference is that in the CCLM, a down-sampled luma value is used to predict a chroma value, while in the CCCM, a luma reconstructed value at a position corresponding to a chroma sample and luma reconstructed values at the top, below, left and right positions around it are used.

Specifically, the CCCM uses a 7-tap convolution filter including five spatially neighboring samples, C (center) is a luma sample corresponding to a current chroma sample, N (north) is a luma sample above C, S (south) is a luma sample below C, W (west) is a luma sample on the left side of C, and E is a luma sample on the right side of C. There is also a nonlinear term P, P=(C×C+midVal)>>bitDepth, where midVal means a median value, and bitDepth means a bit width. For the case of 10 bits, P=(C×C+512)>>10. There is also an offset term B, which is set to be the median value, and is 512 for the 10-bit case. A prediction value of a chroma Sample predChromaVal=C₀C+C₁N+C₂S+C₃E+C₄W+C₅P+C₆B.

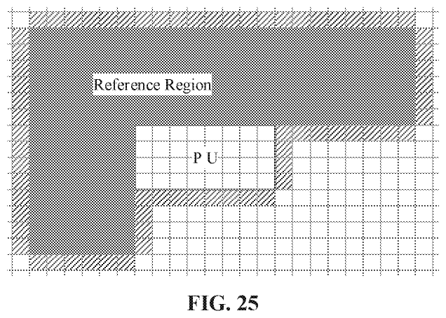

In order to determine C₀, C₁, C₂, C₃, C₄, C₅, C₆, the CCCM applies the same model to predict the chroma in the reference region as shown in FIG. 25 and compares it with the reconstructed chroma value to solve C₀, C₁, C₂, C₃, C₄, C₅, C₆ that minimize the mean square error.

### (4) Multi-Model Convolution Cross-Component Model (MM-CCCM).

Similar to the MM-CCLM, multiple models are used for the current block. Herein, two models are used in ECM-10, and the derivation method is also that a threshold is used to divide the reconstructed luma samples and the luma samples of the current block into two groups, which are used to respectively derive CCCM models, to perform prediction respectively and combine them into a prediction block.

### (5) Gradient Linear Model (GLM).

The GLM is a method of predicting chroma based on the gradient of luma. There are 2 GLM modes here, one mode is 2-parameter GLM and one mode is 3-parameter GLM. Herein:

The formula of the 2-parameter GLM is pred_{C}(i, j)=α·grad_{L}(i, j)+β;

The formula of the 3-parameter GLM is pred_{C}(i, j)=α₀·grad_{L}(i, j)+α₁·rec_{L}′(i,j)+β.

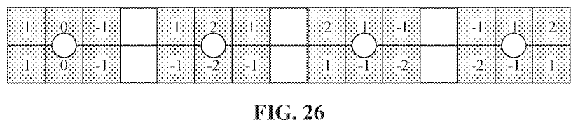

Here, in the 2-parameter GLM, the reconstructed sample value of the down-sampled luma in the CCLM is replaced with the gradient of the luma. The 3-parameter GLM adds the gradient of the luma based on the CCLM. There are four calculation methods for the gradient of luma as shown in FIG. 26. The filter block corresponds to the luma sample, and the circle corresponds to the chroma sample. This is a set of filters designed for the YUV4:2:0 format.

### (6) Inter CCCM.

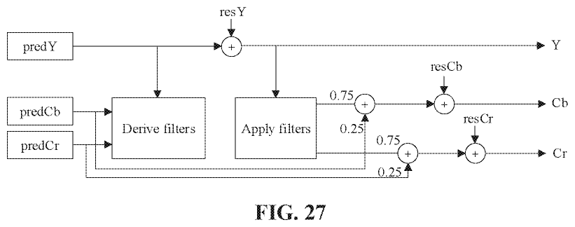

Intra prediction and inter prediction are different. Intra prediction uses reconstructed samples around the current block to predict the inside of the current block, while inter prediction uses pictures of the same object at different times to predict. The most basic motion for inter prediction is translational motion. That is, a motion vector is used to find a reference block and the reference block is used as the prediction block. Since it is the same object found from a different time, the reference picture contains the same number of components as the current picture. For a sequence in YUV format, all three components of YUV can obtain prediction values from the reference block. The above-mentioned cross-component models such as CCLM and CCCM all follow an intra-like approach, that is, the surrounding reconstructed samples are used to derive the model. However, the inter-CCCM uses the existing prediction block for the inter prediction to derive the cross-component model (filter coefficients), as shown in FIG. 27. In FIG. 27, resY, resCb, and resCr represent a luma residual, a blue chroma residual, and a red chroma residual, respectively. Then the addition operation is performed in combination with the corresponding prediction values to obtain the luma reconstructed value Y, the blue chroma reconstructed value Cb and the red chroma reconstructed value Cr. That is, after the luma is reconstructed, the derived model (filter coefficients) is applied to the luma reconstructed value to obtain a second chroma prediction value, and the existing prediction value and the second prediction value obtained by the inter-CCCM are weighted as a new prediction value. The inter-CCCM converts the reconstructed value including the luma residual into the prediction of the chroma through the model, thereby improving compression efficiency.

Further, the transform technology will be described below.

When encoding, the current general hybrid coding framework will perform prediction first. The prediction uses the spatial or temporal correlation performance to obtain a picture that is the same or similar to the current block. It is possible that the prediction block and the current block are exactly the same for a block, but it is difficult to guarantee that this is true for all blocks in a video, especially for natural video, or video captured by a camera. It is difficult to completely predict changes of the irregular motion, distortion, occlusion, luma, etc. in the video. Therefore, the hybrid coding framework will subtract the predicted picture from the original picture of the current block to obtain the residual picture, or subtract the prediction block from the current block to obtain the residual block. The residual block is usually much simpler than the original picture, so prediction can significantly improve the compression efficiency. The residual block is also not directly encoded, but usually transformed first. Transform is to transform the residual picture from the spatial domain to the frequency domain, and remove the correlation of the residual picture. After the residual picture is transformed into the frequency domain, because the energy is mostly concentrated in the low frequency region, the transformed non-zero coefficients are mostly concentrated in the top left corner. Next, quantization is used to further compress. Moreover, since the human eye is insensitive to high frequencies, larger quantization steps can be used in high frequency regions.

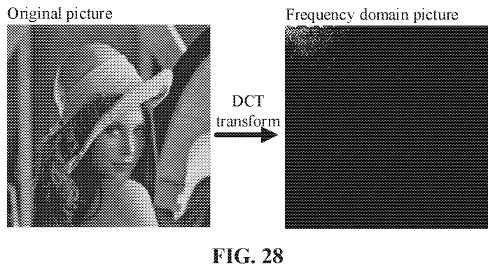

FIG. 28 is a schematic diagram of a DCT transform. As shown in FIG. 28, only the top left corner region of the original picture has non-zero coefficients after DCT transform. Of course, in this example, the DCT transform is performed on the entire picture. In video encoding/decoding, the picture is divided into blocks for processing, so the transform is also based on blocks.

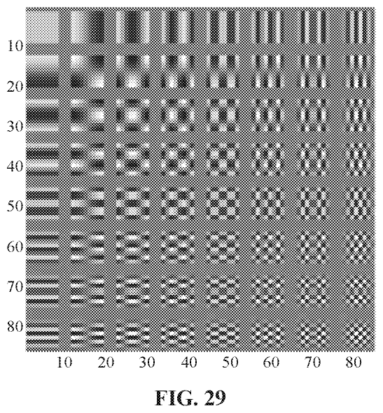

Transform is very useful in common video compression, but not all blocks have to be transformed. In some cases, transform will obtain an effect not as good as compression without transform. Therefore, in some standards such as VVC, the encoder can choose whether the current block uses transform or not. DCT2 (DCT-II) is the most commonly used transform in video compression standards, and its transformed base picture is shown in FIG. 29.

In addition, DCT8 (DCT-VIII) and DST7 (DST-VII) can also be used as a VVC. The basic formulas of these transforms are shown in Table 3, where the basic transform formulas of DCT2, DCT8, and DST7 for N point inputs are shown.

TABLE 3

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Since the pictures are all two-dimensional, and the calculation amount and memory overhead for directly performing two-dimensional transform are unacceptable to the hardware conditions at that time, the above-mentioned DCT2, DCT8, and DST7 transforms used in the standard are all divided into one-dimensional transforms in horizontal direction and the vertical direction and is performed in two steps. For example, the horizontal direction transform is performed first and then the vertical direction transform is performed, or the vertical direction transform is performed first and then the horizontal direction transform is performed.

### (1) Multi-Transform Selection (MTS).

VVC supports transform kernels such as DCT2, DCT8, and DST7. For a block, the encoder can select an appropriate transform kernel and transmit an index into the bitstream. The decoder determines the transform kernel of the inverse transform according to the index. Different transform kernels can be selected for the horizontal direction and the vertical direction, such as DCT8 for the horizontal direction and DST7 for the vertical direction. This technique is generally referred to as MTS.

### (2) Low-Frequency Non-Separable Transform (LFNST).

The above transform method is more effective for horizontal and vertical textures, but the effect for oblique textures will be worse. Indeed, horizontal and vertical textures are the most common, so the above transform method is very useful to improve compression efficiency. With the increasing demand for compression efficiency, if the oblique texture can be processed more effectively, the compression efficiency can be further improved.

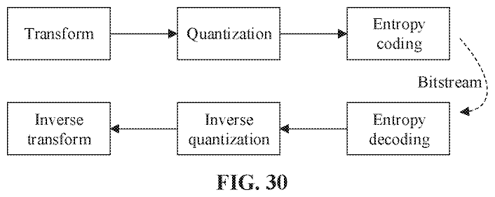

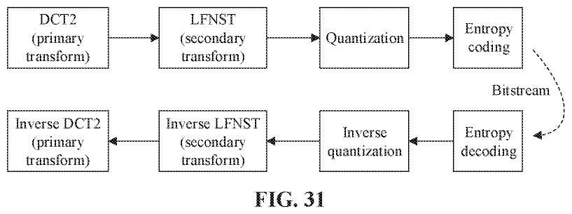

To handle the residuals of oblique textures more efficiently, the LFNST is used in VVC. The above transforms such as DCT2, DCT8, and DST7 are referred to as primary transforms. At the encoding side of VVC, LFNST is used after DCT2 transform and before quantization. At the decoding side of VVC, LFNST is used after inverse quantization and before inverse DCT2 transform. Because it is transformed on the basis of DCT2 (primary transform), LFNST is a secondary transform. FIG. 30 is a schematic diagram of a coding and decoding flow without LFNST (secondary transform), and FIG. 31 is a schematic diagram of a coding and decoding flow with LFNST (secondary transform). Or, the encoder can directly inverse quantize the stored quantization coefficients without entropy decoding, because entropy coding is lossless.

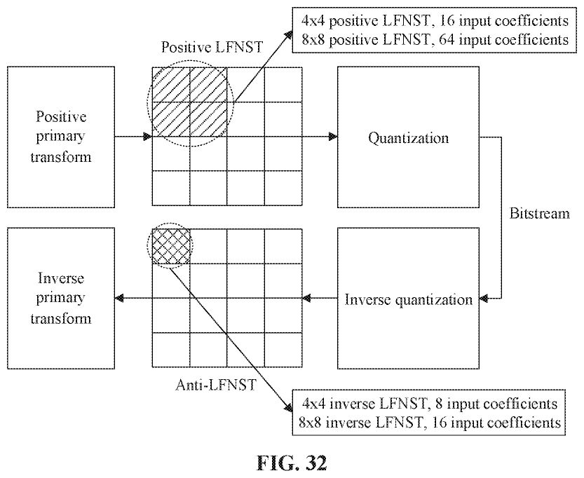

FIG. 32 is a schematic diagram of a detailed encoding and decoding flow with the LFNST (secondary transform). As shown in FIG. 32, at the encoding side, the forward primary transform is first performed, and then a secondary transform LFNST is performed on the low-frequency coefficients in the top left corner after the primary transform. Exemplarily, there are 16 input coefficients for a 4×4 LFNST and 64 input coefficients for an 8×8 LFNST. Then, the coefficients after the LFNST are quantized, and the quantization coefficients are written into the bitstream. At the decoding side, the transform coefficients can be obtained by decoding the bitstream and performing inverse quantization. Then, in the inverse LFNST, there are 8 input coefficients for 4×4 inverse LFNST and 16 input coefficients for 8×8 inverse LFNST. Finally, the inverse primary transform can obtain the residual block.

That is, at the encoding side, the secondary transform LFNST is performed on the low-frequency coefficients in the top left corner after the primary transform. The primary transform concentrates energy to the top left corner by decorrelating the picture. The secondary transform decorrelates the low-frequency coefficients of the primary transform, and the result is intuitively shown in FIG. 32. On the encoding side, 16 coefficients are input to the 4×4 LFNST, and the output is 8 coefficients; 64 coefficients are input to an 8×8 LFNST, and the output is 16 coefficients. On the decoding side, 8 coefficients are input to the 4×4 inverse LFNST, and the output is 16 coefficients; 16 coefficients are input to an 8×8 inverse LFNST, and the output is 64 coefficients.

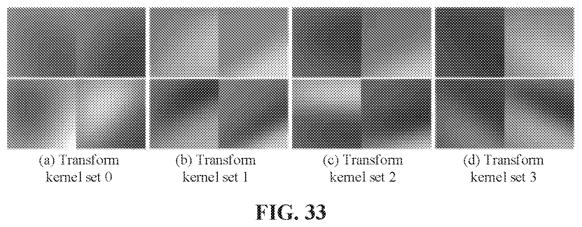

FIG. 33 shows some base pictures for the LFNST in VVC. Some obvious oblique textures can be seen according to FIG. 33. The LFNST not only has transform kernels optimized for some oblique textures, but also has transform kernels optimized for flat gradient textures, such as transform kernel set 0 of the LFNST in VVC.

The LFNST is applied only to intra-encoded blocks. In an angle prediction, the reference samples are tiled to the current block according to the specified angle as the prediction values, which means that the prediction block will have obvious directional texture. The residual of the current block after angle prediction will also show obvious angle characteristics statistically. Therefore, the transform kernel selected by the LFNST can be bound to the intra prediction mode, that is, after the intra prediction mode is determined, the LFNST can only use a set of transform kernels corresponding to the intra prediction mode.

Specifically, the LFNST in VVC has a total of 4 sets of transform kernels, and 2 transform kernels can be selected for each set. Table 4 shows the correspondence between the intra prediction mode and the transform kernel set. It is noted that the cross-component prediction modes used in chroma intra prediction are 81 to 83, but luma intra prediction does not have these modes. The transform kernels of the LFNST can be transposed to handle more angles with one transform kernel set accordingly. Exemplarily, the modes 13 to 23 and 45 to 55 all correspond to transform kernel set 2, but 13 to 23 are clearly near horizontal modes and 45 to 55 are clearly near vertical modes.

TABLE 4

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

The LFNST of the VVC has a total of four sets of transform kernels, and which set is used for the LFNST is specified according to the intra prediction mode. This takes advantage of the correlation between the intra prediction mode and the transform kernel of the LFNST, thereby reducing the transmission for selecting the transform kernel of the LFNST in the bitstream. Whether the LFNST is used for the current block, and if the LFNST is used, whether to use the first or second in a group needs to be determined by the bitstream and some conditions.

In the subsequent evolution of ECM technology, the LFNST is further expanded. LFNST has more transform kernel sets, 35 groups in ECM. The correspondence between the transform kernel set index (LFNST set index) and the intra prediction mode (Intra pred.mode) is shown in Table 5. Each transform kernel set is more efficient for the texture in a respective angle. Here, 3 transform kernels can be selected for each transform kernel set.

TABLE 5

| Intra | | | | | | | | | | | | | | | | |
|---|---|---|---|---|---|---|---|---|---|---|---|---|---|---|---|---|
| pred. mode | −14 | −13 | −12 | −11 | −10 | −9 | −8 | −7 | −6 | −5 | −4 | −3 | −2 | −1 | 0 | 1 |
| LFNST | 2 | 2 | 2 | 2 | 2 | 2 | 2 | 2 | 2 | 2 | 2 | 2 | 2 | 2 | 0 | 1 |
| set index | | | | | | | | | | | | | | | | |

| Intra | | | | | | | | | | | | | | | | |
|---|---|---|---|---|---|---|---|---|---|---|---|---|---|---|---|---|
| pred. mode | 2 | 3 | 4 | 5 | 6 | 7 | 8 | 9 | 10 | 11 | 12 | 13 | 14 | 15 | 16 | 17 |
| LFNST | 2 | 3 | 4 | 5 | 6 | 7 | 8 | 9 | 10 | 11 | 12 | 13 | 14 | 15 | 16 | 17 |
| set index | | | | | | | | | | | | | | | | |
| Intra | | | | | | | | | | | | | | | | |
| pred. mode | 18 | 19 | 20 | 21 | 22 | 23 | 24 | 25 | 26 | 27 | 28 | 29 | 30 | 31 | 32 | 33 |
| LFNST | 18 | 19 | 20 | 21 | 22 | 23 | 24 | 25 | 26 | 27 | 28 | 29 | 30 | 31 | 32 | 33 |
| set index | | | | | | | | | | | | | | | | |
| Intra | | | | | | | | | | | | | | | | |
| pred. mode | 34 | 35 | 36 | 37 | 38 | 39 | 40 | 41 | 42 | 43 | 44 | 45 | 46 | 47 | 48 | 49 |
| LFNST | 34 | 33 | 32 | 31 | 30 | 29 | 28 | 27 | 26 | 25 | 24 | 23 | 22 | 21 | 20 | 19 |
| set index | | | | | | | | | | | | | | | | |
| Intra | | | | | | | | | | | | | | | | |
| pred. mode | 50 | 51 | 52 | 53 | 54 | 55 | 56 | 57 | 58 | 59 | 60 | 61 | 62 | 63 | 64 | 65 |
| LFNST | 18 | 17 | 16 | 15 | 14 | 13 | 12 | 11 | 10 | 9 | 8 | 7 | 6 | 5 | 4 | 3 |
| set index | | | | | | | | | | | | | | | | |

| Intra | | | | | | | | | | | | | | | |
|---|---|---|---|---|---|---|---|---|---|---|---|---|---|---|---|
| pred. mode | 66 | 67 | 68 | 69 | 70 | 71 | 72 | 73 | 74 | 75 | 76 | 77 | 78 | 79 | 80 |
| LFNST | 2 | 2 | 2 | 2 | 2 | 2 | 2 | 2 | 2 | 2 | 2 | 2 | 2 | 2 | 2 |
| set index | | | | | | | | | | | | | | | |

### (3) Inseparable Primary Transform (NSPT).

The LFNST is a horizontal and vertical non-separable transform. Because there is a secondary transform, the DCT2 can be referred to as a primary transform. In this way, it can be said that it is a compromise between performance and complexity to go through the DCT2 first and then the LFNST, because it is more efficient to directly perform inseparable primary transform, but it has higher complexity. For example, the amount of calculation and the storage space for the transform kernel are higher.

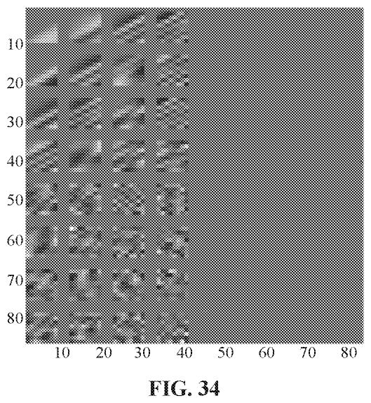

In the ECM10, the NSPT may be used for some small blocks, while the DCT2+LFNST is stilled used for large blocks. The dimensions of the small pieces are such as 4×4, 4×8, 8×4, 8×8, 4×16, 16×4, 8×16, 16×8, 8×32, 32×8. In the ECM 10, the NSPT also matches the transform kernel set according to the intra prediction mode. The matching method can refer to the method for the LFNST, and each transform kernel set has three transform kernels for selection. For example, the 8×8 base picture for one NSPT in the ECM 10 is shown in FIG. 34, which corresponds to the inter angle prediction mode 7. It can be seen that the process of the texture in the corresponding angle is much better. It should be noted that the NSPT is only applied to intra-coded blocks.

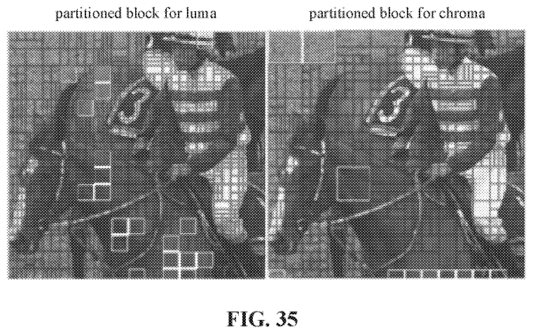

Further, for the partitioning technique, it can include a single tree partitioning and a dual tree partitioning. The luma and chroma in the single tree are partitioned together, and one CU includes a luma block and a chroma block at the same position. In dual tree, luma and chroma are partitioned separately, and a CU has only luma blocks or only chroma blocks. There is only single tree in the HEVC. The dual tree is introduced in the VVC, but the P and B slice in the VVC can only use single tree. The I slice in the VVC can use the dual tree. As shown in FIG. 35, the luma and the chroma are separately partitioned, and it can be seen that the luma has a finer partition than the chroma, because the luma has more detail than the chroma, and generally the luma requires better quality than the chroma.

In summary, in the related art, the LFNST and the NSPT are applied only to intra-coded blocks. Because intra prediction can't predict complex textures perfectly in many cases, intra-coded blocks usually have more residuals, and there is a certain correlation between residuals for the intra prediction and prediction angle statistically. Inter-coded blocks usually can find a better prediction block from the reference picture, so there is less residual. Further, there is no intra prediction mode to match the corresponding transform kernel set. If the selection of transform kernel set is indicated in the bitstream, the overhead will be great. These two aspects may be the reasons why the LFNST and the NSPT of related technologies are not used for inter coding, which makes it less effective in improving the performance of inter-frame coding and decoding.

Based on this, an embodiment of the present application provides an encoding method. An index of a texture feature of a current block is determined. A transform kernel set for the current block is determined according to the index of the texture feature. A transform kernel for the current block is determined according to the transform kernel set. A residual block of the current block is transformed according to the transform kernel to determine a transform coefficient of the current block. Encoding processing is performed on the transform coefficient of the current block, and the obtained encoded bits are written into a bitstream. An embodiment of the present application further provides a decoding method. An index of a texture feature of a current block is determined. A transform kernel set for the current block is determined according to the index of the texture feature. A transform kernel for the current block is determined according to the transform kernel set. An inverse transform is performed on the transform coefficient of the current block according to the transform kernel to determine a residual block of the current block.

In this way, both an encoding side and a decoding side first determine an index of a texture feature of a current block, and then determine a transform kernel set for the current block according to the index of the texture feature, and then determine the transform kernel for the current block according to the transform kernel set. That is, the correspondence between the index of the texture feature and the transform kernel set is established here, which replaces the scheme of matching the transform kernel set according to the intra prediction mode in the related art, so that the LFNST and the NSPT can also be applied to the inter prediction mode. Therefore, for the block that is not easily predicted in the inter prediction mode, that is, the block with a large residual, not only the compression efficiency, that is, the video encoding/decoding efficiency, but also the encoding/decoding performance can be improved.

Hereinafter, embodiments of the present application will be described in detail with reference to the accompanying drawings.

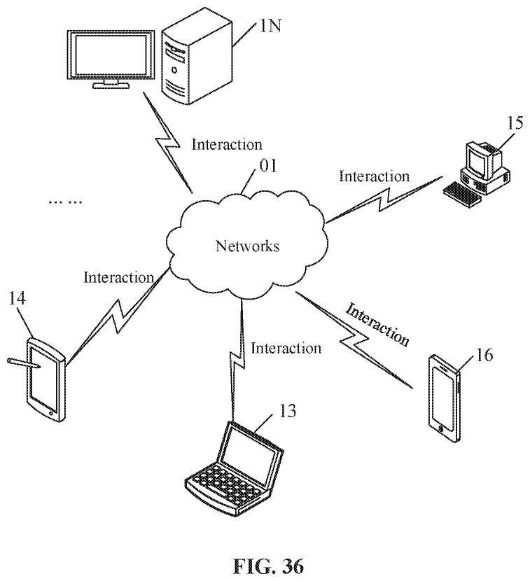

FIG. 36 is a schematic diagram of a network architecture of a video encoder/decoder according to an embodiment of the present application. As shown in FIG. 36, the network architecture includes one or more electronic devices 13-1N and a communication network 01. The electronic devices 13-1N may perform video interaction through the communication network 01. In the process of implementation, the electronic device may be various types of devices having video encoding and decoding functions. For example, the electronic device may include a mobile phone, a tablet computer, a personal computer, a personal digital assistant, a navigator, a digital telephone, a video telephone, a television, a sensing device, a server, and the like, which are not limited in the embodiments of the present application.

In an embodiment of the present application, a network architecture of a video encoding/decoding system including a decoding method and an encoding method is provided herein. The decoder or encoder in the embodiments of the present application may be the electronic device described above. That is, the electronic device in the embodiments of the present application has a video encoding and decoding function, and generally includes a video encoder (that is, an encoder) and a video decoder (that is, a decoder).

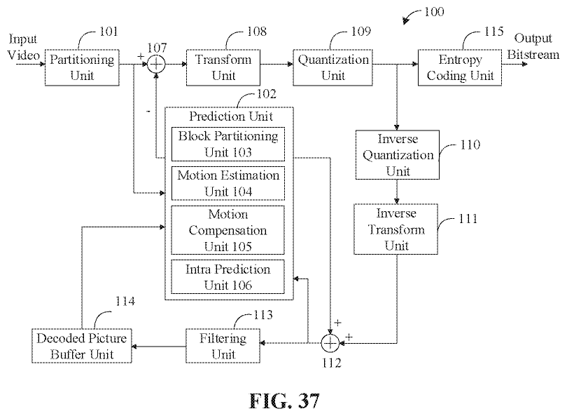

FIG. 37 is a schematic block diagram of a system configuration of an encoder according to an embodiment of the present application. As shown in FIG. 37, the encoder 100 may include a partitioning unit 101, a prediction unit 102, a first adder 107, a transform unit 108, a quantization unit 109, an inverse quantization unit 110, an inverse transform unit 111, a second adder 112, a filtering unit 113, a Decoded Picture Buffer (DPB) unit 114, and an entropy encoding unit 115. Here, the input of the encoder 100 may be a video composed of a series of pictures or one still picture, and the output of the encoder 100 may be a bit stream (which may also be referred to as a “bitstream”) for representing a compressed version of the input video.

The partitioning unit 101 partitions a picture in the input video into one or more Coding Tree Units (CTUs). The partitioning unit 101 divides a picture into a plurality of tiles (or tiles), and may further divide a tile into one or more bricks, where one or more complete and/or partial CTUs may be included in one tile or one brick. In addition, the partitioning unit 101 may form one or more slices, and one slice may include one or more tiles arranged in a raster order in a picture, or one or more tiles covering a rectangular region in a picture. The partitioning unit 101 may also form one or more sub-pictures, one sub-picture may include one or more slices, tiles, or bricks.

During the encoding process of the encoder 100, the partitioning unit 101 transmits the CTU to the prediction unit 102. Generally, the prediction unit 102 may be composed of a block partitioning unit 103, a Motion Estimation (ME) unit 104, a Motion Compensation (MC) unit 105, and an intra prediction unit 106. Specifically, the block partitioning unit 103 further partitions an input CTU into smaller Coding Units (CUs) iteratively using quad-tree partitioning, binary-tree partitioning, and triple-tree partitioning. The prediction unit 102 may acquire an inter prediction block of the CU using the ME unit 104 and the MC unit 105. The intra prediction unit 106 may acquire the intra predicted block of the CU using various intra prediction modes including the MIP mode. In an example, a rate-distortion optimized motion estimation manner may be invoked by the ME unit 104 and the MC unit 105 to obtain an inter prediction block, and a rate-distortion optimized mode determination manner may be invoked by the intra prediction unit 106 to obtain an intra predicted block.

The prediction unit 102 outputs a prediction block of a CU. The first adder 107 calculates the difference between a CU in the output of the partitioning unit 101 and a prediction block of the CU, that is, the residual CU. The transform unit 108 reads the residual CU and performs one or more transform operations on the residual CU to acquire coefficients. The quantization unit 109 quantizes the coefficients and outputs quantization coefficients (i.e., levels). The inverse quantization unit 110 performs a scaling operation on the quantization coefficients to output the reconstructed coefficients. The inverse transform unit 111 performs one or more inverse transforms corresponding to the transforms in the transform unit 108 and outputs the reconstructed residual. The second adder 112 calculates the reconstructed CU by adding the reconstructed residual and the prediction block of the CU from the prediction unit 102. The second adder 112 also transmits its output to the prediction unit 102 for use as an intra prediction reference. After all the CUs in the picture or sub-picture are reconstructed, the filtering unit 113 performs loop filtering on the reconstructed picture or sub-picture. Here, the filtering unit 113 includes one or more filters such as a de-blocking filter, a Sample Adaptive Offset (SAO) filter, an Adaptive Loop Filter (ALF), a luma mapping and chroma scaling (LMCS) filter, a neural network-based filter, and the like. Alternatively, when the filtering unit 113 determines that the CU is not used as a reference when encoding other CUs, the filtering unit 113 performs loop filtering on one or more target samples in the CU.

The output of the filtering unit 113 is a decoded picture or sub-picture, which is buffered to the DPB unit 114. The DPB unit 114 outputs a decoded picture or sub-picture according to the timing and control information. Here, the picture stored in the DPB unit 114 may also be used as a reference for the prediction unit 102 to perform inter prediction or intra prediction. Finally, the entropy encoding unit 115 converts parameters necessary for decoding pictures from the encoder 100 (such as control parameters and supplementary information, etc.) into binary forms, and writes such binary forms into the bitstream according to the syntax structure of each data unit, that is, the encoder 100 finally outputs the bitstream.

Further, the encoder 100 may have a first processor and a first memory having a computer program stored thereon. When the first processor reads and executes the computer program, the encoder 100 reads the input video and generates a corresponding bitstream. Additionally, the encoder 100 may also be a computing device having one or more chips. These units, which are implemented on-chip as integrated circuits, have connection and data exchange functions similar to the corresponding units in FIG. 37.

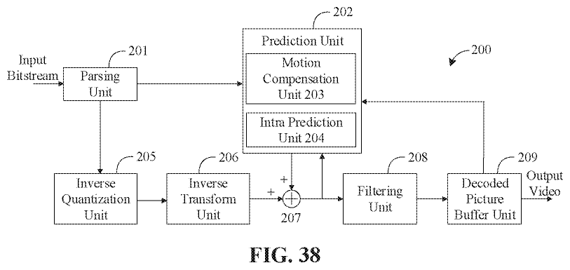

FIG. 38 is a schematic block diagram of a system configuration of a decoder according to an embodiment of the present application. As shown in FIG. 38, the decoder 200 may include a parsing unit 201, a prediction unit 202, an inverse quantization unit 205, an inverse transform unit 206, an adder 207, a filtering unit 208, and a decoded picture buffer unit 209. Here, an input of the decoder 200 is a bitstream representing a compressed version of a video or a still picture, and an output of the decoder 200 may be a decoded video composed of a series of pictures or a decoded still picture.

The input bitstream of the decoder 200 may be a bitstream generated by the encoder 100. The parsing unit 201 parses the input bitstream to acquire a value of an syntax element from the input bitstream. The parsing unit 201 converts the binary representation of the syntax element into a digital value and transmits the digital value to units in the decoder 200 to acquire one or more decoded pictures. The parsing unit 201 may also parse one or more syntax elements from the input bitstream to display a decoded picture.

In the decoding process of the decoder 200, the parsing unit 201 transmits the value of the syntax element and one or more variables for acquiring one or more decoded pictures, which are set or determined according to the value of the syntax element, to the units in the decoder 200.

The prediction unit 202 determines a prediction block of a current decoding block (e.g., CU). Here, the prediction unit 202 may include a motion compensation unit 203 and an intra prediction unit 204. Specifically, when it indicates that the inter decoding mode is used for decoding the current decoding block, the prediction unit 202 passes the relevant parameters from the parsing unit 201 to the motion compensation unit 203 to acquire the inter prediction block. When it is indicates that an intra prediction mode (including a MIP mode indicated based on the MIP mode index value) is used for decoding the current decoding block, the prediction unit 202 transmits the relevant parameters from the parsing unit 201 to the intra prediction unit 204 to acquire an intra prediction block.

The inverse quantization unit 205 has the same function as the inverse quantization unit 110 in the encoder 100. The inverse quantization unit 205 performs a scaling operation on the quantization coefficients (i.e., levels) from the parsing unit 201 to obtain the reconstructed coefficients.

The inverse transform unit 206 has the same function as the inverse transform unit 111 in the encoder 100. The inverse transform unit 206 performs one or more transform operations (i.e., the inverse of the one or more transform operations performed by the inverse transform unit 111 in the encoder 100) to obtain reconstructed residuals.

The adder 207 performs an addition operation on its inputs (the prediction block from the prediction unit 202 and the reconstructed residual from the inverse transform unit 206) to obtain the reconstructed block of the current decoding block. The reconstructed block is also transmitted to the prediction unit 202 for use as a reference for other blocks encoded in the intra prediction mode.

After all CUs in the picture or sub-picture are reconstructed, the filtering unit 208 performs loop filtering on the reconstructed picture or sub-picture. The filtering unit 208 includes one or more filters, such as a deblocking filter, a sample adaptive compensation filter, an adaptive loop filter, a luma mapping and chroma scaling filter, a neural network based filter, and the like. Alternatively, when the filtering unit 208 determines that the reconstructed block is not used as a reference when decoding other blocks, the filtering unit 208 performs loop filtering on one or more target samples in the reconstructed block. Here, the output of the filtering unit 208 is a decoded picture or sub-picture, and the decoded picture or sub-picture is buffered to the DPB unit 209. The DPB unit 209 outputs decoded pictures or sub-pictures according to the timing and control information. The pictures stored in the DPB unit 209 may also be used as a reference for performing inter prediction or intra prediction by the prediction unit 202.

Further, the decoder 200 may have a second processor and a second memory having a computer program stored thereon. When the first processor reads and executes the computer program, the decoder 200 reads the input bitstream and generates the corresponding decoded video. In addition, the decoder 200 may also be a computing device having one or more chips. These units, which are implemented on-chip as integrated circuits, have connection and data exchange functions similar to the corresponding units in FIG. 38.

It should also be noted that when the embodiments of the present application are applied to the encoder 100, the “current block” specifically refers to a block currently to be encoded in a video picture (which may also be simply referred to as a “encoding block”); When the embodiments of the present application are applied to the decoder 200, the “current block” specifically refers to a block currently to be decoded in a video picture (which may also be simply referred to as a “decoding block”).

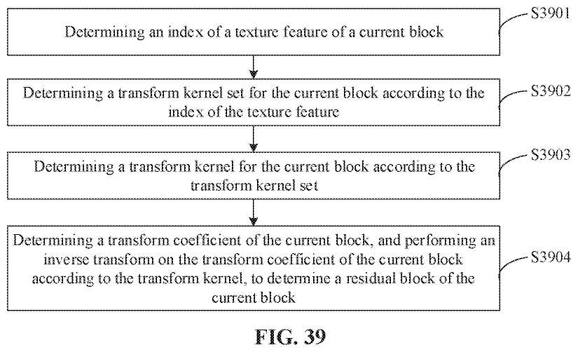

In an embodiment of the present application, see FIG. 39, which shows a schematic flowchart of a decoding method according to an embodiment of the present application. As shown in FIG. 39, the method may include S3901-S3904.

In S3901, an index of a texture feature of a current block is determined.

It should be noted that, in the embodiment of the present application, the method is applied to a decoder. Specifically, based on the composition structure of the decoder 200 illustrated in FIG. 38, the decoding method of the embodiment of the present application is mainly applied to an inter-decoded block. When the inter-decoded block adopts an inter prediction mode, an optimization scheme for NSPT and LFNST in the inter prediction mode is proposed here, so as to improve the compression efficiency of inter prediction.

Here, both the NSPT and the LFNST are transforms that can be used to efficiently process textures with various angles. There may be multiple transform kernels here, and one transform kernel may be specially optimized for a texture with a specific angle. In addition to the textures with angles, the NSPT and the LFNST also include transform kernels for handling gradient textures. In fact, these transform kernels can also be referred to as trained Karhunen-Loeve (KL) Transforms (KLT). That is, both the NSPT and the LFNST may have multiple transform kernels, each of which is designed for a specific texture. The specific texture includes angle textures, gradient textures, etc. In addition, the gradient texture can be further expanded, such as a horizontal gradient texture, a vertical gradient texture, an oblique gradient texture, etc. Further, the present application is not limited to be applied only to non-separable transforms such as the NSPT and the LFNST, but may also be applied to separable transforms optimized for specific textures.

It should be noted that, in an intra predicted block, both the NSPT and the LFNST include a plurality of transform kernel sets, and each intra prediction mode may correspond to one transform kernel set. However, an inter predicted block does not have an intra prediction mode, which is a problem of applying the LFNST and the NSPT to inter prediction. In the embodiment of the present application, a virtual intra prediction mode (index) may be derived from the inter predicted block, or may be referred to as an index of a texture feature. For example, DC mode and PLANAR mode correspond to gradient texture features, and a prediction mode of a certain angle corresponds to a texture feature of the angle. That is, in the embodiment of the present application, on the one hand, the index of the texture feature can avoid the occurrence of an intra prediction mode in “inter”, and on the other hand, it is more conducive to possible expansion. For example, one intra prediction mode can correspond to a plurality of texture features. For example, the DC mode can correspond to a horizontal gradient texture, a vertical gradient texture, an oblique gradient texture, and the like.

In the embodiment of the present application, in order to properly configure the schemes of the NSPT and the LFNST for inter prediction, a virtual intra prediction mode (or “an index of a texture feature”) is proposed here. It is named as the virtual intra prediction mode, because this mode is not used for participating in prediction, but is only used for selection of the transform kernel set for the NSPT or LFNST. The derivation of the index of the texture feature is described in detail below.

In some embodiments, the operation that the index of the texture feature of the current block is determined may include operations that: a candidate sample for deriving the index of the texture feature is determined; and the index of the texture feature of the current block is determined according to the candidate sample.

In one possible implementation, for the candidate sample, a prediction block of the current block may be determined; and at least a portion of samples in the prediction block is taken as the candidate sample.

In the embodiment of the present application, if there is a certain texture in the prediction block, it may be considered that there is a texture with the same feature in the residual block. In this way, the candidate sample used for deriving the index of the texture feature for the inter prediction may be all samples in the prediction block or some samples in the prediction block.

In another possible implementation, for the candidate sample, a neighboring sample of the current block in a reconstructed region may be determined; and the neighboring sample in the reconstructed region is taken as the candidate sample.

In the embodiment of the present application, the candidate sample used for deriving the index of the texture feature for the inter prediction may be a neighboring sample of the current block in the reconstructed region, for example, an reconstructed region on the left and right sides of the current block. Because the reconstructed region on the left and top sides are not the current block but are neighboring to the current block, for example, there is a case that the textures may be connected, they can be used to estimate the texture of the current block to a certain extent.

In yet another possible implementation, it is considered that more samples are used, and for the candidate sample, the neighboring sample in the reconstructed region and at least a portion of samples in the prediction block may be taken as the candidate samples together.

In the embodiment of the present application, the candidate sample used for deriving the index of the texture feature for the inter prediction may include both the prediction block of the current block and the neighboring sample in the reconstructed region on the left and top sides of the current block, so that more samples are used to derive the index of the texture feature, and the derived index of the texture feature is more accurate.

In yet another possible implementation, considering the workflow length of hardware, for the candidate sample, a reference block for the current block may be determined; and at least a portion of samples in the reference block is taken as the candidate sample.

In the embodiment of the present application, for the current block, the index of the texture feature can only be derived after the prediction block is obtained, and the transform kernel for the LFNST/NSPT can only be determined after the index of the texture feature is determined, and then the inverse transform and subsequent processes can be performed. Here, if the reference block is used to derive the index of the texture feature, the process of generating the prediction block and the process of deriving the index of the texture feature can theoretically be carried out in parallel, which is shorter than the workflow using the prediction block. Accordingly, the reference block may also be used to derive the index of the texture feature, or the index of the texture feature may be derived synchronously in the process of generating the prediction block, thereby enabling a shortened workflow length.

In some embodiments, for the reference block for the current block, it is determined that the reference block is an integer sample reference block; or, it is determined that the reference block is a fractional sample reference block.

In one possible implementation, the reference block may directly be the integer sample reference block, because there is no obvious difference in texture direction. For example, for a bi-directional predicted inter block, a virtual intra prediction mode can be derived from an integer sample reference block.

In another possible implementation, the reference block may also be a fractional sample reference block obtained by performing interpolation filtering. Specifically, two reference picture blocks when the current block is bi-directional predicted are determined; fractional sample interpolation filtering is performed on the two reference picture blocks to determine two fractional sample reference picture blocks; and weighted combination is performed on the two fractional sample reference picture blocks, to determine the reference block for the current block.

For example, for a bi-directional predicted inter block, fractional sample interpolation filtering is required to be performed on the two reference blocks first, and then weighted combination is performed on the two fractional sample reference blocks. Then, after obtaining the two interpolation-filtered reference blocks, on the one hand, the prediction value can be obtained by weighted averaging according to the interpolation-filtered reference blocks, and on the other hand, the index of the texture feature can be derived according to the interpolation-filtered reference blocks.

It should also be noted that in the embodiment of the present application, the number of candidate sample used for deriving the index of the texture feature may be at least one, for example, 1, 2, 3, or more. In some embodiments, the number of candidate sample may be determined according to a size parameter of the current block.

That is, when the index of the texture feature of the current block is determined, how many candidate samples are used may be determined by the size parameter of the current block. Exemplarily, if the size of the current block is small, then all available samples may be statistically used. If the size of the current block is large, the current block may be downsampled for being statistically used, such as one sample of every 2, or 4, or 8 samples in the horizontal and/or vertical direction. Alternatively, if the size of the current block in one of the horizontal direction or vertical direction is less than or equal to 8, then all available samples in that direction are statistically used. Otherwise, if the size of the current block in one of the horizontal direction or vertical direction is less than or equal to 16, then one sample of every two samples in that direction is statistically used. Otherwise, one sample of every four samples in this direction is statistically used, which is not specifically limited here.

In some embodiments, the operation that the index of the texture feature of the current block is determined according to the candidate sample may include operations that: a horizontal gradient value and a vertical gradient value of the candidate sample is determined; an index of a texture feature and a gradient intensity value corresponding to the candidate sample is determined according to the horizontal gradient value and the vertical gradient value of the candidate sample; a texture feature statistical table is constructed according to the index of the texture feature and gradient intensity value corresponding to the candidate sample; and the index of the texture feature of the current block is determined according to the texture feature statistical table.

It should be noted that, in the embodiment of the present application, the operation that the index of the texture feature and the gradient intensity value corresponding to the candidate sample is determined according to the horizontal gradient value and the vertical gradient value of the candidate sample may include operations that: an angle mapping is performed according to the horizontal gradient value and the vertical gradient value of the candidate sample, to determine the index of the texture feature corresponding to the candidate sample; and gradient intensity calculation is performed according to the horizontal gradient value and the vertical gradient value of the candidate sample to determine a gradient intensity value corresponding to the candidate sample.

In a specific embodiment, the operation that the angle mapping is performed according to the horizontal gradient value and the vertical gradient value of the candidate sample, to determine the index of the texture feature corresponding to the candidate sample may include an operation that the index of the texture feature corresponding to the candidate sample is determined according to the horizontal gradient value and the vertical gradient value of the candidate sample by using a preset look-up table.

In the embodiment of the present application, the horizontal gradient value of the candidate sample may be represented by gradₓ, and the vertical gradient value of the candidate sample may be represented by grad_{y}. In this way, deriving a virtual intra prediction mode from gradₓ and grad_{y} can be realized by looking up the table.

Exemplarily, if abs(gradₓ) is equal to 0 and abs(grad_{y}) is not equal to 0, then there is a horizontal direction texture, corresponding to intra prediction mode 18 in some techniques. If abs(grad_{y}) is equal to 0 and abs(gradₓ) is not equal to 0, there is a vertical direction texture, corresponding to the intra prediction mode 50 in some techniques. In the case where neither abs(gradₓ) nor abs(grad_{y}) is equal to 0, if abs(gradₓ) is equal to abs(grad_{y}), and gradₓ and grad_{y} have the same sign, corresponding to the intra prediction mode 34 in some techniques. If abs(gradₓ) is equal to 2 times abs(grad_{y}), and gradₓ and grad_{y} have the same sign, corresponding to the intra prediction mode 40 in some techniques. In addition, other situations can be determined by looking up the table according to the same principle.

In a specific embodiment, the operation that the gradient intensity calculation is performed according to the horizontal gradient value and the vertical gradient value of the candidate sample, to determining the gradient intensity value corresponding to the candidate sample may include an operation that: an addition operation is performed on an absolute value of the horizontal gradient value and an absolute value of the vertical gradient value to determine the gradient intensity value corresponding to the candidate sample.

Here, the gradient intensity value corresponding to the candidate sample may be denoted as amp. Exemplarily, amp=abs(gradₓ)+abs(grad_{y}).

It should be noted that, in the embodiment of the present application, the horizontal gradient value and the vertical gradient value for the candidate sample can be calculated using a Sobel operator. Exemplarily, the Sobel operator is as follows:

An operator for the horizontal gradient value is:

| | | |
|---|---|---|
| −1 | 0 | 1 |
| −2 | 0 | 2 |
| −1 | 0 | 1 |

An operator for the vertical gradient value is:

| | | |
|---|---|---|
| −1 | −2 | −1 |
| 0 | 0 | 0 |
| 1 | 2 | 1 |

Thus, it is assumed that the sample value at the pixel position (x, y) is P_{x,y}, the horizontal gradient value gradₓ and the vertical gradient value grad_{y} are calculated as follows:

$$( 22 )$$

$${grad}_{x} = {P}_{x + 1 , y - 1} + 2 * {P}_{x + 1 , y} + {P}_{x + 1 , y + 1} - {P}_{x - 1 , y - 1} - 2 * {P}_{x - 1 , y} - {P}_{x - 1 , y + 1}$$

$$( 23 )$$

$${grad}_{y} = {P}_{x - 1 , y + 1} + 2 * {P}_{x , y + 1} + {P}_{x + 1 , y + 1} - {P}_{x - 1 , y - 1} - 2 * {P}_{x , y - 1} - {P}_{x + 1 , y - 1}$$

In some embodiments, the operation that the texture feature statistical table is constructed according to the index of the texture feature and the gradient intensity value corresponding to the candidate sample may include operations that: when the number of candidate sample is one or more, indexes of one or more texture feature and one or more corresponding gradient intensity values are determined; one or more types of reference texture feature indexes having mutually different characteristics are determined according to the indexes of the one or more texture features, and accumulation calculation is performed on gradient intensity values belonging to a same type of reference texture feature index according to the one or more gradient intensity values, to determine accumulated gradient intensity values corresponding to the one or more types of reference texture feature indexes; and the texture feature statistical table is constructed according to the one or more types of reference texture feature indexes and the accumulated gradient intensity values corresponding to the one or more types of reference texture feature indexes.

That is, in the embodiment of the present application, taking at least some samples in the prediction block being candidate samples as an example, gradient values of all or some samples in the prediction block are calculated, and generally, horizontal gradient values and vertical gradient values can be calculated. Here, the Sobel operator can be used to calculate the gradient values. For a certain sample, the texture direction of the sample can be derived according to its horizontal gradient value and vertical gradient value. For example, if the horizontal gradient value is non-zero and the vertical gradient value is zero, the texture of the sample is vertical. On the contrary, if the horizontal gradient value is zero and the vertical gradient value is non-zero, the texture of the sample is horizontal. For example, if the horizontal gradient value and the vertical gradient value are equal and not zero, the texture of the pixel is 45 degrees. Or, in the embodiment of the present application, there are many other cases in which both the horizontal gradient value and the vertical gradient value are not zero, the direction of the texture of the sample can be determined according to their ratio. In this way, the gradient intensity value of each sample can correspond to an index of the corresponding texture feature. Therefore a texture feature statistical table is constructed, the gradient intensity value of each calculated sample accumulated to index item of the corresponding texture feature in the statistical table to obtain the final texture feature statistical table, and then the index of the texture feature of the current block may be determined according to the texture feature statistical table.

In a possible implementation, the operation that the index of the texture feature of the current block is determined according to the texture feature statistical table may include operations that: a maximum accumulated gradient intensity value in the texture feature statistical table is determined; and an index of a reference texture feature corresponding to the maximum accumulated gradient intensity value is determined as the index of the texture feature of the current block.

In another possible implementation, the operation that the index of the texture feature of the current block is determined according to the texture feature statistical table may include operations that: a maximum accumulated gradient intensity value in the texture feature statistical table is determined; when the maximum accumulated gradient intensity value is less than a first threshold, the index of the texture feature of the current block is set as a DC mode or a PLANANR mode.

In yet another possible implementation, the operation that the index of the texture feature of the current block is determined according to the texture feature statistical table may include operations that: a statistical sum value of all accumulated gradient intensity values in the texture feature statistical table is determined; when the statistical sum value is less than a second threshold, the index of the texture feature of the current block is set as a DC mode or a PLANANR mode.

That is, in the embodiment of the present application, for the deviation of the virtual intra prediction mode (index), since the virtual intra prediction mode (index) may also be referred to as an index of a texture feature, the deviation of the virtual intra prediction mode (index) may also be referred to as derivation of the index of the texture feature here.

In the embodiment of the present application, an inter prediction block may be used to derive a virtual intra prediction mode. If a certain texture exists in the prediction block, it is conceivable that a texture with a same feature exist in the residual block. Exemplarily, here, gradient values for all or part of the samples in the prediction block may be calculated. Generally, the horizontal gradient value and the vertical gradient value may be calculated. Herein, the gradient value may be calculated using the Sobel operator. Then, the corresponding gradient intensity value is determined according to the horizontal gradient value and the vertical gradient value, and then the gradient intensity value corresponds to the corresponding intra prediction mode, so as to construct an intra prediction mode statistical table (i.e., the aforementioned “texture feature statistical table”). The calculated gradient intensity value of each candidate sample needs to be accumulated into the corresponding intra prediction mode item in the statistical table. After the gradient statistics are completed, one possible implementation is that the one intra prediction mode that is accumulated the most in the intra prediction mode statistics table is the virtual intra prediction mode of the current block. Alternatively, another possible implementation method is to determine that the virtual intra prediction mode is the DC mode or the PLANANR mode when the accumulated gradient intensity value of the intra prediction mode having the highest statistically accumulated gradient intensity is less than a certain threshold value. Alternatively, yet another possible implementation is to determine that the virtual intra prediction mode is the DC mode or the PLANANR mode when the sum of all the statistically accumulated gradient intensity values of samples is less than a certain threshold.

In addition, similar statistical derivation of the intra prediction mode is also required for the DIMD, but the difference is that the DIMD uses the reconstruction region around the current block, and here the prediction block of the current block is used. In practice, this scheme can multiplex part of the logic with the DIMD.

It should also be noted that, as for the samples used to derive the virtual intra prediction mode for inter prediction, the reconstructed regions on the left and top sides of the current block may be used here, which is similar to the method for the DIMD. Because the reconstructed regions on the left and top sides are not the current block but are neighboring to the current block, for example, there is a case that the textures are connected, they can be used to estimate the texture of the current block to a certain extent. Another possibility is to use both the prediction block of the current block and the reconstructed regions on the left and top sides of the current block, so that there are more samples available for deviating the virtual intra prediction mode. Another possibility is to consider the workflow length of the hardware. For the current block, a virtual intra prediction mode can be derived only after the prediction block is obtained, only when the virtual intra prediction mode is determined, the transform kernel of the LFNST/NSPT can be determined, then the inverse transform and subsequent processes can be performed. If the reference block is used to derive the virtual intra prediction mode, the process of generating the prediction block and the process of deriving the virtual intra prediction mode can theoretically be carried out in parallel, which is shorter than the design workflow described above. Therefore, the embodiment of the present application may also use the reference block to derive the virtual intra prediction mode, or synchronously derive the virtual intra prediction mode in the process of generating the prediction block. When using the reference block, the integer sample reference block can be directly used, because there will be no obvious difference in texture directions. For example, for a bi-directional predicted inter block, on the one hand, a virtual intra prediction mode is derived from the integer sample reference block; on the other hand, fractional sample interpolation filtering is performed on the two reference blocks, and then weighted combination is performed on the two fractional sample reference blocks. Specifically, the interpolation-filtered fractional sample reference block may also be used here. For example, for a bi-directional predicted inter block, it is necessary to first perform fractional sample interpolation filtering on two reference blocks, and then perform weighted combination of the two fractional sample reference blocks. Then, after obtaining the two interpolation-filtered reference blocks, on the one hand, the prediction value can be obtained by weighted averaging according to the interpolation-filtered reference blocks, and on the other hand, the virtual intra prediction mode can be derived according to the interpolation-filtered reference blocks.

In some embodiments, the operation that the index of the texture feature of the current block is determined may further include an operation that: an index of an angle for the current block when a geometric partitioning mode is performed is determined; and the index of the texture feature of the current block is determined according to the index of the angle.

In the embodiment of the present application, for the derivation of the virtual intra prediction mode for the geometric partition mode (GPM), the prediction block of the GPM is obtained by combining prediction blocks with different motions, so it may contain the contents of two objects, and the boundary is usually difficult to be predicted perfectly, so there may be a large residual at the boundary between the two objects, and the direction of this residual is consistent with the “partition” direction of the GPM. Therefore, for the GPM, the virtual intra prediction mode can be determined using the “partition” mode of the GPM.

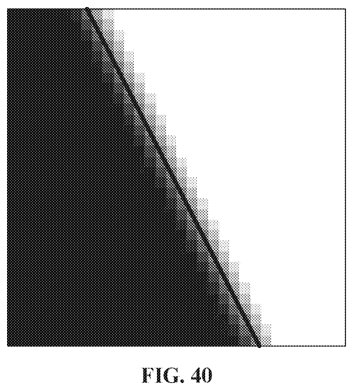

In the embodiment of the present application, the partition line may be considered to be a line composed of points having the same weight in a region, in which the weight changes, in the weight matrix of the GPM, in other words, a line composed of points for which the weights are median, and the points for which weights are median may not be at the integer sample position. Taking weights from 0 to 8 as an example, the median value can be 4. FIG. 40 shows a schematic diagram of a partition line for a GPM mode. As shown in FIG. 40, the thickened solid line is the partition line described herein.

In fact, the weights for the GPM are derived from the partition line. Taking some processes of the GPM in some technologies as examples below, the following merge_GPM_partition_idx [xCb] [yCb] is used to determine “partition”, which is the weight derivation mode described in the embodiment of the present application. A “partition” angle index variable angleIdx and a distance index variable distanceIdx of the GPM are determined using Table 6 according to merge_GPM_partition_idx [xCb] [yCb]. The angle index variable angleIdx and the distance index variable distanceIdx can be regarded as variables that determine the partition line, and they may be respectively used to determine the angle and offset of the partition line.

Table 6 provides an example of the correspondence between angleIdx and distanceIdx and on merge_gpm_partition_idx, as follows.

TABLE 6

| merge_gpm_partition_{—} | | | | | | | | | | | | | | | | |
|---|---|---|---|---|---|---|---|---|---|---|---|---|---|---|---|---|
| idx | 0 | 1 | 2 | 3 | 4 | 5 | 6 | 7 | 8 | 9 | 10 | 11 | 12 | 13 | 14 | 15 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_{—} | | | | | | | | | | | | | | | | |
| idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_{—} | | | | | | | | | | | | | | | | |
| idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_{—} | | | | | | | | | | | | | | | | |
| idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

Because all three color components (such as Y, Cb, and Cr) can use the GPM, the standard text packages the process of generating the prediction sample matrix of the GPM for one component into a sub-process, that is, the weighted prediction process for GPM (weighted sample prediction process for geometric partitioning mode). This process will be involked for all three color components, but the parameters invoked are different. Here, only the luma component is used as an example. The prediction matrix predSamplesL [xL] [yL] of the current luma block (where xL=0 . . . cbWidth−1, yL=0 . . . cbHeight−1) is derived from the weighted prediction procedure for the GPM. nCbW is set to cb Width, nCbH is set to cbHeight. The prediction sample matrices for the two prediction modes predSamplesLAL and predSamplesLBL, and angleIdx and distanceIdx are used as inputs.

The following is the process of deriving the weighted prediction process for the GPM:

The inputs to this process include:
width nCbW of current block height nCbH of current block;
2 prediction sample matrices of (nCbW)×(nCbH) predSamplesLA and predSamplesLB;
“partition” angle index variable angleIdx for the GPM;
distance index variable distanceIdx for the GPM;
component index variable cIdx. Because only the luma component is taken as an example in this embodiment, where cIdx is 0, indicating the luma component.

The output of this process is a prediction sample matrix pbSamples of (nCbW)×(nCbH) for the GPM.

The variables nW, nH, shift1, offset1, displacementX, displacementY, partFlip, and shiftHor are derived as follows:

$$nW = ( cIdx == 0 ) ? nCbW : nCbW * SubWidthC ;$$

$$nH = ( cIdx == 0 ) ? nCbH : nCbH * SubHeightC ;$$

shift1=Max (5, 17-BitDepth), where BitDepth is the bit depth for coding;

$$offset 1 = 1 << ( shift 1 - 1 ) ;$$

$$displacementX = angleIdx ;$$

$$displacementY = ( angleIdx + 8 ) \% 32 ;$$

$$partFlip = ( angleIdx >= 13 \&\& angleIdx <= 27 ) ? 0 : 1 ;$$

$$shiftHor = ( angleIdx \% 16 == 8 ‖ ( angleIdx \% 16 != = 0 \&\& nH >= nW ) ) ? 0 : 1 ;$$

The variables offsetX and offsetY are derived as follows:
If the value of shiftHor is 0:

$$offsetX = ( - nW ) >> 1 ;$$

$$offsetY = ( ( - nH ) >> 1 ) + ( angleIdx < 16 ? ( distanceIdx * nH ) >> 3 : - ( ( distanceIdx * nH ) >> 3 ) ) ;$$

$$- otherwise ( i . e . the value of shiftHor is 1 ) :$$

$$offsetX = ( ( - nW ) >> 1 ) + ( angleIdx < 16 ? ( distanceIdx * nW ) >> 3:- ( ( distanceIdx * nW ) >> 3 ) ;$$

$$offsetY = ( - nH ) >> 1 ;$$

The prediction sample matrix pbSamples [x] [y] (where x=0 . . . nCbW−1, y=0 . . . nCbH−1) is derived as follows:
Variables xL and yL are derived as follows:

$$xL = ( cIdx == 0 ) ? x : x * SubWidthC ;$$

$$yL = ( cIdx == 0 ) ? y : y * SubHeightC ;$$

a variable wValue representing the weight of the prediction sample at the current position is derived as follows: wValue is the weight for the prediction value predSamplesLA [x] [y] of the prediction matrix of the first prediction mode at the point (x, y) and (8-wValue) is the weight for the prediction value predSamplesLB [x] [y] of the prediction matrix of the first prediction mode at the point (x, y).

Table 7 provides an example of the definition of a distance matrix disLut. In this way, the value of disLut can be determined according to Table 7.

TABLE 7

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

Here, weightIdx=(((xL+offsetX)<<1)+1)*disLut[displacementX]+(((yL+offsetY)<<1)+1)*disLut[displacementY];

$$weightIdxL = partFlip ? 32 + weightIdx : 32 - weightIdx ;$$

$$wValue = Clip 3 ( 0 , 8 , ( weightIdxL + 4 ) >> 3 ) ;$$

The values of the predicted samples are derived as follows:

$$pbSamples [ x ] [ y ] = Clip 3 ( 0 , ( 1 << BitDepth ) - 1 , ( predSamplesLA [ x ] [ y ] * wValue + predSamplesLB [ x ] [ y ] * ( 8 - wValue ) + offset ) >> shift 1 ) .$$

It should be noted here that in the standard text, a weight value wValue is derived for each position, and then a prediction value pbSamples [x] [y] for the GPM is calculated. Because in this way, the weight wValue does not have to be written in the form of a matrix, but it can be understood that if the wValue of each position is saved in a matrix, then it is a weight matrix. The weight for each point is calculated separately and weighting is performed to obtain the prediction value for the GPM, or, all the weights are calculated and then weighting is performed together to obtain the predicted sample matrix for the GPM, the principles of them are the same. The use of weight matrix in many descriptions in this application is to make the expression easier to understand, and expression with weight matrix is more intuitive. In fact, it can also be described according to the weight for each position. For example, a mode for deriving the weight matrix can also be referred to as the weight derivation mode.

In this way, according to the derivation process of weight wValue, it can be seen that wValue is derived according to angleIdx and distanceIdx. Therefore, when determining the intra prediction mode corresponding to the partition line, angleIdx may be determined first, and then the corresponding intra angle prediction mode may be determined according to angleIdx. Because according to Table 6 above, it can also be seen that multiple weight derivation modes correspond to an angleIdx. The possible correspondence between an angleIdx and intra angle prediction mode is shown in Table 8. It can be seen that some angleIdx correspond to 0, because these angleIdx are not used in the GPM, that is, the example of 64 weights as shown in FIG. 10. It should be understood that if some angleIdx changes in a certain version, for example, more angleIdx are used in the future, or the intra angle prediction mode changes, for example, there are more intra prediction modes in the future, then this correspondence table can also change accordingly, and is not specifically limited here.

TABLE 8

| angleIdx | 0 | 1 | 2 | 3 | 4 | 5 | 6 | 7 |
|---|---|---|---|---|---|---|---|---|
| intra pred. | 50 | 0 | 44 | 41 | 34 | 27 | 0 | 0 |
| mode | | | | | | | | |
| angleIdx | 8 | 9 | 10 | 11 | 12 | 13 | 14 | 15 |
| intra pred. | 18 | 0 | 0 | 9 | 66 | 59 | 56 | 0 |
| mode | | | | | | | | |
| angleIdx | 16 | 17 | 18 | 19 | 20 | 21 | 22 | 23 |
| intra pred. | 50 | 0 | 44 | 41 | 34 | 27 | 0 | 0 |
| mode | | | | | | | | |
| angleIdx | 24 | 25 | 26 | 27 | 28 | 29 | 30 | 31 |
| intra pred. | 18 | 0 | 0 | 9 | 66 | 59 | 56 | 0 |
| mode | | | | | | | | |

Further, in the embodiment of the present application, the index of the texture feature of the current block may directly copy the index of the texture feature of the reference block. In some embodiments, the operation that the index of the texture feature of the current block is determined may further include an operation that: the virtual intra prediction mode of the current block is determined according to the intra prediction mode of the reference block or the virtual intra prediction mode of the reference block, that is, the index of the texture feature of the current block is determined according to the index of the texture feature of the reference block. If the reference block for the current block has an intra-decoded block, the intra-decoded block has an intra prediction mode, and the intra prediction mode of the reference block may be used as a virtual intra prediction mode of the current block. If the reference block for the current block includes a plurality of intra-decoded blocks, the intra prediction mode at a certain position may be determined according to the coordinates. For example, the intra prediction mode of the reference block corresponding to the center position of the current block is used as the virtual intra prediction mode of the current block. A virtual intra prediction mode may be saved for each inter-decoded block. If the reference block for the current block is an inter-decoded block, it may also find a virtual intra prediction mode. The virtual intra prediction mode can also be stored according to a certain granularity, for example, each 4×4 sample is a minimum storage unit, and each minimum storage unit shares the same intra prediction mode or virtual intra prediction mode. If the reference block for the current block includes a plurality of 4×4 minimum storage units, the (virtual) intra prediction mode at a certain position may be determined according to the coordinates. For example, the (virtual) intra prediction mode of the minimum storage unit of the reference block corresponding to the central position of the current block is used as the virtual intra prediction mode of the current block.

Thus, after the virtual intra angle prediction mode (i.e. the index of the texture feature) is determined, the transform kernel set for the NSPT/LFNST can be determined according to the index of the texture feature.

Further, in the embodiment of the present application, a candidate list may be constructed to determine a virtual intra angle prediction mode. Accordingly, in some embodiments, the operation that the index of the texture feature of the current block is determined may further include operations that: a candidate list is constructed, herein the candidate list includes indexes of a preset number of candidate texture features; a bitstream is decoded to determine the feature index sequence number of the current block; and the index of the texture feature of the current block is determined according to the candidate list and the feature index sequence number. The feature index sequence number represents the number of the index of the texture feature of the current block in the candidate list.

It should be noted that the foregoing embodiment refers to deriving a virtual intra prediction mode using a prediction block or a reference block for the current block or a reconstructed picture around the current block. In a specific embodiment, an intra prediction mode having the maximum gradient intensity value may be selected as the virtual intra prediction mode. In addition, an operation may be added that a candidate list, that is, a virtual intra prediction mode candidate list or a feature index candidate list, is constructed. A syntax element is then used to signalled in the bitstream to indicate which candidate is ultimately selected. The syntax element used herein, that is, the feature index sequence number of the current block, may be represented by lfnst_nspt_feature_idx.

It should be noted that, the value of lfnst_nspt_feature_idx may be an integer such as 0, 1, 2, or 3. For example, if the value of lfnst_nspt_feature_idx is 0, the first element in the candidate list may be selected. If lfnst_nspt_feature_idx is 1, the second element in the candidate list may be selected.

In some embodiments, the operation that the candidate list is constructed includes operations that: indexes of one or more reference texture features in the texture feature statistical table are sorted from large to small according to corresponding accumulated gradient intensity values, to determine the indexes of the preset number of reference texture features that are sorted first; and the candidate list is constructed according to the indexes of the preset number of reference texture features that are sorted first.

In some embodiments, the operation that the candidate list is constructed includes operations that: an index of a first texture feature corresponding to a maximum accumulated gradient intensity value in the texture feature statistical table is determined, and an index of a second texture feature corresponding to the current block when a geometric partitioning mode is performed; and the candidate list is constructed according to the index of the first texture feature and the index of the second texture feature.

That is, in the embodiment of the present application, an example of constructing the candidate list is that, based on the above-described method of calculating the gradient intensity, the top N intra prediction modes (indexes of texture features) are selected according to the gradient intensities from larger to smaller to constitute the candidate list. The value of N may be 2, 3, 4, etc. Another example is that it is assumed that the value of N is 2, that is, an intra prediction mode (an index of a texture feature) with the maximum gradient intensity is the first element in the candidate list, and an intra prediction mode (an index of a texture feature) with the second maximum gradient intensity is the second element in the candidate list. Another example is that: for the GPM, the first element in the candidate list may be set as an intra prediction mode (an index of a texture feature) corresponding to the “partition” mode for the GPM, and the second element may be set as an intra prediction mode (t an index of a texture feature) with the maximum gradient intensity, or vice versa. There is no specific limitation here.

In some embodiments, the operation that the candidate list is constructed may further include an operation that: a reference block for the current block is determined; and the candidate list is constructed according to indexes of texture features corresponding to one or more candidate positions in the reference block.

That is, in the embodiment of the present application, the candidate list is constructed according to the intra prediction mode (the index of the texture feature) of the reference block. For example, the candidate list is constructed according to the intra prediction modes (the index of the texture feature) of the 4×4 minimum storage units corresponding to some positions in the reference block. The coordinate of the top left corner of the current block is (x, y), the width of the current block is nCbW, the height of the current block is nCbH, the center point posC of the current block is (x+nCbW/2, y+nCbH/2), the top left corner is posTL(x, y), the top right corner is posTR(x+nCbW−1, y), the below left corner is posBL(x, y+nCbH−1), the below right corner is (x+nCbW−1, y+nCbH−1). The candidate list is constructed with the intra prediction modes (the indexes of the texture features) of the smallest storage units corresponding to posC, posTL, posTR, posBL and posBR in turn. Here, the candidate position may be at least one of posC, posTL, posTR, posBL, and posBR, but is not limited thereto.

It should also be noted that when constructing the list, the decoder needs to ensure that each item in the candidate list is not repeated. If the available intra prediction modes (the indexes of the texture features) cannot fill the list, a default intra prediction mode (an index of a texture feature) may be added, for example, an intra prediction mode (an index of a texture feature) in horizontal direction or vertical direction.

It should be noted that this method can be applied not only to inter prediction but also to intra prediction. If the value of N is 2, then only a binary symbol is needed to represent it. If the value of N is greater than 2, then a truncated unary code can be used. Here, all binary symbols can be decoded using the context model of the CABAC.

In this way, after the candidate list is constructed, a virtual intra angle prediction mode (that is, the index of the texture feature of the current block) can also be determined according to the feature index sequence number obtained by decoding the bitstream.

In S3902, a transform kernel set for the current block is determined according to the index of the texture feature.

In S3903, a transform kernel for the current block is determined according to the transform kernel set.

It should be noted that, after the index of the texture feature of the current block is determined, the transform kernel set for the current block can be determined according to a correspondence between an index of a texture feature and a transform kernel set. For example, the LFNST in some techniques has a total of four transform kernel sets, and the correspondence between the intra prediction mode and the transform kernel set is detailed in Table 4. In some technologies, the LFNST may also have more transform kernel sets, such as 35 groups. The correspondence between the intra prediction mode and the transform kernel sets is detailed in Table 5.

Additionally, each transform kernel set may include at least two transform kernels. For example, a transform kernel set may include two transform kernels, or may include three transform kernels, or may include four optional transform kernels, or a larger number of optional transform kernels, which are not specifically limited herein.

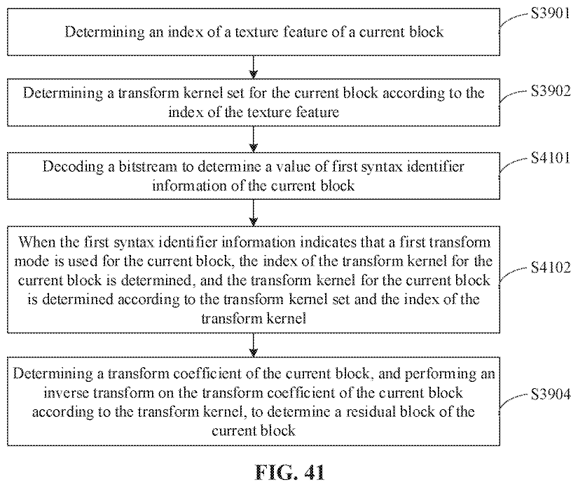

In some embodiments, referring to FIG. 41, after operation S3902, the method may further include the following operations S4101-S4102:

In S4101, a bitstream is decoded to determine a value of first syntax identifier information of the current block.

In S4102, when the first syntax identifier information indicates that a first transform mode is used for the current block, the index of the transform kernel for the current block is determined, and the transform kernel for the current block is determined according to the transform kernel set and the index of the transform kernel.

It should be noted that, in the embodiment of the present application, the first syntax identifier information may be represented by lfnst_nspt_idx. The first syntax identifier information may be used to indicate whether a first transform mode is used for the current block. When the first transform mode is used for the current block, the value of the first syntax identifier information may be used to indicate the index of the transform kernel used for the current block.

It should also be noted that in the embodiment of the present application, the first transform mode may be LFNST or NSPT. That is, lfnst_nspt_idx is used to indicate whether the LFNST or the NSPT is used for the current block, and when the LFNST or the NSPT is used for the current block, the value of lfnst_nspt_idx may also be used to indicate the index of the transform kernel used by the current block. Whether the LFNST or the NSPT is used for the current block may be determined according to a size parameter of the current block. Exemplarily, if the size parameter of the current block is small, it may be determined that lfnst_nspt_idx is used to indicate whether the NSPT is used for the current block and an index of a used transform kernel corresponding to the NSPT, if the size parameter of the current block is large, it may be determined that lfnst_nspt_idx is used to indicate whether the LFNST is used for the current block and an index of a used transform kernel corresponding to the LFNST.

In the embodiment of the present application, two pieces of syntax identifier information lfnst_nspt_idx and nspt_idx may be used instead of the first syntax identifier information lfnst_nspt_idx. Here, lfnst_idx is used to indicate whether or not the LFNST is used for the current block and the index of the used transform kernel corresponding to the LFNST, and nspt_idx is used to indicate whether or not the NSPT is used for the current block and the index of the transform kernel corresponding to the used NSPT, which are not specifically limited here.

In some embodiments, when the first syntax identifier information indicates that a first transform mode is used for the current block, the index of the transform kernel for the current block determined may include an operation that: when the intra prediction mode is used for the current block, the bitstream is decoded to determine the index of the transform kernel for the current block; when the inter prediction mode is used for the current block, the index of the transform kernel for the current block is determined according to the value of the first syntax identifier information.

It should be noted that, in the embodiment of the present application, when the intra prediction mode is used for the current block, the first syntax identifier information is used to indicate whether a first transform mode is used for the current block. When the first syntax identifier information indicates that a first transform mode is used for the current block, it is further necessary to decode the bitstream to determine an index of the transform kernel for the current block, and then the transform kernel for the current block is determined according to the transform kernel set and the index of the transform kernel. The index of the transform kernel is used to indicate the number of the transform kernel for the current block in the transform kernel set. Exemplarily, if the index of the transform kernel for the current block is 0, the transform kernel for the current block is the first transform kernel in the transform kernel set. If the index of the transform kernel for the current block is 1, then the transform kernel for the current block is the second transform kernel in the transform kernel set. If the index of the transform kernel for the current block is 2, then the transform kernel for the current block is the third transform kernel in the transform kernel set.

It should also be noted that, in the embodiment of the present application, when the inter prediction mode is used for the current block, there are three transform kernels in one transform kernel set for LFNST/NSPT for selection. In addition, there is a case in which the LFNST/NSPT is not used. That is, there are four possible options for the current block for the LFNST/NSPT. Therefore, here, lfnst_nspt_idx may be used to indicate whether a first transform mode is used for the current block and the index of the transform kernel used for the current block. In this way, the index of the transform kernel for the current block can be determined according to the value of the first syntax identifier information, and then the transform kernel for the current block can be determined according to the transform kernel set and the index of the transform kernel. Exemplarily, if the value of the first syntax identifier information is 0, it is determined that the LFNST/NSPT is not used for the current block. If the value of the first syntax identifier information is 1, it is determined that the LFNST/NSPT is used for the current block, and the transform kernel for the current block is the first transform kernel in the transform kernel set. If the value of the first syntax identifier information is 2, it is determined that the LFNST/NSPT is used for the current block, and the transform kernel for the current block is the second transform kernel in the transform kernel set. If the value of the first syntax identifier information is 3, it is determined that the LFNST/NSPT is used for the current block, and the transform kernel for the current block is the third transform kernel in the transform kernel set. That is, in the embodiments of the present application, the value of lfnst_nspt_idx may be 0, 1, 2, 3, or the like.

It should also be noted that, in the embodiment of the present application, the first syntax identifier information lfnst_nspt_idx may be replaced by two other syntax identifier information. One piece of syntax identifier information is used to indicate whether the LFNST/NSPT is used for the current block, and the other syntax identifier information is used to indicate a corresponding transform kernel index when the LFNST/NSPT is used for the current block. In this way, two syntax elements need to be transmitted in the bitstream, resulting in a large bitstream overhead. In this case, for the case where the index of the transform kernel needs to be transmitted in the bitstream, if there is only one transform kernel in the transform kernel set, there is no need to transmit the index of the transform kernel at this time. Specifically, when the LFNST/NSPT is used for the current block, the only one transform kernel in the transform kernel set may be directly used as the transform kernel for the current block.

Further, for a case where the index of the texture feature is determined through the candidate list, in some embodiments, the method may further include operations that: a bitstream is decoded to determine a value of the first syntax identifier information of the current block; when the first syntax identifier information indicates that a first transform mode is used for the current block, the operation of decoding a bitstream to determine the feature index sequence number of the current block is performed.

That is, in the embodiment of the present application, the first syntax identifier information is represented by lfnst_nspt_idx, and the feature index sequence number is represented by lfnst_nspt_feature_idx. Here, lfnst_nspt_feature_idx may be used to select a virtual intra prediction mode or the index of the texture feature. Exemplarily, if lfnst_nspt_feature_idx is 0, the first element in the candidate list is selected; if lfnst_nspt_feature_idx is 1, then the second element in the candidate list is selected. Further, here, lfnst_nspt_feature_idx may be parsed in a case where the LFNST or NSPT is used for the current block. Specifically, if the LFNST/NSPT is not used for the current block, lfnst_nspt_feature_idx is not parsed. For example, since lfnst_nspt_idx is used to indicate whether the LFNST/NSPT is used for the current block and which transform kernel is selected from the transform kernel set for the LFNST/NSPT, if lfnst_nspt_idx is 0 at this time, it means that the LFNST/NSPT is not used for the current block, in this case, it is not necessary to parse lfnst_nspt_feature_idx; Otherwise, if lfnst_nspt_idx is not 0, it means that the LFNST/NSPT is used for the current block, in such case lfnst_nspt_feature_idx can be parsed. It should be noted that this method can be applied not only to inter prediction, but also to intra prediction, and is not specifically limited here.

In S3904, a transform coefficient of the current block is determined, and an inverse transform is performed on the transform coefficient of the current block according to the transform kernel to determine a residual block of the current block.

It should be noted that, in the embodiment of the present application, the operation that the transform coefficient of the current block is determined may include an operation that: a bitstream is decoded to determine a quantization coefficient of the current block; and the quantization coefficient of the current block are inversely quantized to determine the transform coefficient of the current block.

It should also be noted that, in the embodiment of the present application, the operation that the inverse transform is performed on the transform coefficient of the current block according to the transform kernel to determine the residual block of the current block may include operations that: when a size parameter of the current block satisfies a first condition, an inverse transform of an inseparable primary transform is performed on the transform coefficient of the current block according to the transform kernel to determine the residual block of the current block; when the size parameter of the current block satisfies a second condition, an inverse transform of a low-frequency non-separable transform is performed on the transform coefficient of the current block according to the transform kernel to determine a transform block of the current block; and an inverse transform of a discrete cosine transform is performed on the transform block of the current block to determine the residual block of the current block.

Here, the size parameter of the current block satisfies the first condition, including that the size parameter of the current block is small, for example, the size parameter of the current block is less than a certain threshold. That is, for a block with a smaller size, the transform kernel for the NSPT is used here, that is, inverse NSPT is performed on the transform coefficient of the current block according to the transform kernel, to determine the residual block of the current block.

Here, the size parameter of the current block satisfies the second condition, including that the size parameter of the current block is large, for example, the size parameter of the current block is larger than a certain threshold. That is, for a block with a larger size, the transform kernel for the LFNST is used here, that is, inverse LFNST is performed on the transform coefficient of the current block according to the transform kernel to determine the transform block of the current block; and an inverse DCT2 transform is performed on the transform block of the current block to determine a residual block of the current block.

It should also be noted that, in the embodiment of the present application, the “inverse transform” for the transform coefficient by the decoding side may also be referred to as “transform” in the standard text. “Transform” and “inverse transform” herein correspond to two opposite processes. For example, “transform” converts values in the spatial domain into coefficients in the frequency domain, and then “inverse transform” converts coefficients in the frequency domain into values in the spatial domain. “Inverse” is relative to “positive”, and they are essentially transforms. It should be noted that if the standard only specifies decoding, then the “transform” in the standard text is the part of decoding, specifically, it refers to the “inverse transform” herein.

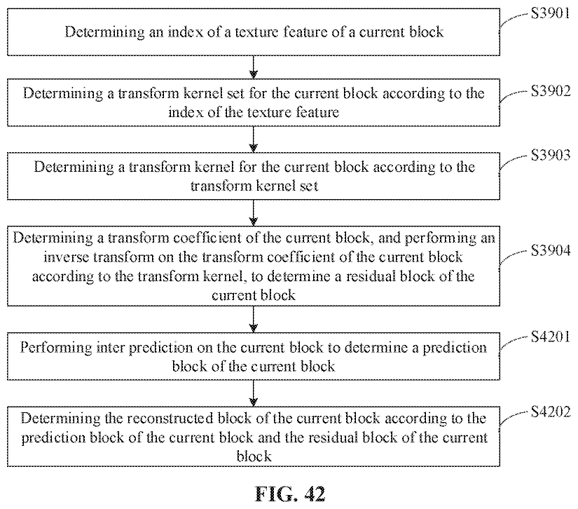

In some embodiments, referring to FIG. 42, after operation S3904, the method may further include S4201-S4202.

In S4201, inter prediction is performed on the current block, to determine a prediction block of the current block.

In S4202, a reconstructed block of the current block is determined according to the prediction block of the current block and the residual block of the current block.

It should be noted that, in the embodiment of the present application, the operation S4201 may be performed in parallel with operations S3901 to S3903, or may be performed before operations S3901 to S3903, and the order of the operations is not specifically limited here.

It should also be noted that, in the embodiment of the present application, after the prediction block of the current block is determined, the prediction block of the current block and the residual block of the current block may be added to determine the reconstructed block of the current block.

In short, after determining the prediction block, the decoder derives a virtual intra prediction mode according to the prediction block, and then determines the transform kernel set for the NSPT/LFNST according to the virtual intra prediction mode. If a transform kernel set has multiple transform kernels for selection, the decoder determines the transform kernel by decoding lfnst_nspt_idx in the bitstream. There is no dependency between the process of decoding lfnst_nspt_idx in the bitstream and the process of determining the transform kernel set. The quantization coefficients are decoded from the bitstream by entropy decoding.

If it is the NSPT, the quantization coefficient is inversely quantized to obtain the decoded transform coefficient, inverse NSPT is performed on the decoded transform coefficient to obtain the decoded residual block, and finally the reconstructed block is obtained according to the decoded residual block and the prediction block.

If it is the LFNST, the quantization coefficient are inversely quantized to obtain the decoded transform coefficient, inverse LFNST is performed on the decoded transform coefficient, and then inverse DCT2 transform is performed to obtain the decoded residual block, and finally the reconstructed block is obtained according to the decoded residual block and the prediction block.

It can be understood that the embodiment of the present application may use a high level syntax to control the enable/disable of the present technical solution. In some embodiments, the method further includes operations that: a bitstream is decoded to determine a value of the second syntax identifier information; and when the second syntax identifier information indicates that a first transform mode is allowed to be used for a current sequence, the operation of determining the index of the texture feature of the current block is performed. The current sequence includes the current block.

It should be noted that, in the embodiment of the present application, the second syntax identifier information may be represented by sps_inter_lfnst_nspt_enabled_flag, and the second syntax identifier information is a syntax element in a Sequence Parameter Set (SPS).

It should also be noted that, in the embodiment of the present application, if the value of the second syntax identifier information is a first value, it is determined that the second syntax identifier information indicates that the current sequence is allowed to use the first transform mode; if the value of the second syntax identifier information is a second value, it is determined that the second syntax identifier information indicates that the current sequence is not allowed to use the first transform mode.

In an embodiment of the present application, the first value is different from the second value, and the first value and the second value may be in a parameter form or a numeric form. Specifically, the first syntax identifier information may be a parameter written in a profile, or may be a value of a flag, which is not specifically limited here. Exemplarily, the first value may be 1 and the second value may be 0. Alternatively, the first value may be 0 and the second value may be 1. Alternatively, the first value may be true and the second value may be false. Alternatively, the first value may be false and the second value may be true. In a specific embodiment, the first value is 1 and the second value is 0.

That is, the embodiment of the present application may use a high level syntax to control the enable/disable of the present technical solution. For example, a sequence-level flag is used. For example, a syntax element sps_inter_lfnst_nspt_enabled_flag is added to the sequence parameter set. If the value of sps_inter_lfnst_nspt_enabled_flag is 1, the present technical solution is allowed to be used for the current sequence. If the value of sps_inter_lfnst_nspt_enabled_flag is 0, the present technical solution is not allowed to be used for the current sequence. However, when the present technical solution is allowed to be used, the decoder needs to decode the index of the transform kernel for the LFNST or the NSPT when decoding the inter-coded block, and perform the inverse transform process of the LFNST or the NSPT. Or, the embodiment of the present application may also set respective syntax elements for the LFNST and the NSPT, that is, sps_inter_lfnst_enabled_flag and sps_inter_nspt_enabled_flag, respectively. Sps_inter_LFNST_enabled_flag is used to indicate whether the LFNST is allowed to be used for the current sequence, and sps_inter_nspt_enabled_flag is used to indicate whether the NSPT is allowed to be used for the current sequence.

Or, in the embodiment of the present application, the same flag may be set for the inter LFNST/NSPT and the intra LFNST/NSPT, such as sps_lfnst_nspt_enabled_flag. For example, if the value of sps_inter_lfnst_nspt_enabled_flag is 0, then it may be determined that the LFNST and the NSPT are not allowed to be used for the current sequence, if the value of sps_inter_lfnst_nspt_enabled_flag is 1, it may be determined that the LFNST and the NSPT are allowed to be used for intra-decoded blocks in the current sequence; if the value of sps_inter_lfnst_nspt_enabled_flag is 2, it may be determined that the LFNST and the NSPT are allowed to be used for inter-decoded blocks in the current sequence.

Further, in some embodiments, the method further includes operations that: a bitstream is decoded to determine a value of the second syntax identifier information; when the second syntax identifier information indicates that a first transform mode is allowed to be used for a current sequence, the bitstream is decoded to determine a value of the third syntax identifier information; when the third syntax identifier information indicates that the first transform mode is allowed to be used for a current picture, the operation of determining the index of the texture feature of the current block is performed.

In the embodiment of the present application, the current sequence may include a current picture, and the current picture may include the current block. Here, the third syntax identifier information may be represented by ph_inter_lfnst_nspt_enabled_flag, and the third syntax identifier information is a syntax element at the picture level.

It should be noted that, in the embodiment of the present application, if the value of the third syntax identifier information is a first value, it is determined that the third syntax identifier information indicates that the first transform mode is allowed to be used for the current picture; if the value of the third syntax identifier information is a second value, it is determined that the third syntax identifier information indicates that the first transform mode is allowed to be used for the current picture.

Further, in some embodiments, the method further includes operations that: a bitstream is decoded to determine a value of second syntax identifier information; when the second syntax identifier information indicates that a first transform mode is allowed to be used for a current sequence, a bitstream is decoded to determine a value of the fourth syntax identifier information; and when the fourth syntax identifier information indicates that the first transform mode is allowed to be used for a current slice, the operation of determining the index of the texture feature of the current block is performed.

In an embodiment of the present application, the current sequence may include the current slice, and the current slice may include the current block. Here, the fourth syntax identifier information may be represented by sh_inter_lfnst_nspt_enabled_flag, and the fourth syntax identifier information is a syntax element at a slice level.

Further, in the embodiment of the present application, if a value of the fourth syntax identifier information is a first value, it is determined that the fourth syntax identifier information indicates that the first transform mode is allowed to be used for the current slice; if the value of the fourth syntax identifier information is a second value, it is determined that the fourth syntax identifier information indicates that the first transform mode is not allowed to be used for the current slice.

In the embodiment of the present application, the first value is different from the second value, and the first value and the second value may be in a parameter form or a numeric form. Specifically, the first syntax identifier information may be a parameter written in a profile, or may be a value of a flag, which is not specifically limited here. Exemplarily, the first value may be 1 and the second value may be 0. Alternatively, the first value may be 0 and the second value may be 1. Alternatively, the first value may be true and the second value may be false. Alternatively, the first value may be false and the second value may be true. In a specific embodiment, the first value is 1 and the second value is 0.

That is, in the embodiment of the present application, a high level syntax may be used to control the enable/disable of the present technical solution. For example, a sequence-level flag is used. For example, a syntax element sps_inter_lfnst_nspt_enabled_flag is added to the sequence parameter set (SPS). If the value of sps_inter_lfnst_nspt_enabled_flag is 1, the present technical solution is allowed to be used for the current sequence. If the value of sps_inter_lfnst_nspt_enabled_flag is 0, the present technical solution is not allowed to be used for the current sequence. If the present technical solution is allowed, the decoder needs to decode lfnst_nspt_idx when decoding the inter-encoded block, and perform LFNST or NSPT processing. Or, it is also possible to set respective flags for the LFNST and the NSPT, namely sps_inter_lfnst_enabled_flag and sps_inter_nspt_enabled_flag, respectively.

Further, the embodiment of the present application may also use other levels of syntax elements to realize more flexible control, such as a flag in an picture parameter set (PPS), a flag in an picture header or a slice header, etc. For example, the sequence parameter set (SPS) determines whether the current sequence can use the present technical solution, and if the current sequence uses the present technical solution, a sh_inter_lfnst_nspt_enabled_flag in a slice header is set to determine whether the current slice uses the present technical solution, thereby providing higher flexibility. Because for inter coding, particularly RA, the QP of different pictures or slices differs greatly. Here, since an picture having a low GOP temporal level usually has a low QP, and an picture having a higher GOP temporal level usually has a higher QP, the present technical solution does not significantly improve the compression efficiency when the QP is particularly high or particularly low, and thus a flag in a picture header or a slice header can be set to control it more flexibly.

It should be noted that, in the embodiments of the present application, the LFNST and the NSPT may be applied to the inter predicted block. For blocks that can't be inter predicted well, that is, blocks with large residuals, correlation can better removed and compression efficiency can be improved compared with MTS in related technologies.

It should be noted that, in the embodiments of the present application, the LFNST and the NSPT may be applied to an Intra Block Copy (IBC) block in addition to inter prediction block.

The present embodiment provides a decoding method. An index of a texture feature of a current block is determined. A transform kernel set for the current block is determined according to the index of the texture feature. A transform kernel for the current block is determined according to the transform kernel set. A transform coefficient of the current block is determined. An inverse transform is performed on the transform coefficient of the current block according to the transform kernel to determine a residual block of the current block. Then, a reconstructed block is determined according to the inter predicted prediction block and the residual block. That is, a correspondence between an index of the texture feature and a transform kernel set is established here, which replaces the scheme of matching the transform kernel set according to the intra prediction mode in the related art, so that the LFNST and the NSPT can also be applied to the inter prediction mode. Therefore, for blocks that are not easily predicted in the inter prediction mode, that is, blocks with large residuals, not only the compression efficiency but also the encoding and decoding performance can be improved.

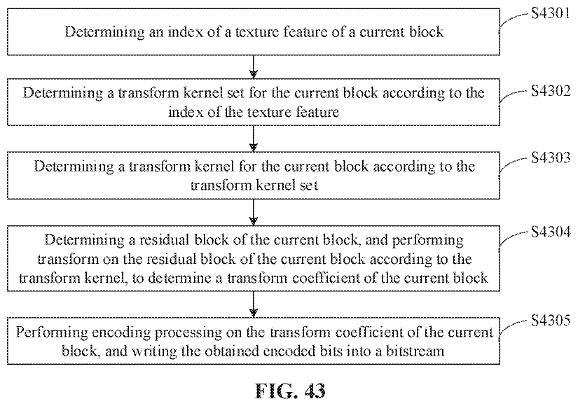

In another embodiment of the present application, see FIG. 43, which shows a schematic flowchart of an encoding method provided by the embodiment of the present application. As shown in FIG. 43, the method may include S4301-S4305.

In S4301, an index of a texture feature of a current block is determined.

It should be noted that in the embodiment of the present application, the method is applied to an encoder. Specifically, based on the configuration structure of the encoder 100 illustrated in FIG. 37, the encoding method of the embodiment of the present application is mainly applied to inter-coded blocks. When an inter prediction mode is used for the inter-coded block, the optimization scheme for NSPT and LFNST in the inter prediction mode is mainly proposed here to improve the compression efficiency of inter prediction.

Here, both the NSPT and the LFNST are transforms that can be used to efficiently process textures with various angles. There may be multiple transform kernels here, and one transform kernel may be specially optimized for a texture with a specific angle. In addition to the textures with angles, the NSPT and the LFNST also include transform kernels for handling gradient textures. In fact, these transform kernels can also be referred to as trained Karhunen-Loeve (KL) Transforms. That is, both the NSPT and the LFNST may have multiple transform kernels, each of which is designed for a specific texture. The specific texture includes angle textures, gradient textures, etc. In addition, the gradient texture can be further expanded, such as a horizontal gradient texture, a vertical gradient texture, an oblique gradient texture, etc. Further, the present solution is not limited to be applied only to non-separable transforms such as the NSPT and the LFNST, but may also be applied to separable transforms optimized for specific textures.

It should be noted that, in an intra predicted block, both the NSPT and the LFNST include a plurality of transform kernel sets, and each intra prediction mode may correspond to one transform kernel set. However, an inter predicted block does not have an intra prediction mode, which is a problem of applying the LFNST and the NSPT to inter prediction. In the embodiment of the present application, a virtual intra prediction mode (index) may be derived from the inter predicted block, or may be referred to as an index of a texture feature. For example, DC mode and PLANAR mode correspond to gradient texture features, and a prediction mode of a certain angle corresponds to a texture feature of the angle. That is, in the embodiment of the present application, on the one hand, the index of the texture feature can avoid the occurrence of an intra prediction mode in “inter”, and on the other hand, it is more conducive to possible expansion. For example, one intra prediction mode can correspond to a plurality of texture features. For example, the DC mode can correspond to a horizontal gradient texture, a vertical gradient texture, an oblique gradient texture, and the like.

In the embodiment of the present application, in order to properly configure the schemes of the NSPT and the LFNST for inter prediction, a virtual intra prediction mode (or “an index of a texture feature”) is proposed here. It is named as the virtual intra prediction mode, because this mode is not used for participating in prediction, but is only used for selection of the transform kernel set for the NSPT or LFNST. The derivation of the index of the texture feature is described in detail below.

In some embodiments, the operation that the index of the texture feature of the current block is determined may include operations that: a candidate sample for deriving the index of the texture feature is determined; and the index of the texture feature of the current block is determined according to the candidate sample.

In one possible implementation, for the candidate sample, a prediction block of the current block may be determined; and at least a portion of samples in the prediction block is taken as the candidate sample.

In the embodiment of the present application, if there is a certain texture in the prediction block, it may be considered that there is a texture with the same feature in the residual block. In this way, the candidate sample used for deriving the index of the texture feature for the inter prediction may be all samples in the prediction block or some samples in the prediction block.

In another possible implementation, for the candidate sample, a neighboring sample of the current block in a reconstructed region may be determined; and the neighboring sample in the reconstructed region is taken as the candidate sample.

In the embodiment of the present application, the candidate sample used for deriving the index of the texture feature for the inter prediction may be a neighboring sample of the current block in the reconstructed region, for example, an reconstructed region on the left and right sides of the current block. Because the reconstructed region on the left and top sides are not the current block but are neighboring to the current block, for example, there is a case that the textures may be connected, they can be used to estimate the texture of the current block to a certain extent.

In yet another possible implementation, it is considered that more samples are used, and for the candidate sample, the neighboring sample in the reconstructed region and at least a portion of samples in the prediction block may be taken as the candidate samples together.

In the embodiment of the present application, the candidate sample used for deriving the index of the texture feature for the inter prediction may include both the prediction block of the current block and the neighboring sample in the reconstructed region on the left and top sides of the current block, so that more samples are used to derive the index of the texture feature, and the derived index of the texture feature is more accurate.

In yet another possible implementation, considering the workflow length of hardware, for the candidate sample, a reference block for the current block may be determined; and at least a portion of samples in the reference block is taken as the candidate sample.

In the embodiment of the present application, for the current block, the index of the texture feature can only be derived after the prediction block is obtained, and the transform kernel for the LFNST/NSPT can only be determined after the index of the texture feature is determined, and then the inverse transform and subsequent encoding processes can be performed. Here, if the reference block is used to derive the index of the texture feature, the process of generating the prediction block and the process of deriving the index of the texture feature can theoretically be carried out in parallel, which is shorter than the workflow using the prediction block. Accordingly, the reference block may also be used to derive the index of the texture feature, or the index of the texture feature may be derived synchronously in the process of generating the prediction block, thereby enabling a shortened workflow length.

In some embodiments, for the reference block for the current block, it is determined that the reference block is an integer sample reference block; or, it is determined that the reference block is a fractional sample reference block.

In one possible implementation, the reference block may directly be the integer sample reference block, because there is no obvious difference in texture direction. For example, for a bi-directional predicted inter block, a virtual intra prediction mode can be derived from an integer sample reference block.

In another possible implementation, the reference block may also be a fractional sample reference block obtained by performing interpolation filtering. Specifically, two reference picture blocks when the current block is bi-directional predicted are determined; fractional sample interpolation filtering is performed on the two reference picture blocks to determine two fractional sample reference picture blocks; and weighted combination is performed on the two fractional sample reference picture blocks, to determine the reference block for the current block.

For example, for a bi-directional predicted inter block, fractional sample interpolation filtering is required to be performed on the two reference blocks first, and then weighted combination is performed on the two fractional sample reference blocks. Then, after obtaining the two interpolation-filtered reference blocks, on the one hand, the prediction value can be obtained by weighted averaging according to the interpolation-filtered reference blocks, and on the other hand, the index of the texture feature can be derived according to the interpolation-filtered reference blocks.

It should also be noted that in the embodiment of the present application, the number of candidate sample used for deriving the index of the texture feature may be at least one, for example, 1, 2, 3, or more. In some embodiments, the number of candidate sample may be determined according to a size parameter of the current block.

That is, when the index of the texture feature of the current block is determined, how many candidate samples are used may be determined by the size parameter of the current block. Exemplarily, if the size of the current block is small, then all available samples may be statistically used. If the size of the current block is large, the current block may be downsampled for being statistically used, such as one sample of every 2, or 4, or 8 samples in the horizontal and/or vertical direction. Alternatively, if the size of the current block in one of the horizontal direction or vertical direction is less than or equal to 8, then all available samples in that direction are statistically used. Otherwise, if the size of the current block in one of the horizontal direction or vertical direction is less than or equal to 16, then one sample of every two samples in that direction is statistically used. Otherwise, one sample of every four samples in this direction is statistically used, which is not specifically limited here.

In some embodiments, the operation that the index of the texture feature of the current block is determined according to the candidate sample may include operations that: a horizontal gradient value and a vertical gradient value of the candidate sample is determined; an index of a texture feature and a gradient intensity value corresponding to the candidate sample is determined according to the horizontal gradient value and the vertical gradient value of the candidate sample; a texture feature statistical table is constructed according to the index of the texture feature and gradient intensity value corresponding to the candidate sample; and the index of the texture feature of the current block is determined according to the texture feature statistical table.

It should be noted that, in the embodiment of the present application, the operation that the index of the texture feature and the gradient intensity value corresponding to the candidate sample is determined according to the horizontal gradient value and the vertical gradient value of the candidate sample may include operations that: an angle mapping is performed according to the horizontal gradient value and the vertical gradient value of the candidate sample, to determine the index of the texture feature corresponding to the candidate sample; and gradient intensity calculation is performed according to the horizontal gradient value and the vertical gradient value of the candidate sample to determine a gradient intensity value corresponding to the candidate sample.

In a specific embodiment, the operation that the angle mapping is performed according to the horizontal gradient value and the vertical gradient value of the candidate sample, to determine the index of the texture feature corresponding to the candidate sample may include an operation that the index of the texture feature corresponding to the candidate sample is determined according to the horizontal gradient value and the vertical gradient value of the candidate sample by using a preset look-up table.

In the embodiment of the present application, the horizontal gradient value of the candidate sample may be represented by gradₓ, and the vertical gradient value of the candidate sample may be represented by grad_{y}. In this way, deriving a virtual intra prediction mode from gradₓ and grad_{y} can be realized by looking up the table.

Exemplarily, if abs(gradₓ) is equal to 0 and abs(grad_{y}) is not equal to 0, then there is a horizontal direction texture, corresponding to intra prediction mode 18 in some techniques. If abs(grad_{y}) is equal to 0 and abs(gradₓ) is not equal to 0, there is a vertical direction texture, corresponding to the intra prediction mode 50 in some techniques. In the case where neither abs(gradₓ) nor abs(grad_{y}) is equal to 0, if abs(gradₓ) is equal to abs(grad_{y}), and gradₓ and grad_{y} have the same sign, corresponding to the intra prediction mode 34 in some techniques. If abs(gradₓ) is equal to 2 times abs(grad_{y}), and gradₓ and grad_{y} have the same sign, corresponding to the intra prediction mode 40 in some techniques. In addition, other situations can be determined by looking up the table according to the same principle.

In a specific embodiment, the operation that the gradient intensity calculation is performed according to the horizontal gradient value and the vertical gradient value of the candidate sample, to determining the gradient intensity value corresponding to the candidate sample may include an operation that: an addition operation is performed on an absolute value of the horizontal gradient value and an absolute value of the vertical gradient value to determine the gradient intensity value corresponding to the candidate sample.

Here, the gradient intensity value corresponding to the candidate samples may be denoted as amp. Exemplarily, amp=abs(gradₓ)+abs(grad_{y}).

It should be noted that, in the embodiment of the present application, the horizontal gradient value and the vertical gradient value for the candidate sample can be calculated using a Sobel operator. Exemplarily, the Sobel operator is as follows:

An operator for the horizontal gradient value is:

| | | |
|---|---|---|
| −1 | 0 | 1 |
| −2 | 0 | 2 |
| −1 | 0 | 1 |

An operator for the vertical gradient value is:

| | | |
|---|---|---|
| −1 | −2 | −1 |
| 0 | 0 | 0 |
| 1 | 2 | 1 |

Thus, it is assumed that the sample value at the pixel position (x, y) is P_{x,y}, the horizontal gradient value gradₓ and the vertical gradient value grad_{y} are calculated as follows:

$$( 24 )$$

$${grad}_{x} = {P}_{x + 1 , y - 1} + 2 * {P}_{x + 1 , y} + {P}_{x + 1 , y + 1} - {P}_{x - 1 , y - 1} - 2 * {P}_{x - 1 , y} - {P}_{x - 1 , y + 1}$$

$$( 25 )$$

$${grad}_{y} = {P}_{x - 1 , y + 1} + 2 * {P}_{x , y + 1} + {P}_{x + 1 , y + 1} - {P}_{x - 1 , y - 1} - 2 * {P}_{x , y - 1} - {P}_{x + 1 , y - 1}$$

In some embodiments, the operation that the texture feature statistical table is constructed according to the index of the texture feature and the gradient intensity value corresponding to the candidate sample may include operations that: when the number of candidate sample is one or more, indexes of one or more texture feature and one or more corresponding gradient intensity values are determined; one or more types of reference texture feature indexes having mutually different characteristics are determined according to the indexes of the one or more texture features, and accumulation calculation is performed on gradient intensity values belonging to a same type of reference texture feature index according to the one or more gradient intensity values, to determine accumulated gradient intensity values corresponding to the one or more types of reference texture feature indexes; and the texture feature statistical table is constructed according to the one or more types of reference texture feature indexes and the accumulated gradient intensity values corresponding to the one or more types of reference texture feature indexes.

That is, in the embodiment of the present application, taking at least some samples in the prediction block being candidate samples as an example, gradient values of all or some samples in the prediction block are calculated, and generally, horizontal gradient values and vertical gradient values can be calculated. Here, the Sobel operator can be used to calculate the gradient values. For a certain sample, the texture direction of the sample can be derived according to its horizontal gradient value and vertical gradient value. For example, if the horizontal gradient value is non-zero and the vertical gradient value is zero, the texture of the sample is vertical. On the contrary, if the horizontal gradient value is zero and the vertical gradient value is non-zero, the texture of the sample is horizontal. For example, if the horizontal gradient value and the vertical gradient value are equal and not zero, the texture of the pixel is 45 degrees. Or, in the embodiment of the present application, there are many other cases in which both the horizontal gradient value and the vertical gradient value are not zero, the direction of the texture of the sample can be determined according to their ratio. In this way, the gradient intensity value of each sample can correspond to an index of the corresponding texture feature. Therefore a texture feature statistical table is constructed, the gradient intensity value of each calculated sample accumulated to index item of the corresponding texture feature in the statistical table to obtain the final texture feature statistical table, and then the index of the texture feature of the current block may be determined according to the texture feature statistical table.

In a possible implementation, the operation that the index of the texture feature of the current block is determined according to the texture feature statistical table may include operations that: a maximum accumulated gradient intensity value in the texture feature statistical table is determined; and an index of a reference texture feature corresponding to the maximum accumulated gradient intensity value is determined as the index of the texture feature of the current block.

In another possible implementation, the operation that the index of the texture feature of the current block is determined according to the texture feature statistical table may include operations that: a maximum accumulated gradient intensity value in the texture feature statistical table is determined; when the maximum accumulated gradient intensity value is less than a first threshold, the index of the texture feature of the current block is set as a DC mode or a PLANANR mode.

In yet another possible implementation, the operation that the index of the texture feature of the current block is determined according to the texture feature statistical table may include operations that: a statistical sum value of all accumulated gradient intensity values in the texture feature statistical table is determined; when the statistical sum value is less than a second threshold, the index of the texture feature of the current block is set as a DC mode or a PLANANR mode.

That is, in the embodiment of the present application, for the deviation of the virtual intra prediction mode (index), since the virtual intra prediction mode (index) may also be referred to as an index of a texture feature, the deviation of the virtual intra prediction mode (index) may also be referred to as derivation of an index of a texture feature here.

In an embodiment of the present application, an inter prediction block may be used to derive a virtual intra prediction mode. If a certain texture exists in the prediction block, it is conceivable that a texture with a same feature exist in the residual block. Exemplarily, here, gradient values for all or part of the samples in the prediction block may be calculated. Generally, the horizontal gradient value and the vertical gradient value may be calculated. Herein, the gradient value may be calculated using the Sobel operator. Then, the corresponding gradient intensity value is determined according to the horizontal gradient value and the vertical gradient value, and then the gradient intensity value corresponds to the corresponding intra prediction mode, so as to construct an intra prediction mode statistical table (i.e., the aforementioned “texture feature statistical table”). The calculated gradient intensity value of each candidate sample needs to be accumulated into the corresponding intra prediction mode item in the statistical table. After the gradient statistics are completed, one possible implementation is that the one intra prediction mode that is accumulated the most in the intra prediction mode statistics table is the virtual intra prediction mode of the current block. Alternatively, another possible implementation method is to determine that the virtual intra prediction mode is the DC mode or the PLANANR mode when the accumulated gradient intensity value of the intra prediction mode having the highest statistically accumulated gradient intensity is less than a certain threshold value. Alternatively, yet another possible implementation is to determine that the virtual intra prediction mode is the DC mode or the PLANANR mode when the sum of all the statistically accumulated gradient intensity values of samples is less than a certain threshold.

In addition, similar statistical derivation of the intra prediction mode is also required for the DIMD, but the difference is that the DIMD uses the reconstruction region around the current block, and here the prediction block of the current block is used. In practice, this scheme can multiplex part of the logic with the DIMD.

It should also be noted that, as for the samples used to derive the virtual intra prediction mode for inter prediction, the reconstructed regions on the left and top sides of the current block may be used here, which is similar to the method for the DIMD. Because the reconstructed regions on the left and top sides are not the current block but are neighboring to the current block, for example, there is a case that the textures are connected, they can be used to estimate the texture of the current block to a certain extent. Another possibility is to use both the prediction block of the current block and the reconstructed regions on the left and top sides of the current block, so that there are more samples available for deviating the virtual intra prediction mode. Another possibility is to consider the workflow length of the hardware. For the current block, a virtual intra prediction mode can be derived only after the prediction block is obtained, only when the virtual intra prediction mode is determined, the transform kernel of the LFNST/NSPT can be determined, then the inverse transform and subsequent processes can be performed. If the reference block is used to derive the virtual intra prediction mode, the process of generating the prediction block and the process of deriving the virtual intra prediction mode can theoretically be carried out in parallel, which is shorter than the design workflow described above. Therefore, the embodiment of the present application may also use the reference block to derive the virtual intra prediction mode, or synchronously derive the virtual intra prediction mode in the process of generating the prediction block. When using the reference block, the integer sample reference block can be directly used, because there will be no obvious difference in texture directions. For example, for a bi-directional predicted inter block, on the one hand, a virtual intra prediction mode is derived from the integer sample reference block; on the other hand, fractional sample interpolation filtering is performed on the two reference blocks, and then weighted combination is performed on the two fractional sample reference blocks. Specifically, the interpolation-filtered fractional sample reference block may also be used here. For example, for a bi-directional predicted inter block, it is necessary to first perform fractional sample interpolation filtering on two reference blocks, and then perform weighted combination of the two fractional sample reference blocks. Then, after obtaining the two interpolation-filtered reference blocks, on the one hand, the prediction value can be obtained by weighted averaging according to the interpolation-filtered reference blocks, and on the other hand, the virtual intra prediction mode can be derived according to the interpolation-filtered reference blocks.

In some embodiments, the operation that the index of the texture feature of the current block is determined may further include an operation that: an index of an angle for the current block when a geometric partitioning mode is performed is determined; and the index of the texture feature of the current block is determined according to the index of the angle.

In the embodiment of the present application, for the derivation of the virtual intra prediction mode for the geometric partition mode (GPM), the prediction block of the GPM is obtained by combining prediction blocks with different motions, so it may contain the contents of two objects, and the boundary is usually difficult to be predicted perfectly, so there may be a large residual at the boundary between the two objects, and the direction of this residual is consistent with the “partition” direction of the GPM. Therefore, for the GPM, the virtual intra prediction mode can be determined using the “partition” mode of the GPM.

In the embodiment of the present application, the partition line may be considered to be a line composed of points having the same weight in a region, in which the weight changes, in the weight matrix of the GPM, in other words, a line composed of points for which the weights are median, and the points for which weights are median may not be at the integer sample position. Taking weights from 0 to 8 as an example, the median value can be 4. FIG. 40 shows a schematic diagram of a partition line for a GPM mode. As shown in FIG. 40, the thickened solid line is the partition line described herein.

In fact, the weights for the GPM are derived from the partition line. Taking some processes of the GPM in some technologies as examples below, the following merge_GPM_partition_idx [xCb] [yCb] is used to determine “partition”, which is the weight derivation mode described in the embodiment of the present application. A “partition” angle index variable angleIdx and a distance index variable distanceIdx of the GPM are determined using Table 6 according to merge_GPM_partition_idx [xCb] [yCb]. The angle index variable angleIdx and the distance index variable distanceIdx can be regarded as variables that determine the partition line, and they may be respectively used to determine the angle and offset of the partition line.

Because all three color components (such as Y, Cb, and Cr) can use the GPM, the standard text packages the process of generating the prediction sample matrix of the GPM for one component into a sub-process, that is, the weighted prediction process for GPM (weighted sample prediction process for geometric partitioning mode). This process will be invoked for all three color components, but the parameters invoked are different. Here, only the luma component is used as an example. The prediction matrix predSamplesL [xL] [yL] of the current luma block (where xL=0 . . . cbWidth−1, yL=0 . . . cbHeight−1) is derived from the weighted prediction procedure for the GPM. nCbW is set to cb Width, nCbH is set to cbHeight. The prediction sample matrices for the two prediction modes predSamplesLAL and predSamplesLBL, and angleIdx and distanceIdx are used as inputs.

The following is the process of deriving the weighted prediction process for the GPM:

The inputs to this process include:
width nCbW of current block height nCbH of current block;
2 prediction sample matrices of (nCbW)×(nCbH) predSamplesLA and predSamplesLB;
“partition” angle index variable angleIdx for the GPM;
distance index variable distanceIdx for the GPM;
component index variable cIdx. Because only the luma component is taken as an example in this embodiment, where cIdx is 0, indicating the luma component.

The output of this process is a prediction sample matrix pbSamples of (nCbW)×(nCbH) for the GPM.

The variables nW, nH, shift1, offset1, displacementX, displacementY, partFlip, and shiftHor are derived as follows:

$$nW = ( cIdx == 0 ) ? nCbW : nCbW * SubWidthC ;$$

$$nH = ( cIdx == 0 ) ? nCbH : nCbH * SubHeightC ;$$

shift1=Max (5, 17-BitDepth), where BitDepth is the bit depth for coding;

$$offset 1 = 1 << ( shift 1 - 1 ) ;$$

$$displacementX = angleIdx ;$$

$$displacementY = ( angleIdx + 8 ) \% 32 ;$$

$$partFlip = ( angleIdx >= 13 \&\& angleIdx <= 27 ) ? 0 : 1 ;$$

$$shiftHor = ( angleIdx \% 16 == 8 ‖ ( angleIdx \% 16 != = 0 \&\& nH >= nW ) ) ? 0 : 1 ;$$

The variables offsetX and offsetY are derived as follows:

$$- If the value of shiftHor is 0 :$$

$$offsetX = ( - nW ) >> 1 ;$$

$$offsetY = ( ( - nH ) >> 1 ) + ( angleIdx < 16 ? ( distanceIdx * nH ) >> 3 : - ( ( distanceIdx * nH ) >> 3 ) ) ;$$

$$- otherwise ( i . e . the value of shiftHor is 1 ) :$$

$$offsetX = ( ( - nW ) >> 1 ) + ( angleIdx < 16 ? ( distanceIdx * nW ) >> 3:- ( ( distanceIdx * nW ) >> 3 ) ;$$

$$offsetY = ( - nH ) >> 1 ;$$

The prediction sample matrix pbSamples [x] [y] (where x=0 . . . nCbW−1, y=0 . . . nCbH−1) is derived as follows:
Variables xL and yL are derived as follows:

$$xL = ( cIdx == 0 ) ? x : x * SubWidthC ;$$

$$yL = ( cIdx == 0 ) ? y : y * SubHeightC ;$$

a variable wValue representing the weight of the prediction sample at the current position is derived as follows: wValue is the weight for the prediction value predSamplesLA [x] [y] of the prediction matrix of the first prediction mode at the point (x, y) and (8-wValue) is the weight for the prediction value predSamplesLB [x] [y] of the prediction matrix of the first prediction mode at the point (x, y). The above-described Table 7 provides an example of the definition of a distance matrix disLut. In this way, the value of disLut can be determined according to Table 7.

Here, weightIdx=(((xL+offsetX)<<1)+1)*disLut [displacementX]+ (((yL+offsetY)<<1)+1)*disLut [displacementY];

$$weightIdxL = partFlip ? 32 + weightIdx : 32 - weightIdx ;$$

$$wValue = Clip 3 ( 0 , 8 , ( weightIdxL + 4 ) >> 3 ) ;$$

The values of the predicted samples are derived as follows:

$$pbSamples [ x ] [ y ] = Clip 3 ( 0 , ( 1 << BitDepth ) - 1 , ( predSamplesLA [ x ] [ y ] * wValue + predSamplesLB [ x ] [ y ] * ( 8 - wValue ) + offset ) >> shift 1 ) .$$

It should be noted here that in the standard text, a weight value wValue is derived for each position, and then a prediction value pbSamples [x] [y] for the GPM is calculated. Because in this way, the weight wValue does not have to be written in the form of a matrix, but it can be understood that if the wValue of each position is saved in a matrix, then it is a weight matrix. The weight for each point is calculated separately and weighting is performed to obtain the prediction value for the GPM, or, all the weights are calculated and then weighting is performed together to obtain the predicted sample matrix for the GPM, the principles of them are the same. The use of weight matrix in many descriptions in this application is to make the expression easier to understand, and expression with weight matrix is more intuitive. In fact, it can also be described according to the weight for each position. For example, a mode for deriving the weight matrix can also be referred to as the weight derivation mode.

In this way, according to the derivation process of weight wValue, it can be seen that wValue is derived according to angleIdx and distanceIdx. Therefore, when determining the intra prediction mode corresponding to the partition line, angleIdx may be determined first, and then the corresponding intra angle prediction mode may be determined according to angleIdx. Because according to Table 6 above, it can also be seen that multiple weight derivation modes correspond to an angleIdx. One possible correspondence between an angleIdx and intra angle prediction mode is shown in Table 8 above. It can be seen that some angleIdx correspond to 0, because these angleIdx are not used in the GPM, that is, the example of 64 weights as shown in FIG. 10. It should be understood that if some angleIdx changes in a certain version, for example, more angleIdx are used in the future, or the intra angle prediction mode changes, for example, there are more intra prediction modes in the future, then this correspondence table can also change accordingly, and is not specifically limited here.

Further, in the embodiment of the present application, the index of the texture feature of the current block may directly copy the index of the texture feature of the reference block. In some embodiments, the operation that the index of the texture feature of the current block is determined may further include an operation that: the virtual intra prediction mode of the current block is determined according to the intra prediction mode of the reference block or the virtual intra prediction mode of the reference block, that is, the index of the texture feature of the current block is determined according to the index of the texture feature of the reference block. If the reference block for the current block has an intra-encoded block, the intra-encoded block has an intra prediction mode, and the intra prediction mode of the reference block may be used as a virtual intra prediction mode of the current block. If the reference block for the current block includes a plurality of intra-encoded blocks, the intra prediction mode at a certain position may be determined according to the coordinates. For example, the intra prediction mode of the reference block corresponding to the center position of the current block is used as the virtual intra prediction mode of the current block. A virtual intra prediction mode may be saved for each inter-encoded block. If the reference block for the current block is an inter-encoded block, it may also find a virtual intra prediction mode. The virtual intra prediction mode can also be stored according to a certain granularity, for example, each 4×4 sample is a minimum storage unit, and each minimum storage unit shares the same intra prediction mode or virtual intra prediction mode. If the reference block for the current block includes a plurality of 4×4 minimum storage units, the (virtual) intra prediction mode at a certain position may be determined according to the coordinates. For example, the (virtual) intra prediction mode of the minimum storage unit of the reference block corresponding to the central position of the current block is used as the virtual intra prediction mode of the current block.

Thus, after the virtual intra angle prediction mode (i.e. the index of the texture feature) is determined, the transform kernel set for the NSPT/LFNST can be determined according to the index of the texture feature.

Further, in the embodiment of the present application, a candidate list may be constructed to determine a virtual intra angle prediction mode. Accordingly, in some embodiments, the operation that the index of the texture feature of the current block is determined may further include operations that: a candidate list is constructed, herein the candidate list includes indexes of a preset number of candidate texture features; cost value calculation is performed on the indexes of the preset number of candidate texture features respectively, to determine respective cost values for the indexes of the preset number of candidate texture features; and a minimum cost value is determined from the respective cost values for the indexes of the preset number of candidate texture features, and an index of a candidate texture feature corresponding to the minimum cost value is determined as the index of the texture feature of the current block.

It should be noted that, in the embodiment of the present application, the preset number may be 1, 2, 3, or more. If only one index of a candidate texture feature is included in the candidate list, then this one index of the candidate texture feature can be directly used as the index of the texture feature of the current block without performing cost value calculation.

It should be noted that, in the embodiment of the present application, the cost value calculation is performed on each of indexes of the preset number of candidate texture features, to determine the cost value of each of the indexes of the preset number of candidate texture features. Here, the cost value may be determined based on the cost result of Rate Distortion Optimization (RDO), the cost result of Sum of Absolute Difference (SAD), or even the cost result of Sum of Absolute Transformed Difference (SATD), but there is no limitation here.

Exemplarily, taking the rate-distortion optimization method as an example, the rate-distortion cost value calculation may be performed according to indexes of a preset number of candidate texture features, to determine a cost value of each of the indexes of the preset number of candidate texture features, and then a minimum cost value may be selected therefrom, and an index of the candidate texture feature corresponding to the minimum cost value may be determined as the index of the texture feature of the current block, thereby improving encoding efficiency.

Further, in some embodiments, the method further includes operations that: a feature index sequence number of the current block is determined according to the index of the texture feature of the current block, herein the feature index sequence number is used to indicate a number of the index of the texture feature of the current block in the candidate list; and the feature index sequence number of the current block is encoded, and the obtained encoded bits are written into the bitstream.

It should be noted that the foregoing embodiment refers to deriving the virtual intra prediction mode using a prediction block or a reference block for the current block or a reconstructed picture around the current block. In a specific embodiment, an intra prediction mode having the maximum gradient intensity value may be selected as the virtual intra prediction mode. In addition, a step may be added to construct a candidate list, that is, a virtual intra prediction mode candidate list or a feature index candidate list. A syntax element is then written in the bitstream for indicating which candidate is ultimately selected. The syntax element used herein, that is, the feature index sequence number of the current block, may be represented by lfnst_nspt_feature_idx.

That is, when encoding, the encoder can construct a candidate list by the above method, then attempt to encode all possible candidates respectively, determine a candidate with the minimum encoding cost as the transform kernel used by the current block, determine the value of lfnst_nspt_feature_idx and write it into the bitstream. The value of lfnst_nspt_feature_idx may be an integer such as 0, 1, 2, and 3. For example, if the first element in the candidate list is selected, it may be determined that the value of lfnst_nspt_feature_idx is 0. If the second element of the candidate list is selected, it may be determined that lfnst_nspt_feature_idx is 1.

It should also be noted that, in the embodiment of the present application, if only one index of a candidate texture feature is included in the candidate list, not only can the one index of the candidate texture feature be directly used as the index of the texture feature of the current block without the cost value calculation, but also it is not necessary to determine the value of lfnst_nspt_feature_idx, and it is not necessary to write the value of lfnst_nspt_feature_idx into the bitstream.

In some embodiments, the operation that the candidate list is constructed includes operations that: indexes of one or more reference texture features in the texture feature statistical table are sorted from large to small according to corresponding accumulated gradient intensity values, to determine the indexes of the preset number of reference texture features that are sorted first; and the candidate list is constructed according to the indexes of the preset number of reference texture features that are sorted first.

In some embodiments, the operation that the candidate list is constructed includes operations that: an index of a first texture feature corresponding to a maximum accumulated gradient intensity value in the texture feature statistical table is determined, and an index of a second texture feature corresponding to the current block when a geometric partitioning mode is performed; and the candidate list is constructed according to the index of the first texture feature and the index of the second texture feature.

That is, in the embodiment of the present application, an example of constructing the candidate list is that, based on the above-described method of calculating the gradient intensity, the top N intra prediction modes (indexes of texture features) are selected according to the gradient intensities from larger to smaller to constitute the candidate list. The value of N may be 2, 3, 4, etc. Another example is that it is assumed that the value of N is 2, that is, an intra prediction mode (an index of a texture feature) with the maximum gradient intensity is the first element in the candidate list, and an intra prediction mode (an index of a texture feature) with the second maximum gradient intensity is the second element in the candidate list. Another example is that: for the GPM, the first element in the candidate list may be set as an intra prediction mode (an index of a texture feature) corresponding to the “partition” mode for the GPM, and the second element may be set as an intra prediction mode (t an index of a texture feature) with the maximum gradient intensity, or vice versa. There is no specific limitation here.

In some embodiments, the operation that the candidate list is constructed may further include an operation that: a reference block for the current block is determined; and the candidate list is constructed according to indexes of texture features corresponding to one or more candidate positions in the reference block.

That is, in the embodiment of the present application, the candidate list is constructed according to the intra prediction mode (the index of the texture feature) of the reference block. For example, the candidate list is constructed according to the intra prediction modes (the index of the texture feature) of the 4×4 minimum storage units corresponding to some positions in the reference block. The coordinate of the top left corner of the current block is (x, y), the width of the current block is nCbW, the height of the current block is nCbH, the center point posC of the current block is (x+nCbW/2, y+nCbH/2), the top left corner is posTL(x, y), the top right corner is posTR(x+nCbW−1, y), the below left corner is posBL(x, y+nCbH−1), the below right corner is (x+nCbW−1, y+nCbH−1). The candidate list is constructed with the intra prediction modes (the indexes of the texture features) of the smallest storage units corresponding to posC, posTL, posTR, posBL and posBR in turn. Here, the candidate position may be at least one of posC, posTL, posTR, posBL, and posBR, but is not limited thereto.

It should also be noted when constructing the list, the encoder needs to ensure that each item in the candidate list is not repeated. If the available intra prediction modes (the indexes of the texture features) cannot fill the list, a default intra prediction mode (an index of a texture feature) may be added, for example, an intra prediction mode (an index of a texture feature) in horizontal direction or vertical direction.

It should be noted that this method can be applied not only to inter prediction but also to intra prediction. If the value of N is 2, then only a binary symbol is needed to represent it. If the value of N is greater than 2, then a truncated unary code can be used. Here, all binary symbols can be encoded using the context model of the CABAC.

For example, referring to Table 9, the value of the feature index sequence number lfnst_nspt_feature_idx of the current block may be binarized using a truncated unary code, and then each encoding bit may be encoded based on the context model.

TABLE 9

| The value of | |
|---|---|
| lfnst_nspt_feature_idx | Encoded bits |
| 0 | 0 |
| 1 | 10 |
| 2 | 110 |
| 3 | 111 |

In this way, after the candidate list is constructed, the virtual intra angle prediction mode (that is, the index of the texture feature of the current block) can also be determined according to the feature index sequence number obtained by decoding the bitstream.

In S4302, a transform kernel set for the current block is determined according to the index of the texture feature.

In S4303, a transform kernel for the current block is determined according to the transform kernel set.

It should be noted that, after the index of the texture feature of the current block is determined, the transform kernel set for the current block can be determined according to a correspondence between an index of a texture feature and a transform kernel set. For example, the LFNST in some techniques has a total of four transform kernel sets, and the correspondence between the intra prediction mode and the transform kernel set is detailed in Table 4. In some technologies, the LFNST may also have more transform kernel sets, such as 35 groups. The correspondence between the intra prediction mode and the transform kernel sets is detailed in Table 5.

Additionally, each transform kernel set may include at least two transform kernels. For example, a transform kernel set may include two transform kernels, or may include three transform kernels, or may include four optional transform kernels, or a larger number of optional transform kernels, which are not specifically limited herein.

In some embodiments, the transform kernel set includes one or more candidate transform kernels. Accordingly, the operation that the transform kernel for the current block is determined according to the transform kernel set may include an operation that: cost value calculation is performed on the one or more candidate transform kernels respectively, to determine respective cost values of the one or more candidate transform kernels; and a minimum cost value is determined from the respective cost values of the one or more candidate transform kernels, and a candidate transform kernel corresponding to the minimum cost value is determined as the transform kernel for the current block.

In one possible implementation, the cost value calculation is performed on the one or more candidate transform kernels. Here, taking the first candidate transform kernel as an example, the method may include operations that: transform and quantization are performed on the residual block of the current block based on a first candidate transform kernel, to determine a first candidate quantization coefficient of the current block, entropy coding processing is performed on the first candidate quantization coefficient, to determine a first cost value of the first candidate transform kernel; inverse quantization and inverse transform are performed on the first candidate quantization coefficient, to determine a first candidate residual block of the current block, and a first candidate prediction block of the current block is determined according to the first candidate residual block; cost calculation is performed according to the first candidate prediction block and an original picture of the current block, to determine a second cost value of the first candidate transform kernel; and a cost value of the first candidate transform kernel is determined based on the first cost value and the second cost value of the first candidate transform kernel.

It should be noted that, in the embodiment of the present application, the first candidate transform kernel is any one of one or more candidate transform kernels, and thus, the cost value of each of the one or more candidate transform kernels can be determined.

It should also be noted that, in the embodiment of the present application, the first cost value may represent the cost of overhead of the first candidate transform kernel in the bitstream, and the second cost value may represent the cost of distortion of the first candidate transform kernel. Here, the operation that the cost value of the first candidate transform kernel is determined according to the first cost value and the second cost value of the first candidate transform kernel may include an operation that the first cost value and the second cost value of the first candidate transform kernel are summed, and the sum value of the first cost value and the second cost value is used as the cost value of the first candidate transform kernel.

It should also be noted that, in the embodiment of the present application, the cost value calculation herein may be determined based on the cost result of RDO, the cost result of SAD, or even the cost result of SATD, but there is no limitation here.

It should also be noted that, in the embodiments of the present application, the transform kernel set may include 1, 2, 3, or more candidate transform kernels. If the transform kernel set includes only one candidate transform kernel, then this one candidate transform kernel can be directly used as the transform kernel for the current block without performing cost value calculation.

In some embodiments, the method further includes: a value of first syntax identifier information of the current block is determined, the first syntax identifier information is used to indicate whether the first transform mode is used for the current block and an index of a correspondingly used transform kernel; and the value of the first syntax identifier information is encoded, and the obtained encoded bits are written into the bitstream.

It should be noted that, in the embodiment of the present application, the first syntax identifier information may be represented by lfnst_nspt_idx. The first syntax identifier information may be used to indicate whether a first transform mode is used for the current block, and when a first transform mode is used for the current block, the value of the first syntax identifier information may be used to indicate the index of the transform kernel used by the current block.

It should also be noted that in the embodiment of the present application, the first transform mode may be the LFNST or NSPT. That is, lfnst_nspt_idx is used to indicate whether the LFNST or the NSPT is used for the current block, and when the LFNST or the NSPT is used for the current block, the value of lfnst_nspt_idx may also be used to indicate the index of the transform kernel used by the current block. Whether the LFNST or the NSPT is used for the current block may be determined according to the size parameter of the current block. Exemplarily, if the size parameter of the current block is small, it may be determined that lfnst_nspt_idx is used to indicate whether the NSPT is used for the current block and the index of the transform kernel corresponding to the used NSPT; If the size parameter of the current block is large, it may be determined that lfnst_nspt_idx is used to indicate whether the LFNST is used for the current block and the index of the transform kernel corresponding to the used LFNST.

In the embodiment of the present application, two pieces of syntax identifier information lfnst_nspt_idx and nspt_idx may be used instead of the first syntax identifier information lfnst_nspt_idx. Here, lfnst_idx is used to indicate whether or not the LFNST is used for the current block and the index of the used transform kernel corresponding to the LFNST, and nspt_idx is used to indicate whether or not the NSPT is used for the current block and the index of the transform kernel corresponding to the used NSPT, which are not specifically limited here.

In some embodiments, the method further includes operations that: an index of a transform kernel index of the current block is determined; herein the index of the transform kernel is used to indicate a number of the transform kernel for the current block in the transform kernel set; when an intra prediction mode is used for the current block, the index of the transform kernel for the current block is encoded and the obtained encoded bits are written into the bitstream; when an inter prediction mode is used for the current block, the value of the first syntax identifier information is determined according to the index of the transform kernel for the current block, the value of the first syntax identifier information is encoded, and the obtained encoded bits are written into the bitstream.

It should be noted that, in the embodiment of the present application, when the intra prediction mode is used for the current block, the first syntax identifier information is used to indicate whether a first transform mode is used for the current block. When the first transform mode is used for the current block, it is also necessary to determine the index of the transform kernel for the current block, the index of the transform kernel for the current block is encoded, and the obtained encoded bits are written into the bitstream, so as to subsequently determine the transform kernel for the current block at the decoding side according to the transform kernel set and the index of the transform kernel obtained by decoding. Herein the index of the transform kernel is used to indicate the number of the transform kernel for the current block in the transform kernel set. Exemplarily, if the index of the transform kernel for the current block is 0, the transform kernel for the current block is the first transform kernel in the transform kernel set. If the index of the transform kernel for the current block is 1, then the transform kernel for the current block is the second transform kernel in the transform kernel set. If the index of the transform kernel for the current block is 2, then the transform kernel for the current block is the third transform kernel of the transform kernel set.

It should also be noted that, in the embodiment of the present application, when the inter prediction mode is used for the current block, there are three transform kernels in one transform kernel group for the LFNST/NSPT for selection. In addition, there is a case in which the LFNST/NSPT is not used. That is, there are four possible options for the current block for the LFNST/NSPT. Therefore, lfnst_nspt_idx may be used here to indicate whether a first transform mode is used for the current block and the index of the transform kernel used by the current block. In this way, after the index of the transform kernel for the current block is determined, the value of the first syntax identifier information can be determined according to the index of the transform kernel for the current block, the value of the first syntax identifier information can be encoded, and the obtained encoded bits can be written into the bitstream, so as to subsequently determine the transform kernel for the current block at the decoding side according to the transform kernel set and the value of the first syntax identifier information obtained by decoding.

In some embodiments, for the value of the first syntax identifier information, if the first transform mode is not used for the current block, it is determined that the value of the first syntax identifier information is a first value. If the first transform mode is used for the current block and the index of the transform kernel used for the current block is 0, it is determined that the value of the first syntax identifier information is a second value. If the first transform mode is used for the current block and the index of the transform kernel used for the current block is 1, it is determined that the value of the first syntax identifier information is a third value. If the first transform mode is used for the current block and the index of the transform kernel used for the current block is 2, it is determined that the value of the first syntax identifier information is a fourth value.

In a specific embodiment, the first value is equal to 0, the second value is equal to 1, the third value is equal to 2, and the fourth value is equal to 3.

Exemplarily, if the LFNST/NSPT is not used for the current block, it is determined that the value of the first syntax identifier information is 0. If the LFNST/NSPT is used for the current block, and the transform kernel for the current block is the first transform kernel in the transform kernel set, it is determined that the value of the first syntax identifier information is 1. If the LFNST/NSPT is used for the current block, and the transform kernel for the current block is the second transform kernel in the transform kernel set, it is determined that the value of the first syntax identifier information is 2. If the LFNST/NSPT is used for the current block, and the transform kernel for the current block is the third transform kernel in the transform kernel set, it is determined that the value of the first syntax identifier information is 3. That is, in the embodiments of the present application, the value of lfnst_nspt_idx may be 0, 1, 2, 3, or the like.

It should also be noted that, in the embodiment of the present application, the first syntax identifier information lfnst_nspt_idx may be replaced by two other syntax identifier information. One piece of syntax identifier information is used to indicate whether the LFNST/NSPT is used for the current block, and the other syntax identifier information is used to indicate a corresponding transform kernel index when the LFNST/NSPT is used for the current block. In this way, two syntax elements need to be transmitted in the bitstream, resulting in a large bitstream overhead. In this case, for the case where the index of the transform kernel needs to be transmitted in the bitstream, if there is only one transform kernel in the transform kernel set, there is no need to perform the cost value calculation and transmit the index of the transform kernel at this time. Specifically, when the LFNST/NSPT is used for the current block, the only one transform kernel in the transform kernel set may be directly used as the transform kernel for the current block.

In some embodiments, an operation that when the first syntax identifier information indicates that the first transform mode is used for the current block, the index of the transform kernel for the current block is determined may include operations that: when the intra prediction mode is used for the current block, the index of the transform kernel for the current block is determined; when the inter prediction mode is used for the current block, the index of the transform kernel for the current block is determined according to the value of the first syntax identifier information.

Further, in a case where the index of the texture feature is determined by the candidate list, before performing the encoding process on the feature index sequence number of the current block, the method further includes an operation that: when the first transform mode is used for the current block, the encoding process is performed on the feature index sequence number of the current block and the obtained encoded bits are written into the bitstream.

That is, in the embodiment of the present application, the first syntax identifier information is represented by lfnst_nspt_idx, and the feature index sequence number is represented by lfnst_nspt_feature_idx. Here, lfnst_nspt_feature_idx may be used to select a virtual intra prediction mode or an index of a texture feature. Exemplarily, if the first element in the candidate list is selected, it may be determined that lfnst_nspt_feature_idx is 0. If the second element in the candidate list is selected, it may be determined that lfnst_nspt_feature_idx is 1. In addition, here, it may be determined whether it is necessary to encode lfnst_nspt_feature_idx when the LFNST or NSPT is used for the current block. Specifically, if the LFNST/NSPT is not used for the current block, lfnst_nspt_feature_idx does not need to be encoded. For example, since lfnst_nspt_idx is used to indicate whether the LFNST/NSPT is used for the current block and which transform kernel is selected from the transform kernel set of the LFNST/NSPT, if lfnst_nspt_idx is 0 at this time, it means that the LFNST/NSPT is not used for the current block, and in this case, it is not necessary to continuously encode lfnst_nspt_feature_idx. Otherwise, if lfnst_nspt_idx is not 0, it means that the LFNST/NSPT is used for the current block. In this case, lfnst_nspt_feature_idx can be continuously encoded, so that the index of the texture feature of the current block can be determined on the basis of the decoded lfnst_nspt_feature_idx at the decoding side.

It should be noted that the above method can be applied not only to inter prediction but also to intra prediction, and is not specifically limited here.

In S4304, a residual block of the current block is determined, and the residual block of the current block is transformed according to the transform kernel to determine a transform coefficient of the current block.

In S4305, the transform coefficient of the current block is encoded, and the obtained encoded bits are written into the bitstream.

It should be noted that, in the embodiment of the present application, when the transform coefficient of the current block is encoded, the method may include operations that: quantization process is performed on the transform coefficient of the current block to determine the quantization coefficient of the current block; the quantization coefficients of the current block are encoded, and the obtained encoded bits are written into the bitstream.

It should also be noted that, in the embodiment of the present application, the “transform” of the residual block at the encoding end may also be referred to as “positive transform”, and specifically refers to the transform from the spatial domain to the frequency domain to remove the correlation of the residual. It should be noted that if the standard only specifies decoding, then the “transform” in the standard text is the part of decoding, specifically referring to the “inverse transform” herein.

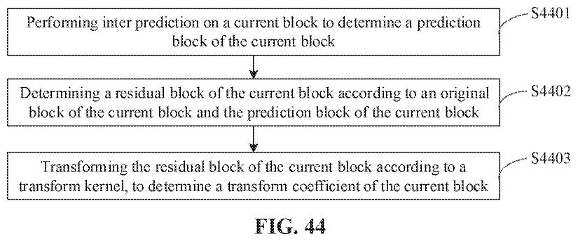

It should also be noted that, in the embodiment of the present application, referring to FIG. 44, for operation S4304, the method may include S4401-S4403.

In S4401, inter prediction is performed on the current block, to determine a prediction block of the current block.

In S4402, the residual block of the current block is determined according to the original block of the current block and the prediction block of the current block.

In S4403, the residual block of the current block is transformed according to the transform kernel, to determine the transform coefficient of the current block.

In the embodiment of the present application, operations S4401 to S4402 may be performed in parallel with operations S4301 to S4303, or may be performed before operations S4301 to 4303, or may be performed after operations S4301 to 4303, and the order of the operations is not specifically limited here.

It should also be noted that, in the embodiment of the present application, after the prediction block of the current block is determined, a subtraction operation may be performed on the original block of the current block and the prediction block of the current block to determine the residual block of the current block.

It should also be noted that, in the embodiment of the present application, the operation that when the transform is performed on the residual block of the current block according to the transform kernel, to determine the transform coefficient of the current block may include operations that: when a size parameter of the current block satisfies a first condition, an non-separable primary transform is performed on the residual block of the current block according to the transform kernel, to determine the transform coefficient of the current block; when the size parameter of the current block satisfies a second condition, a discrete cosine transform is performed on the residual block of the current block, to determine a transform block of the current block; and a low-frequency non-separable transform is performed on the transform block of the current block according to the transform kernel, to determine the transform coefficient of the current block.

Here, the size parameter of the current block satisfies the first condition, including that the size parameter of the current block is small. For example, the size parameter of the current block is less than a certain threshold. That is, for a block with a smaller size, the transform kernel of the NSPT is used here, that is, the NSPT is performed on the residual block of the current block according to the transform kernel, to determine the transform coefficient of the current block.

Here, the size parameter of the current block satisfies the second condition, including that the size parameter of the current block is large. For example, the size parameter of the current block is larger than a certain threshold. That is, for a block with a larger size, the transform kernel of the LFNST is used here. That is, a primary transform of DCT2 is performed on the residual block of the current first, and then the LFNST is performed on the transform block of the current block according to the transform kernel to determine the transform coefficient of the current block.

In short, after determining the prediction block, the encoder derives a virtual intra prediction mode according to the prediction block, and then determines the transform kernel set for the NSPT/LFNST according to the virtual intra prediction mode. If a transform kernel set has multiple transform kernels for selection, the encoder tries each transform kernel in the transform kernel set.

If it is the NSPT, the positive transform can be performed on the residual block using the NSPT to obtain transform coefficients, the transform coefficients can be quantized to obtain quantization coefficients, and then the quantization coefficients can be entropy-encoded. The cost of the overhead in the bitstream under the transform kernel can be obtained by entropy coding. The quantization coefficients are inversely quantized to obtain decoded transform coefficients, and inversely NSPT is performed on the decoded transform coefficients to obtain decoded residual blocks. The decoded transform coefficients and the original transform coefficients may be different because quantization is lossy. Likewise, the decoded residual block and the original residual block may be different. A reconstructed block is obtained from the decoded residual block and the prediction block. The cost of distortion can be obtained according to the reconstructed block and the original picture of the current block. The cost of encoding using the current transform kernel of the NSPT is the cost of overhead plus the cost of distortion. The costs of several transform kernels are compared, and the smallest one is selected as the best choice for the NSPT of the current block.

If it is the LFNST, positive transform can be performed on the residual block using DCT2, then the positive transform can be performed using the LFNST to obtain the transform coefficients the transform coefficients can be quantized to obtain the quantization coefficients, and then the quantization coefficients can be entropy-encoded. The cost of overhead in the bitstream for the transform kernel can be obtained by entropy coding. The quantization coefficients are inversely quantized to obtain decoded transform coefficients, and inverse LFNST is performed on the decoded transform coefficients, and then inverse DCT2 is performed on it to obtain decoded residual blocks. The decoded transform coefficients and the original transform coefficients may be different because quantization is lossy. Likewise, the decoded residual block and the original residual block may be different. A reconstructed block is obtained according to the decoded residual block and the prediction block. The cost of distortion can be obtained from the original picture and the reconstructed block of the current block. The cost of encoding using the current transform kernel of the LFNST is the cost of overhead plus the cost of distortion. The costs of several transform kernels are compared, and the smallest one is selected as the best choice for the LFNST of the current block.

It can be understood that the embodiment of the present application may use a high level syntax to control the enable/disable of the present technical solution. In some embodiments, the method further includes operations that: a value of second syntax identifier information is determined; and the value of the second syntax identifier information is encoded, and the obtained encoded bits are written into the bitstream.

In an embodiment of the present application, the second syntax identifier information indicates whether a first transform mode is allowed to be used for a current sequence. Specifically, if the first transform mode is used for the current sequence, it may be determined that the value of the second syntax identifier information is a first value; if the first transform mode is not used for the current sequence, it may be determined that the value of the second syntax identifier information may is a second value.

Further, in some embodiments, the method further includes operations that: when the first transform mode is allowed to be used for the current sequence, the operation of determining the index of the texture feature of the current block is performed. Herein the current sequence includes the current block.

It should be noted that, in the embodiment of the present application, the second syntax identifier information may be represented by sps_inter_lfnst_nspt_enabled_flag, and the second syntax identifier information is a syntax element in a Sequence Parameter Set (SPS).

It should also be noted that in the embodiment of the present application, the first value is different from the second value, and the first value and the second value may be in a parameter form or a numeric form. Specifically, the first syntax identifier information may be a parameter written in a profile, or may be a value of a flag, which is not specifically limited here. Exemplarily, the first value may be 1 and the second value may be 0. Alternatively, the first value may be 0 and the second value may be 1. Alternatively, the first value may be true and the second value may be false. Alternatively, the first value may be false and the second value may be true. In a specific embodiment, the first value is 1 and the second value is 0.

That is, the embodiment of the present application may use a high level syntax to control the enable/disable of the present technical solution. For example, a sequence-level flag is used. For example, a syntax element sps_inter_lfnst_nspt_enabled_flag is added to the sequence parameter set. If the present technical solution is allowed to be used for the current sequence, it may be determined that the value of sps_inter_lfnst_nspt_enabled_flag is 1. If the present technical solution is not allowed to be used for the current sequence, it may be determined that the value of sps_inter_lfnst_nspt_enabled_flag is 0. In a case where the present technical solution is allowed to be used, the encoding side may continue to determine the index of the texture feature of the current block and determine the index of the transform kernel of the LFNST or the NSPT, and the index of the transform kernel or the value of lfnst_nspt_idx is encoded. Or, the embodiment of the present application may also set respective syntax elements for the LFNST and the NSPT, that is, sps_inter_lfnst_enabled_flag and sps_inter_nspt_enabled_flag, respectively. sps_inter_lfnst_enabled_flag is used to indicate whether the LFNST is allowed to be used for the current sequence, and sps_inter_nspt_enabled_flag is used to indicate whether NSPT is allowed to be used for the current sequence.

It should be noted that, in the embodiment of the present application, the same flag, such as sps_lfnst_nspt_enabled_flag, may be set for an inter LFNST/NSPT and an intra LFNST/NSPT. For example, if the value of sps_inter_lfnst_nspt_enabled_flag is 0, then it may be determined that the LFNST and the NSPT is not allowed to be used for the current sequence; if the value of sps_inter_lfnst_nspt_enabled_flag is 1, it may be determined that the current sequence allows intra-encoding blocks to use the LFNST and the NSPT; if the value of sps_inter_lfnst_nspt_enabled_flag is 2, it may be determined that the current sequence allows inter-encoding blocks to use the LFNST and the NSPT.

In some embodiments, the method further includes operations that: a value of the second syntax identifier information and a value of the third syntax identifier information are determined; herein the second syntax identifier information is used to indicate whether a first transform mode is allowed to be used for a current sequence, and the third syntax identifier information is used to indicate whether the first transform mode is allowed to be used for a current picture; the value of the second syntax identifier information and the value of the third syntax identifier information are encoded, and the obtained encoded bits are written into the bitstream.

Further, in some embodiments, when the first transform mode is allowed to be used for the current sequence, it is determined whether the first transform mode is allowed to be used for the current picture; when the first transform mode is allowed to be used for the current picture, the operation of determining the index of the texture feature of the current block is performed.

In the embodiment of the present application, the current sequence may include the current picture, and the current picture may include a current block. Here, the third syntax identifier information may be represented by ph_inter_lfnst_nspt_enabled_flag, and the third syntax identifier information is a syntax element at the picture level.

In the embodiment of the present application, when the first transform mode is allowed to be used for the current picture, it may be determined that a value of the third syntax identifier information is a first value; when the first transform mode is not allowed to be used for the current picture, it may be determined that the value of the third syntax identifier information is a second value.

In some embodiments, the method further includes operations that: a value of second syntax identifier information and a value of fourth syntax identifier information are determined, herein the second syntax identifier information is used to indicate whether a first transform mode is allowed to be used for a current sequence, and the fourth syntax identifier information is used to indicate whether the first transform mode is allowed to be used for the current slice; the value of the second syntax identifier information and the value of the fourth syntax identifier information are encoded, and the obtained encoded bits are written into the bitstream.

Further, in some embodiments, when the first transform mode is allowed to be used for a current sequence, it is determined whether the first transform mode is allowed to be used for the current slice; when the first transform mode is allowed to be used for the current slice, the operation of determining the index of the texture feature of the current tile is performed.

In the embodiment of the present application, the current sequence may include the current slice, and the current slice may include the current block. Here, the fourth syntax identifier information may be represented by sh_inter_lfnst_nspt_enabled_flag, and the fourth syntax identifier information is a syntax element at a slice level.

In the embodiment of the present application, if the first transform mode is allowed to be used for the current slice, it may be determined that the value of the fourth syntax identifier information is a first value. If the first transform mode is not allowed to be used for the current slice, it may be determined that the value of the fourth syntax identifier information is a second value.

It should also be noted that in the embodiment of the present application, the first value is different from the second value, and the first value and the second value may be in the form of parameters or numbers. Specifically, the first syntax identifier information may be a parameter written in a profile, or may be a value of a flag, which is not specifically limited here. Exemplarily, the first value may be 1 and the second value may be 0. Alternatively, the first value may be 0 and the second value may be 1. Alternatively, the first value may be true and the second value may be false. Alternatively, the first value may be false and the second value may be true. In a specific embodiment, the first value is 1 and the second value is 0.

That is, in the embodiment of the present application, a high level syntax may be used to control the enable/disable of the present technical solution. For example, a sequence-level flag is used. For example, the syntax element sps_inter_lfnst_nspt_enabled_flag is added into the sequence parameter set (SPS). If the present technical solution is allowed to be used for the current sequence, it may be determined that the value of sps_inter_lfnst_nspt_enabled_flag is 1. If the present technical solution is not allowed to be used for the current sequence, it may be determined that the value of sps_inter_lfnst_nspt_enabled_flag is 0. If the present technical solution is allowed, the encoding side may continue to determine the index of the texture feature of the current block and determine the index of the transform kernel for the LFNST or the NSPT, and the index of the transform kernel or the value of lfnst_nspt_idx is encoded, so that the decoder can decode lfnst_nspt_idx when decoding the inter-encoded block and perform the processing of the LFNST or NSPT. Or, it is also possible to set respective flags for the LFNST and the NSPT, namely sps_inter_lfnst_enabled_flag and sps_inter_nspt_enabled_flag, respectively.

Further, the embodiment of the present application may also use other levels of syntax elements to realize more flexible control, such as a flag in an picture parameter set (PPS), a flag in an picture header (picture header) or a slice header (slice header), etc. For example, the sequence parameter set (SPS) determines whether the current sequence can use the present technical solution, and if the current sequence uses the present technical solution, a sh_inter_lfnst_nspt_enabled_flag in a slice header is set to determine whether the current slice uses the present technical solution, thereby providing higher flexibility. Because for inter coding, particularly RA, the QPs of different pictures or slices differs greatly. Here, since a picture having a low GOP temporal level usually has a low QP, and a picture having a higher GOP temporal level usually has a higher QP, the present technical solution does not significantly improve the compression efficiency when the QP is particularly high or particularly low, and thus a flag in a picture header or a slice header can be set to control it more flexibly.

It should also be noted that, in the embodiments of the present application, the LFNST and the NSPT may be applied to the inter predicted block. For blocks that can't be inter predicted well, that is, blocks with large residuals, correlation can better removed and compression efficiency can be improved compared with MTS in related technologies.

It should be noted that, in the embodiments of the present application, the LFNST and the NSPT may be applied to an Intra Block Copy (IBC) block in addition to inter prediction block.

In another embodiment of the present application, the embodiment of the present application provides a bitstream generated by bit encoding according to information to be encoded. The information to be encoded includes at least one of a quantization coefficient of a current block, a feature index sequence number of the current block, a value of first syntax identifier information, a value of second syntax identifier information, a value of third syntax identifier information, and a value of fourth syntax identifier information.

In an embodiment of the present application, the first syntax identifier information indicates whether the first transform mode is used for the current block and an index of a corresponding used transform kernel, the second syntax identifier information indicates whether a first transform mode is allowed to be used for a current sequence, the third syntax identifier information indicates whether the first transform mode is allowed to be used for a current picture, and the fourth syntax identifier information indicates whether the first transform mode is allowed to be used for the current slice.

The present embodiment provides an encoding method. An index of a texture feature of a current block is determined. A transform kernel set for the current block is determined according to the index of the texture feature. A transform kernel for the current block is determined according to the transform kernel set. The residual block of the current block is determined. The residual block of the current block is transformed according to the transform kernel to determine a transform coefficient of the current block. The transform coefficient of the current block is encoded, and the obtained encoded bits are written into the bitstream. That is, the correspondence between the index of the texture feature and the transform kernel set is established here, and the scheme of matching the transform kernel set according to the intra prediction mode in the related art is replaced, so that the LFNST and the NSPT can also be applied to the inter prediction mode, so that for blocks that are not easily predicted in the inter prediction mode, that is, blocks with large residuals, not only the compression efficiency but also the encoding and decoding performance can be improved.

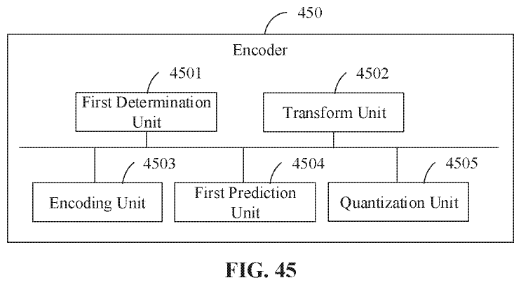

In still another embodiment of the present application, based on the same inventive concept as the above embodiments, reference is made to FIG. 45, which shows a schematic structural diagram of a configuration of an encoder provided by an embodiment of the present application. As shown in FIG. 45, the encoder 450 may include a first determination unit 4501, a transform unit 4502, and an encoding unit 4503.

The first determination unit 4501 is configured to determine an index of a texture feature of a current block; determine a transform kernel set for the current block according to the index of the texture feature; and determine a transform kernel for the current block according to the transform kernel set.

The transform unit 4502 is configured to determine a residual block of the current block, perform transform on the residual block of the current block according to the transform kernel, to determine a transform coefficient of the current block.

The encoding unit 4503 is configured to encode the transform coefficient of the current block and write the obtained encoded bits into the bitstream.

In some embodiments, referring to FIG. 45, the encoder 450 may further include a first prediction unit 4504 configured to perform inter prediction on the current block, to determine a prediction block of the current block.

The first determination unit 4501 is further configured to determine the residual block of the current block based on an original block of the current block and the prediction block of the current block.

In some embodiments, referring to FIG. 45, the encoder 450 may further include a quantization unit 4505 configured to quantize the transform coefficient of the current block, to determine a quantization coefficient of the current block.

The encoding unit 4503 is further configured to encode the quantization coefficient of the current block, and write the obtained encoded bits into the bitstream.

In some embodiments, the first determination unit 4501 is further configured to quantize the transform coefficient of the current block to determine the quantization coefficient of the current block. The encoding unit 4503 is further configured to encode the quantization coefficient of the current block, and write the obtained encoded bits into the bitstream.

In some embodiments, the first determination unit 4501 is further configured to determine a candidate sample for deriving the index of the texture feature; and determine the index of the texture feature of the current block according to the candidate sample.

In some embodiments, the first determination unit 4501 is further configured to determine a horizontal gradient value and a vertical gradient value of the candidate sample;

determine an index of a texture feature and a gradient intensity value corresponding to the candidate sample according to the horizontal gradient value and the vertical gradient value of the candidate sample; construct a texture feature statistical table according to the index of the texture feature and the gradient intensity value corresponding to the candidate sample; and determine the index of the texture feature of the current block according to the texture feature statistical table.

In some embodiments, the first determination unit 4501 is further configured to determine a number of the candidate sample according to a size parameter of the current block.

In some embodiments, the first determination unit 4501 is further configured to determine a prediction block of the current block; and take at least a portion of the samples in the prediction block as the candidate sample.

In some embodiments, the first determination unit 4501 is further configured to determine a neighboring sample of the current block in a reconstructed region; and take the neighboring sample in the reconstructed region as the candidate sample.

In some embodiments, the first determination unit 4501 is further configured to take the neighboring sample in the reconstructed region and at least a portion of samples in the prediction block as candidate samples.

In some embodiments, the first determination unit 4501 is further configured to determine a reference block for the current block; and take at least a portion of samples in the reference block as the candidate sample.

In some embodiments, the first determination unit 4501 is further configured to determine that the reference block is an integer sample reference block; or determine that the reference block is a fractional sample reference block.

In some embodiments, the first determination unit 4501 is further configured to determine two reference picture blocks when the current block is bi-directional predicted; perform fractional sample interpolation filtering on the two reference picture blocks to determine the two fractional sample reference picture blocks; and perform weighted combination on the two fractional sample reference picture blocks to determine the reference block for the current block.

In some embodiments, the first determination unit 4501 is further configured to perform an angle mapping according to the horizontal gradient value and the vertical gradient value of the candidate sample, to determine the index of the texture feature corresponding to the candidate samples; and perform gradient intensity calculation according to the horizontal gradient value and the vertical gradient value of the candidate sample, to determine the gradient intensity value corresponding to the candidate sample.

In some embodiments, the first determination unit 4501 is further configured to determine the index of the texture feature corresponding to the candidate sample according to the horizontal gradient value and the vertical gradient value of the candidate sample by using a preset look-up table.

In some embodiments, the first determination unit 4501 is further configured to perform an addition operation on an absolute value of the horizontal gradient value and an absolute value of the vertical gradient value to determine the gradient intensity value corresponding to the candidate sample.

In some embodiments, the first determination unit 4501 is further configured to: when a number of the candidate sample is one or more, determine indexes of one or more texture features and one or more corresponding gradient intensity values; determine one or more types of reference texture feature indexes having mutually different characteristics according to the indexes of the one or more texture features, and perform accumulation calculation on gradient intensity values belonging to a same type of reference texture feature index according to the one or more gradient intensity values, to determine accumulated gradient intensity values corresponding to the one or more types of reference texture feature indexes; and construct the texture feature statistical table according to the one or more types of reference texture feature indexes and the accumulated gradient intensity values corresponding to the one or more types of reference texture feature indexes.

In some embodiments, the first determination unit 4501 is further configured to determine a maximum accumulated gradient intensity value in the texture feature statistical table; and determine an index of a reference texture feature corresponding to the maximum accumulated gradient intensity value as the index of the texture feature of the current block.

In some embodiments, the first determination unit 4501 is further configured to determine a maximum accumulated gradient intensity value in the texture feature statistical table; and when the maximum accumulated gradient intensity value is less than a first threshold, set the index of the texture feature of the current block as a DC mode or a PLANANR mode.

In some embodiments, the first determination unit 4501 is further configured to determine a statistical sum value of all accumulated gradient intensity values in the texture feature statistical table; and when the statistical sum value is less than a second threshold, set the index of the texture feature of the current block as a DC mode or a PLANANR mode.

In some embodiments, the first determination unit 4501 is further configured to determine an index of an angle for the current block when a geometric partitioning mode is performed; and determine the index of the texture feature of the current block according to the index of the angle.

In some embodiments, the first determination unit 4501 is further configured to determine a reference block for the current block; and determine the index of the texture feature of the current block according to an index of a texture feature of the reference block.

In some embodiments, the first determination unit 4501 is further configured to construct a candidate list, herein the candidate list includes indexes of a preset number of candidate texture features; perform cost value calculation on indexes of the preset number of candidate texture features, to determine respective cost values for the indexes of the preset number of candidate texture features; and determine a minimum cost value from the respective cost values for the indexes of the preset number of candidate texture features, and determine an index of a candidate texture feature corresponding to the minimum cost value as the index of the texture feature of the current block.

In some embodiments, the first determination unit 4501 is further configured to determine a feature index sequence number of the current block according to the index of the texture feature of the current block, herein the feature index sequence number is used to indicate a number of the index of the texture feature of the current block in the candidate list; and the encoding unit 4503 is further configured to encode the feature index sequence number of the current block and write the obtained encoded bits into the bitstream.

In some embodiments, the first determination unit 4501 is further configured to sort indexes of one or more reference texture features in the texture feature statistical table from large to small according to corresponding accumulated gradient intensity values, to determine indexes of a preset number of reference texture features that are sorted first, and construct the candidate list according to the indexes of the preset number of reference texture features that are sorted first.

In some embodiments, the first determination unit 4501 is further configured to determine an index of a first texture feature corresponding to a maximum accumulated gradient intensity value in the texture feature statistical table, determine an index of a second texture feature corresponding to the current block when a geometric partitioning mode is performed, and construct the candidate list according to the index of the first texture feature and the index of the second texture feature.

In some embodiments, the first determination unit 4501 is further configured to determine a reference block for the current block; and construct the candidate list according to indexes of texture features corresponding to one or more candidate positions in the reference block.

In some embodiments, the encoding unit 4503 is further configured to: when a first transform mode is used for the current block, perform the operation of encoding the feature index sequence number of the current block and writing the obtained encoded bits into the bitstream.

In some embodiments, the first determination unit 4501 is further configured to determine a value of first syntax identifier information of the current block, herein the first syntax identifier information is used to indicate whether the first transform mode is used for the current block and an index of a correspondingly used transform kernel; and the encoding unit 4503 is further configured to encode the value of the first syntax identifier information, and write the obtained encoded bits into the bitstream.

In some embodiments, the first determination unit 4501 is further configured to determine an index of a transform kernel for the current block, wherein the index of the transform kernel is used to indicate a number of the transform kernel for the current block in the transform kernel set; the encoding unit 4503 is further configured to: when an intra prediction mode is used for the current block, encode the index of the transform kernel for the current block, and write the obtained encoded bits into the bitstream; and when an inter prediction mode is used for the current block, determine the value of the first syntax identifier information according to the index of the transform kernel for the current block, encode the value of the first syntax identifier information, and write the obtained encoded bits into the bitstream.

In some embodiments, the transform kernel set includes one or more candidate transform kernels. Accordingly, the first determination unit 4501 is further configured to performing cost value calculation on the one or more candidate transform kernels respectively, to determine respective cost values of the one or more candidate transform kernels; determine a minimum cost value from the respective cost values of the one or more candidate transform kernels, and determine a candidate transform kernel corresponding to the minimum cost value as the transform kernel for the current block.

In some embodiments, the first determination unit 4501 is further configured to perform transform and quantization on the residual block of the current block based on a first candidate transform kernel, to determine a first candidate quantization coefficient of the current block, perform entropy coding processing on the first candidate quantization coefficient, to determine a first cost value of the first candidate transform kernel; perform inverse quantization and inverse transform on the first candidate quantization coefficient, to determine a first candidate residual block of the current block, and determine a first candidate prediction block of the current block according to the first candidate residual block; perform cost calculation according to the first candidate prediction block and an original picture of the current block, to determine a second cost value of the first candidate transform kernel; and determine a cost value of the first candidate transform kernel based on the first cost value and the second cost value of the first candidate transform kernel, herein the first candidate transform kernel is any one of the one or more candidate transform kernel.

In some embodiments, the transform unit 4502 is further configured to: when a size parameter of the current block satisfies a first condition, perform an non-separable primary transform on the residual block of the current block according to the transform kernel, to determine the transform coefficient of the current block; when the size parameter of the current block satisfies a second condition, perform a discrete cosine transform on the residual block of the current block, to determine a transform block of the current block; and perform a low-frequency non-separable transform on the transform block of the current block according to the transform kernel, to determine the transform coefficient of the current block.

In some embodiments, the first determination unit 4501 is further configured to determine a value of second syntax identifier information, herein the second syntax identifier information is used to indicate whether a first transform mode is allowed to be used for a current sequence; and the encoding unit 4503 is further configured to encode the value of the second syntax identifier information, and write the obtained encoded bits into the bitstream.

In some embodiments, the first determination unit 4501 is further configured to when the first transform mode is allowed to be used for the current sequence, perform the operation of determining the index of the texture feature of the current block, herein the current sequence includes the current block.

In some embodiments, the first determination unit 4501 is further configured to determine a value of second syntax identifier information and a value of third syntax identifier information, herein the second syntax identifier information indicates whether a first transform mode is allowed to be used for a current sequence, and the third syntax identifier information indicates whether a first transform mode is allowed to be used for a current picture; and the encoding unit 4503 is further configured to encode the value of the second syntax identifier information and the value of the third syntax identifier information, and write the obtained encoded bits into the bitstream.

In some embodiments, the first determination unit 4501 is further configured to when the first transform mode is allowed to be used for the current sequence, determine whether the first transform mode is allowed to be used for the current picture; and when the first transform mode is allowed to be used for the current picture, performing the operation of determining the index of the texture feature of the current block, herein the current sequence comprises the current picture, and the current picture includes the current block.

In some embodiments, the first determination unit 4501 is further configured to determine a value of second syntax identifier information and a value of fourth syntax identifier information, herein the second syntax identifier information indicates whether a first transform mode is allowed to be used for a current sequence, and the fourth syntax identifier information indicates whether the first transform mode is allowed to be used for the current slice; and the encoding unit 4503 is further configured to encode the value of the second syntax identifier information and the value of the fourth syntax identifier information, and write the obtained encoded bits into the bitstream.

In some embodiments, the first determination unit 4501 is further configured to: when the first transform mode is allowed to be used for the current sequence, determine whether the first transform mode is allowed to be used for the current slice; and when the first transform mode is allowed to be used for the current slice, perform the operation of determining the index of the texture feature of the current block, herein the current sequence includes the current slice, and the current slice includes the current block.

It can be understood that in the embodiments of the present application, the “unit” may be a part of a circuit, a part of a processor, a part of a program or software, etc., or may be a module, or may be non-modular. Moreover, in the present embodiments, various components may be integrated in one processing unit, various units may physically exist separately, or two or more units may be integrated in one unit. The above-described integrated unit may be implemented in the form of hardware or software functional modules.

The integrated unit may be stored in a computer-readable storage medium if it is implemented in the form of a software functional module and not sold or used as an independent product. Based on such a understanding, the technical solution of the embodiments essentially or contributes to the prior art or all or part of the technical solution may be embodied in the form of a software product stored in a storage medium and includes several instructions for causing a computer device (which may be a personal computer, a server, a network device, etc.) or a processor to perform all or part of the steps of the methods described in the embodiment. The storage medium includes a USB disk, a removable hard disk, a Read Only Memory (ROM), a Random Access Memory (RAM), a magnetic disk, an optical disk, and various media capable of storing program codes.

Accordingly, an embodiment of the present application provides a computer-readable storage medium applied to the encoder 450. The computer-readable storage medium stores a computer program that, when executed by a first processor, implements the method of any one of the foregoing embodiments.

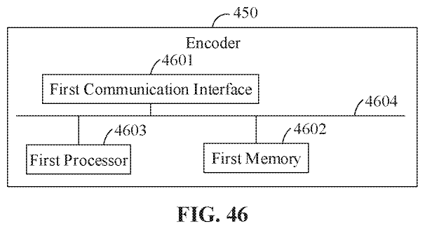

Based on the configuration of the encoder 450 and the computer-readable storage medium, reference is made to FIG. 46, which shows a schematic diagram of a specific hardware structure of the encoder 450 according to an embodiment of the present application. As shown in FIG. 46, the encoder 450 may include: a first communication interface 4601, a first memory 4602, and a first processor 4603. The various components are coupled together by a first bus system 4604. It will be appreciated that the first bus system 4604 is used to enable connected communication between these components. The first bus system 4604 includes a power bus, a control bus, and a status signal bus in addition to a data bus. However, for the sake of clarity of illustration, various buses are designated as first bus system 4604 in FIG. 46.

The first communication interface 4601 is configured to receive/transmit signals in the process of transmitting/receiving information with other external network elements.

The first memory 4602 is used for storing a computer program executable on the first processor 4603.

The first processor 4603 is configured to, when execute the computer program, perform the following operations:
determining an index of a texture feature of a current block; determining a transform kernel set for the current block according to the index of the texture feature; determining a transform kernel for the current block according to the transform kernel set; determining a residual block of the current block, and performing transform on the residual block of the current block according to the transform kernel, to determine a transform coefficient of the current block; and encoding the transform coefficient of the current block, and writing the obtained encoded bits into a bitstream.

It is understood that the first memory 4602 in the embodiment of the present application may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), and Direct Rambus RAM (DRRAM). The first memory 4602 for the systems and methods described herein is intended to include, but is not limited to, these and any other suitable type of memory.

The first processor 4603 may be an integrated circuit chip having signal processing capabilities. In implementation, the steps of the above-described methods may be accomplished by integrated logic circuitry in hardware in the first processor 4603 or instructions in the form of software. The above-described first processor 4603 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present application may be implemented or executed. The general purpose processor may be a microprocessor or the processor may be any conventional processor or the like. The steps of the method disclosed in connection with the embodiments of the present application may be directly embodied as execution by the hardware coding processor, or may be executed by combining hardware and software modules in the coding processor. The software module may be located in a storage medium mature in the art, such as a random access memory, a flash memory, a read-only memory, a programmable read-only memory, or an electrically erasable programmable memory, a register, etc. The storage medium is located in the first memory 4602, and the first processor 4603 reads the information in the first memory 4602, and completes the steps of the above method in combination with its hardware.

It will be understood that the embodiments described herein may be implemented in hardware, software, firmware, middleware, microcode, or combinations thereof. For hardware implementation, the processing unit may be implemented in one or more Application Specific Integrated Circuits (ASICs), Digital Signal Processors (DSPs), DSP Devices (DSPDs), Programmable Logic Devices (PLDs), Field-Programmable Gate Arrays (FPGAs), general purpose processors, controllers, microcontrollers, microprocessors, other electronic units for performing the functions described herein, or combinations thereof. For software implementations, the techniques described herein may be implemented by modules (e.g., procedures, functions, etc.) that perform the functions described herein. The software code may be stored in memory and executed by a processor. The memory may be implemented in the processor or external to the processor.

Optionally, as another embodiment, the first processor 4603 is further configured to execute the method of any one of the preceding embodiments when executing the computer program.

The present embodiment provides an encoder. In the encoder, a correspondence between an index of a texture feature and a transform kernel set is established, which replaces the scheme of matching the transform kernel set according to the intra prediction mode in the related art, so that the LFNST and the NSPT can also be applied to the inter prediction mode. Therefore, for blocks that are not easily predicted in the inter prediction mode, that is, blocks with large residuals, not only the compression efficiency but also the encoding and decoding performance can be improved.

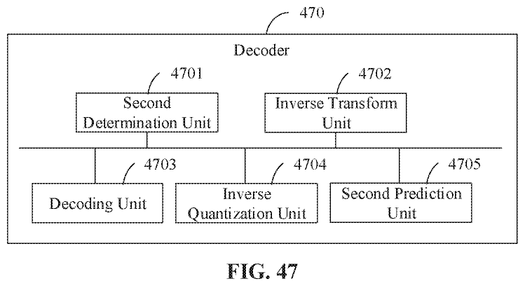

Based on the same inventive concept as the foregoing embodiments, reference is made to FIG. 47, which shows a schematic structure diagram of a configuration of a decoder according to an embodiment of the present application. As shown in FIG. 47, the decoder 470 may include a second determination unit 4701 and an inverse transform unit 4702.

The second determination unit 4701 is configured to determine an index of a texture feature of the current block; and determine a transform kernel set for the current block according to the index of the texture feature.

The second determination unit 4701 is further configured to determine a transform kernel for the current block according to the transform kernel set.

The inverse transform unit 4702 is configured to determine a transform coefficient of the current block, and perform an inverse transform on the transform coefficient of the current block according to the transform kernel, to determine a residual block of the current block.

In some embodiments, referring to FIG. 47, decoder 470 may further include a decoding unit 4703 and an inverse quantization unit 4704.

The decoding unit 4703 is configured to decode a bitstream to determine a quantization coefficient of the current block.

The inverse quantization unit 4704 is further configured to perform inverse quantization on the quantization coefficient of the current block to determine the transform coefficient of the current block.

In some embodiments, referring to FIG. 47, the decoder 470 may further include a second prediction unit 4705 configured to perform inter prediction on the current block to determine a prediction block of the current block.

The second determination unit 4701 is further configured to determine a reconstructed block of the current block according to the prediction block of the current block and the residual block of the current block.

In some embodiments, the decoding unit 4703 is further configured to decode a bitstream to determine a value of the first syntax identifier information of the current block. The second determination unit 4701 is further configured to: when the first syntax identifier information indicates that a first transform mode is used for the current block, determine an index of a transform kernel for the current block, and determine the transform kernel for the current block according to the transform kernel set and the index of the transform kernel.

In some embodiments, the decoding unit 4703 is further configured to decode a bitstream to determine the index of the transform kernel for the current block when an intra prediction mode is used for the current block. The second determination unit 4701 is further configured to determine the index of the transform kernel for the current block according to the value of the first syntax identifier information when an inter prediction mode is used for the current block.

In some embodiments, the second determination unit 4701 is further configured to determine a candidate sample for deriving the index of the texture feature; and determine the index of the texture feature of the current block according to the candidate sample.

In some embodiments, the second determination unit 4701 is further configured to construct a texture feature statistical table according to the index of the texture feature and the gradient intensity value corresponding to the candidate sample; and determine the index of the texture feature of the current block according to the texture feature statistical table.

In some embodiments, the second determination unit 4701 is further configured to determine a number of the candidate sample according to a size parameter of the current block.

In some embodiments, the second determination unit 4701 is further configured to determine a prediction block of the current block; and take at least a portion of samples in the prediction block as the candidate sample.

In some embodiments, the second determination unit 4701 is further configured to determine a neighboring sample of the current block in a reconstructed region; and take the neighboring sample in the reconstructed region as the candidate sample.

In some embodiments, the second determination unit 4701 is further configured to take the neighboring sample in the reconstructed region and at least a portion of samples in the prediction block as candidate samples.

In some embodiments, the second determination unit 4701 is further configured to determine a reference block for the current block; and take at least a portion of samples in the reference block as the candidate sample.

In some embodiments, the second determination unit 4701 is further configured to determine that the reference block is an integer sample reference block; or determine that the reference block is a fractional sample reference block.

In some embodiments, the second determination unit 4701 is further configured to determine two reference picture blocks when the current block is bi-directional predicted; perform fractional sample interpolation filtering on the two reference picture blocks to determine two fractional sample reference picture blocks; and perform weighted combination on the two fractional sample reference picture blocks to determine the reference block for the current block.

In some embodiments, the second determination unit 4701 is further configured to perform an angle mapping according to the horizontal gradient value and the vertical gradient value of the candidate sample, to determine the index of the texture feature corresponding to the candidate sample; and perform gradient intensity calculation according to the horizontal gradient value and the vertical gradient value of the candidate sample, to determine the gradient intensity value corresponding to the candidate sample.

In some embodiments, the second determination unit 4701 is further configured to determine the index of the texture feature corresponding to the candidate sample according to the horizontal gradient value and the vertical gradient value of the candidate sample by using a preset look-up table.

In some embodiments, the second determination unit 4701 is further configured to perform an addition operation on an absolute value of the horizontal gradient value and an absolute value of the vertical gradient value, to determine the gradient intensity value corresponding to the candidate sample.

In some embodiments, the second determination unit 4701 is further configured to: when a number of the candidate sample is one or more, determine indexes of one or more texture feature and one or more corresponding gradient intensity values; determine one or more types of reference texture feature indexes having mutually different characteristics according to the indexes of the one or more texture features, and perform accumulation calculation on gradient intensity values belonging to a same type of reference texture feature index according to the one or more gradient intensity values, to determine accumulated gradient intensity values corresponding to the one or more types of reference texture feature indexes; and construct the texture feature statistical table according to the one or more types of reference texture feature indexes and the accumulated gradient intensity values corresponding to the one or more types of reference texture feature indexes.

In some embodiments, the second determination unit 4701 is further configured to determine a maximum accumulated gradient intensity value in the texture feature statistical table; and determine an index of a reference texture feature corresponding to the maximum accumulated gradient intensity value as the index of the texture feature of the current block.

In some embodiments, the second determination unit 4701 is further configured to determine a maximum accumulated gradient intensity value in the texture feature statistical table; and when the maximum accumulated gradient intensity value is less than a first threshold, set the index of the texture feature of the current block as a DC mode or a PLANANR mode.

In some embodiments, the second determination unit 4701 is further configured to determine a statistical sum value of all accumulated gradient intensity values in the texture feature statistical table; and when the statistical sum value is less than a second threshold, the index of the texture feature of the current block is set as a DC mode or a PLANANR mode.

In some embodiments, the second determination unit 4701 is further configured to determine an index of an angle for the current block when a geometric partitioning mode is performed; and determine the index of the texture feature of the current block according to the index of the angle.

In some embodiments, the second determination unit 4701 is further configured to determine a reference block for the current block; and determine the index of the texture feature of the current block according to an index of a texture feature of the reference block.

In some embodiments, the second determination unit 4701 is further configured to: construct a candidate list, herein the candidate list includes indexes of a preset number of candidate texture features; decode a bitstream to determine a feature index sequence number of the current block.

In some embodiments, the second determination unit 4701 is further configured to sort indexes of one or more reference texture features in the texture feature statistical table from large to small according to corresponding accumulated gradient intensity values, to determine the indexes of the preset number of reference texture features that are sorted first; and construct the candidate list according to the indexes of the preset number of reference texture features that are sorted first.

In some embodiments, the second determination unit 4701 is further configured to determine an index of a first texture feature corresponding to a maximum accumulated gradient intensity value in the texture feature statistical table and an index of a second texture feature corresponding to the current block when a geometric partitioning mode is performed; and construct the candidate list according to the index of the first texture feature and the index of the second texture feature.

In some embodiments, the second determination unit 4701 is further configured to determine a reference block for the current block; and construct the candidate list according to indexes of texture features corresponding to one or more candidate positions in the reference block.

In some embodiments, the decoding unit 4703 is further configured to decode a bitstream to determine a value of the first syntax identifier information of the current block; and the second determination unit 4701 is further configured to when the first syntax identifier information indicates that a first transform mode is used for the current block, perform the operation of decoding the bitstream to determine the feature index sequence number of the current block.

In some embodiments, the inverse transform unit 4702 is further configured to: when a size parameter of the current block satisfies a first condition, perform an inverse transform of an inseparable primary transform on the transform coefficient of the current block according to the transform kernel, to determine the residual block of the current block; when the size parameter of the current block satisfies a second condition, perform an inverse transform of a low-frequency non-separable transform on the transform coefficient of the current block according to the transform kernel, to determine a transform block of the current block; and perform an inverse transform of a discrete cosine transform on the transform block of the current block to determine the residual block of the current block.

In some embodiments, the decoding unit 4703 is further configured to decode a bitstream to determine a value of second syntax identifier information; and when the second syntax identifier information indicates that a first transform mode is allowed to be used for a current sequence, perform the operation of determining the index of the texture feature of the current block, herein the current sequence includes the current block.

In some embodiments, the decoding unit 4703 is further configured to decode a bitstream to determine a value of second syntax identifier information; when the second syntax identifier information indicates that a first transform mode is allowed to be used for a current sequence, decode the bitstream to determine a value of third syntax identifier information; and when the third syntax identifier information indicates that the first transform mode is allowed to be used for the current picture, perform the operation of determining the index of the texture feature of the current block, herein the current sequence includes the current picture, and the current picture includes the current block.

In some embodiments, the decoding unit 4703 is further configured to decode a bitstream to determine a value of second syntax identifier information; when the second syntax identifier information indicates that a first transform mode is allowed to be used for a current sequence, decode the bitstream to determine a value of fourth syntax identifier information; and when the fourth syntax identifier information indicates that the first transform mode is allowed to be used for the current slice, perform the operation of determining the index of the texture feature of the current block, herein the current sequence includes the current slice, and the current slice includes the current block.

It can be understood that in the present embodiment, the “unit” may be a part of a circuit, a part of a processor, a part of a program or software, etc., or may be a module, or may be non-modular. Moreover, in the present embodiments, various components may be integrated in one processing unit, various units may physically exist separately, or two or more units may be integrated in one unit. The above-described integrated unit may be implemented in the form of hardware or software functional modules.

The integrated unit may be stored in a computer-readable storage medium if implemented in the form of software functional modules and not sold or used as an independent product. Based on such an understanding, the present embodiment provides a computer-readable storage medium applied to the decoder 470, the computer-readable storage medium storing a computer program that, when executed by a second processor, implements the method of any of the preceding embodiments.

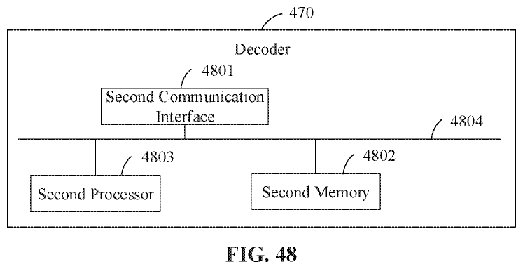

Based on the configuration of the decoder 470 and the computer-readable storage medium, reference is made to FIG. 48, which shows a schematic diagram of a specific hardware structure of the decoder 470 according to an embodiment of the present application. As shown in FIG. 48, the decoder 470 may include: a second communication interface 4801, a second memory 4802, and a second processor 4803. The various components are coupled together by a second bus system 4804. It will be appreciated that the second bus system 4804 is used to enable connected communication between these components. The second bus system 4804 includes a power bus, a control bus, and a status signal bus in addition to a data bus. However, for the sake of clarity of illustration, various buses are designated as second bus system 4804 in FIG. 48.

The second communication interface 4801 is configured to receive/transmit signals in the process of transmitting/receiving information with other external network elements.

The second memory 4802 is used for storing a computer program executable on the second processor 4803.

The second processor 4803 is configured to, when executing the computer program, perform the following operations:
determining an index of a texture feature of a current block; determining a transform kernel set for the current block according to the index of the texture feature; determining a transform kernel for the current block according to the transform kernel set; and determining a transform coefficient of the current block, and performing an inverse transform on the transform coefficient of the current block according to the transform kernel, to determine a residual block of the current block.

Optionally, as another embodiment, the second processor 4803 is further configured to: when executing the computer program, perform the method of any one of the preceding embodiments.

It can be understood that the second memory 4802 has a hardware function similar to that of the first memory 4602, and that the second processor 4803 has a hardware function similar to that of the first processor 4603, which will not be detailed here again.

The present embodiment provides a decoder. In the decoder, a correspondence between an index of a texture feature and a transform kernel set is established, which replaces the scheme of matching the transform kernel set according to the intra prediction mode in the related art, so that the LFNST and the NSPT can also be applied to the inter prediction mode. Therefore, for blocks that are not easily predicted in the inter prediction mode, that is, blocks with large residuals, not only the compression efficiency but also the encoding and decoding performance can be improved.

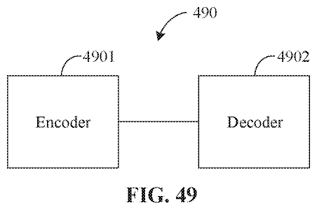

In still another embodiment of the present application, reference is made to FIG. 49, which shows a schematic structure diagram of a coding system according to an embodiment of the present application. As shown in FIG. 49, the coding system 490 may include an encoder 4901 and a decoder 4902.

In an embodiment of the present application, the encoder 4901 may be the encoder described in any one of the preceding embodiments, and the decoder 4902 may be the decoder described in any one of the preceding embodiments.

It should be noted that an index of a texture feature or a texture feature index is a first transform parameter, accordingly, a reference texture feature index is a reference first transform parameter, and an index of a candidate reference texture is a candidate first transform parameter.

It should be noted that in the present application, the terms “comprising” “including” or any other variation thereof are intended to encompass a non-exclusive inclusion such that a process, method, object, or apparatus including a series of elements includes not only those elements, but also other elements not explicitly listed, or elements inherent to such a process, method, object, or apparatus. Without further limitation, an element defined by the statement “including a” does not preclude the presence of additional identical elements in a process, method, object, or apparatus that includes the element.

The above-described serial numbers of the embodiments of the present application are for description only, and do not represent the advantages and disadvantages of the embodiments.

The methods disclosed in several method embodiments provided in the present application can be arbitrarily combined without conflict to obtain new method embodiments.

The features disclosed in several product embodiments provided in the present application can be arbitrarily combined without conflicting to obtain new product embodiments.

The features disclosed in several method or device embodiments provided in the present application can be arbitrarily combined without conflict to obtain a new method or device embodiment.

The above is merely a specific embodiment of the present application, but the protection scope of the present application is not limited thereto. Changes or substitutions which may be easily thought by any person skilled in the art within the technical scope disclosed in the present application should be fallen into the protection scope of the present application. Therefore, the protection scope of the present application should be based on the protection scope of the claims.

### INDUSTRIAL APPLICABILITY

In the embodiments of the present application, at an encoding side, an index of a texture feature of a current block is determined; a transform kernel set for the current block is determined according to the index of the texture feature; a transform kernel for the current block is determined according to the transform kernel set; the residual block of the current block is determined; the residual block of the current block is transformed according to the transform kernel to determine a transform coefficient of the current block; the transform coefficient of the current block is encoded, and the obtained encoded bits are written into the bitstream. At the decoding side, an index of a texture feature of a current block is determined; a transform kernel set for the current block is determined according to the index of the texture feature; a transform kernel for the current block is determined according to the transform kernel set; a transform coefficient of the current block is determined; an inverse transform is performed on the transform coefficient of the current block according to the transform kernel to determine a residual block of the current block. As such, whenever the encoding side or the decoding side, first, an index of a texture feature of a current block is determined; then a transform kernel set for the current block is determined according to the index of the texture feature; and further a transform kernel for the current block is determined according to the transform kernel set. That is, a correspondence between an index of the texture feature and a transform kernel set is established here, which replaces the scheme of matching the transform kernel set according to the intra prediction mode in the related art, so that the LFNST and the NSPT can also be applied to the inter prediction mode. Therefore, for blocks that are not easily predicted in the inter prediction mode, that is, blocks with large residuals, not only the compression efficiency but also the encoding and decoding performance can be improved.

1. A method of decoding, applied to a decoder, the method comprising:
determining a first transform parameter of a current block;
determining a transform kernel set for the current block according to the first transform parameter;
determining a transform kernel for the current block according to the transform kernel set; and
determining a transform coefficient of the current block, and performing an inverse transform on the transform coefficient of the current block according to the transform kernel, to determine a residual block of the current block.

2. The method of claim 1, wherein determining the transform kernel for the current block according to the transform kernel set comprises:
decoding a bitstream to determine a value of first syntax identifier information of the current block, the first syntax identifier information indicates an index of a transform kernel for the current block; and
determining the transform kernel for the current block according to the transform kernel set and the index of the transform kernel.

3. The method of claim 1, wherein determining the first transform parameter of the current block comprises:
determining a candidate sample for deriving the first transform parameter; and
determining the first transform parameter of the current block according to the candidate sample.

4. The method of claim 3, wherein determining the first transform parameter of the current block according to the candidate sample comprises:
determining a horizontal gradient value and a vertical gradient value of the candidate sample;
determining a first transform parameter and a gradient intensity value corresponding to the candidate sample according to the horizontal gradient value and the vertical gradient value of the candidate sample;
constructing a texture feature statistical table according to the first transform parameter and the gradient intensity value corresponding to the candidate sample; and
determining the first transform parameter of the current block according to the texture feature statistical table.

5. The method of claim 3, further comprising:
determining a number of the candidate sample according to a size parameter of the current block.

6. The method of claim 3, further comprising:
determining a prediction block of the current block; and
taking at least a portion of samples in the prediction block as the candidate sample.

7. The method of claim 6, further comprising:
determining a neighboring sample of the current block in a reconstructed region; and
taking the neighboring sample in the reconstructed region as the candidate sample.

8. The method of claim 7, further comprising:
taking the neighboring sample in the reconstructed region and at least a portion of the samples in the prediction block as candidate samples.

9. The method of claim 3, further comprising:
determining a reference block for the current block; and
taking at least a portion of samples in the reference block as the candidate sample.

10. The method of claim 9, wherein determining the reference block for the current block comprises:
determining that the reference block is an integer sample reference block; or,
determining that the reference block is a fractional sample reference block.

11. The method of claim 10, wherein when the reference block is the fractional sample reference block, determining the reference block for the current block comprises:
determining two reference picture blocks when the current block is bi-directional predicted;
performing fractional sample interpolation filtering on the two reference picture blocks to determine two fractional sample reference picture blocks; and
performing weighted combination on the two fractional sample reference picture blocks to determine the reference block for the current block.

12. The method of claim 4, wherein determining the first transform parameter and the gradient intensity value corresponding to the candidate sample according to the horizontal gradient value and the vertical gradient value of the candidate sample comprises:
performing an angle mapping according to the horizontal gradient value and the vertical gradient value of the candidate sample, to determine the first transform parameter corresponding to the candidate sample; and
performing gradient intensity calculation according to the horizontal gradient value and the vertical gradient value of the candidate sample, to determine the gradient intensity value corresponding to the candidate sample.

13. The method of claim 12, wherein performing the angle mapping according to the horizontal gradient value and the vertical gradient value of the candidate sample, to determine the first transform parameter corresponding to the candidate sample comprises:
determining the first transform parameter corresponding to the candidate sample according to the horizontal gradient value and the vertical gradient value of the candidate sample by using a preset look-up table.

14. The method of claim 12, wherein performing the gradient intensity calculation according to the horizontal gradient value and the vertical gradient value of the candidate sample, to determine the gradient intensity value corresponding to the candidate sample comprises:
performing an addition operation on an absolute value of the horizontal gradient value and an absolute value of the vertical gradient value, to determine the gradient intensity value corresponding to the candidate sample.

15. The method of claim 4, wherein constructing the texture feature statistical table according to the first transform parameter and the gradient intensity values corresponding to the candidate sample comprises:
when a number of the candidate sample is one or more, determining one or more first transform parameters and one or more corresponding gradient intensity values;
determining one or more types of reference first transform parameters which are mutually different according to the one or more first transform parameters, and performing accumulation calculation on gradient intensity values belonging to a same type of reference first transform parameter according to the one or more gradient intensity values, to determine accumulated gradient intensity values corresponding to the one or more types of reference first transform parameters; and
constructing the texture feature statistical table according to the one or more types of reference first transform parameters and the accumulated gradient intensity values corresponding to the one or more types of reference first transform parameters.

16. The method of claim 15, wherein determining the first transform parameter of the current block according to the texture feature statistical table comprises:
determining a maximum accumulated gradient intensity value in the texture feature statistical table; and
determining a reference first transform parameter corresponding to the maximum accumulated gradient intensity value as the first transform parameter of the current block.

17. The method of claim 1, wherein determining the first transform parameter of the current block comprises:
determining an index of an angle for the current block when a geometric partitioning mode is performed; and
determining the first transform parameter of the current block according to the index of the angle.

18. The method of claim 1, wherein determining the first transform parameter of the current block comprises:
determining a reference block for the current block; and
determining the first transform parameter of the current block according to a first transform parameter of the reference block.

19. A method of encoding, applied to an encoder, the method comprising:
determining a first transform parameter of a current block;
determining a transform kernel set for the current block according to the first transform parameter;
determining a transform kernel for the current block according to the transform kernel set;
determining a residual block of the current block, and performing transform on the residual block of the current block according to the transform kernel, to determine a transform coefficient of the current block; and
encoding the transform coefficient of the current block, and writing the obtained encoded bits into a bitstream.

20. A non-transitory computer-readable storage medium, having a computer program and a bitstream stored thereon, wherein the computer program, when executed by a processor, enables the processor to perform the following operations to generate the bitstream:
determining an index of a first transform parameter;
determining a transform kernel set for the current block according to the first transform parameter;
determining a transform kernel for the current block according to the transform kernel set;
determining a residual block of the current block, and performing transform on the residual block of the current block according to the transform kernel, to determine a transform coefficient of the current block; and
encoding the transform coefficient of the current block, and writing the obtained encoded bits into a bitstream.
